(19) United States
(12) Patent Application Publication
(10) Pub. No.: US 2014/0024132 A1
(43) Pub. Date: Jan. 23, 2014

(54) METHODS AND SYSTEMS USING INTEGRATED METABOLOMICS AND PHARMACOKINETICS FOR MULTI-COMPONENT DRUG EVALUATION

(71) Applicants: Wei Jia, Concord, NC (US); Yunping Qiu, Kannapolis, NC (US)

(72) Inventors: Wei Jia, Concord, NC (US); Yunping Qiu, Kannapolis, NC (US)

(21) Appl. No.: 13/634,133

(22) PCT Filed: Mar. 14, 2011
(86) PCT No.: PCT/US11/28418

§ 371 Date: Aug. 20, 2013

Related U.S. Application Data
(60) Provisional application No. 61/313,479, filed on Mar. 12, 2010.

(51) Int. Cl. G01N 27/62

(52) U.S. Cl. CPC G01N 27/62
USPC 436/173; 422/68.1

(57) ABSTRACT

Disclosed are methods and systems for identifying biochemical changes in a subject in response to administration of a multi-component therapeutic and one or more active ingredients in the multi-component therapeutic. The methods and systems of the invention may be used to elucidate the interaction of the biological system's genome with its environments, and in the pharmacokinetic, pharmacodynamic and toxicology analysis of multi-component therapeutics. The metabolomics methods and systems of the invention can also be used in studies of plant derived agents to demonstrate biochemical alterations in response to the dynamic multi-component intervention.

### FIELD OF THE INVENTION

The present invention relates to methods and systems that use integrated metabolomics and pharmacokinetics for multi-component drug evaluation.

### BACKGROUND

Multi-component therapeutics, including combination chemical compounds and herbal medicines, are defined as a concerted pharmacological intervention of multiple compounds interacting with multiple targets which possess mutually interdependent activities that are required for an optimal effect. [1, 2] Such an approach might reduce the required dosage of individual agents compared with mono-therapy and limit potential side effects. [3, 7] The interaction between the ingredients in a multi-component drug and the multiple targets associated with a diseased state is far more complex than merely the result of a direct interaction exerted by a single chemical entity.

The past two decades have witnessed an increasing application of botanical-based nutraceuticals as complementary interventions against a number of conditions. [88, 89] Botanicals frequently contain hundreds or even thousands of individual chemical entities present in a wide range of concentration levels. The vast number of metabolites typically present in natural products, the plant metabolome, and their huge dynamic range are inextricable challenges for pharmacological evaluation and nutraceutical/drug development. Due to the compositional complexity of both botanicals and biological sample matrices (blood, urine, other bodily fluids, and tissues), the necessary analytical approaches to quantitatively measure the time-dependent concentration profiles of bioavailable plant molecules (pharmacokinetics, PK) and the dynamic changes of biochemical endpoints (pharmacodynamics, PD) within a single pharmacological experiment have been beyond the scope of traditional research. As a result, evaluation of PK has been a long-standing bottleneck in botanical-based medical and nutritional research.

The pharmacology of multi-component agents, including botanical-based nutraceuticals, represents a “network” approach, in which multiple compounds interact with multiple targets in vivo with interdependent activities to achieve an optimal effect. [90, 91] The traditional approach to understanding the pharmacology of a multi-component agent is to study the effects of single components on single biological reactions, enzymes, genes, etc, and gradually assemble into an integrated picture. However, assembling the results obtained from such a reductionistic approach to achieve a systems understanding of a concerted pharmacological intervention has proven impractical. [8] With such a complex “network” approach involving a large number of multiparametric variables, it is technically challenging to identify the origin of each significantly changed metabolite in the global metabolite pool, and to correlate the dynamic changes between the human (endogenous) metabolome and exogenous (xenobiotic) metabolome. Both endobiotics and xenobiotics in biological samples are inevitably entangled in PK and metabolomics studies. For example, with respect to plant-based therapies, as certain primary metabolites of plants are similar to small molecule endogenous metabolites in animals, the exclusion of one from the other in the analysis of a subject's overall physiological state can be a major problem.

Metabolomics [9] or metabonomics [10], which is the study of metabolite profiles in a biological system under a given set of conditions, has become an approach to understanding the basic principles of relating chemical patterns in biology as well as systems biology. [11, 12] The term, metabolome, has been expanded to include whole metabolite profiles derived from hosts and their symbiotic microbiota. [21, 22] Environmental xenobiotics also furnish a large proportion of the metabolite pool. [20] Thus, metabolomics can also study the dynamic alterations of an endogenous metabolite pool associated with xenobiotic intervention.

Metabolomics, with the capability of simultaneous analysis of hundreds and thousands of variables, meets the requirements for the evaluation of multi-component herbal medicines in vivo and, therefore, can be used to bridge the gap between nutraceuticals/herbal medicine/traditional Chinese medicine (TCM) or other multi-component therapies and molecular pharmacology. [13, 14] Utilizing a metabolomics platform to interpret the efficacies or toxicities of herbal medicines has been a key focus of recent herbal and medicine research. [15, 20] For example, Xie et al. has utilized an advance LC-MS system to characterize the phytochemical profile of Pu-erh tea and the metabolic alterations in response to Pu-erh tea ingestion with chemical and metabolic profiling approach. [57] However, an integrated approach involving metabolomics, pharmacology and PK has not been explored, and is greatly needed for medical research relating to nutraceuticals/plant-based therapies and multi-component therapies.

This application discloses methods and systems for conducting integrated metabolomics, PK, PD and toxicology studies for multi-component therapeutics, where multivariate data analysis is used as a powerful technique for the analysis of a large number of variables to identify bioavailable components and their metabolites as well as significantly altered small molecule endogenous metabolites. Such an integrated approach may be used to link the datasets from multi-component therapeutics to their biological endpoints and the corresponding biochemical changes in animal models and clinical subjects. See Lan and Jia, “An Integrated Metabolomics and Pharmacokinetics Strategy for Multi-Component Drugs Evaluation,” Curr. Drug. Metab. 2010, 11:105-114, which is incorporated by reference in its entirety herein. [97]

### SUMMARY

Pharmacokinetics and pharmacodynamics studies of multi-component agents, including combination chemical compounds, herbal medicines, nutraceuticals and dietary supplements can provide important information required for therapy or maintaining general wellness. The present invention provides methods and systems to perform integrated pharmacokinetic, pharmacodynamic and toxicological studies in a single subject, or multiple subjects. In certain aspects, the methods and systems of the invention may be used to assess treatment efficacy, to predict probable side effects that may be associated with a treatment, and/or to determine optimal dosages and treatment schedules for complex human diseases.

For example, in certain apsects, the methods and systems of the invention may be used for pharmacological analysis of multi-component therapeutic agents, as well as personalized nutrition evaluation involving plant- and/or animal-derived foods and dietary supplements. Example applications include: (1) pharmacokinetic and pharmacodynamic study of compound/combination chemical drugs; (2) metabolomics study of multi-component drug intervention; (3) biomarker discovery for the evaluation of single or multi-component drug intervention; (4) phytochemical compound identification; and (5) nutra-kinetic study of nutritional intervention. Other applications of the methods and systems of the invention are disclosed and claimed herein.

### BRIEF DESCRIPTION OF THE DRAWINGS

The present invention may be better understood by referring to the non-limiting figures included herein.

FIG. 1 illustrates schematic representation of an embodiment of the present invention wherein an integrated metabolomics and pharmacokinetics for the study of a multi-component therapeutic is presented. Steps in performing the study include: (1) Prepare multi-component therapeutic; (2) prepare multi-component therapeutic for analysis of components; (3) prepare multi-component therapeutic for administration to subject; (4) administer multi-component therapeutic to subject; (5) collect samples from subject (e.g., urine, blood, plasma) at different time points for component analysis; (6) conduct component analysis of multi-component therapeutic and samples from subject (e.g., UPLC-QTOFMS and GC-TOFMS analysis) and conduct data acquisition; (7) conduct data analysis with statistical methods (e.g., multivariate and univariate); (8) identification of peak components (e.g., absorbed components from the multi-component therapeutic, biodegradated metabolites of the absorbed components from the multi-component therapeutic, and altered endogenous metabolites from the subject; (9) perform data interpretation of relationships between components of administered multi-component therapeutic and altered endogenous metabolites and visualization for PK, PD and toxicology studies.

FIG. 2 illustrates an of an embodiment of the present invention wherein an integrated PK and PD approach is taken to assess the effect of multi-component therapeutics. The multi-component therapeutic profile is the chemical profile of components in the multi-component therapeutic. The pre-dose metabolome is the metabolic profile of a subject at time prior to administration of the multi-component therapeutic. The post-dose metabolome is the metabolite profile of the subject at a time point after administration of the multi-component therapeutic. The differential metabolites are selected by comparing the post-dose metabolome with the pre-dose metabolome using statistical analysis. Absorbed components from the multi-component therapeutic are obtained by identifying the shared variables between the multi-component therapeutic profile and the differential metabolites using a similarity analysis technique (dashed lines). The shared variables between the pre-dose metabolome and the differential metabolites are the altered endogenous metabolites within the subject. The remaining differential variables are the biotransformed plant components. These components can be used to conduct PK, PD and toxicology analyses

FIG. 3 shows the role of metabolomics in the relationship between pharmacokinetics (PK), pharmacodynamics (PD) and toxicology (TOX) of the multi-component therapeutics where a normal (left ellipse) or abnormal (right ellipse) subject metabolome represents a healthy state or diseased state. A multi-component therapeutic intervention is represented by the multi-component therapeutic profile (center box). Etiological factors, including a pathogen or xenobiotics, will perturb the global metabolome to an abnormal state (arrow 1). Multi-component therapeutic intervention may result in a systems recovery of the subject metabolome (arrow 2). The “system to system” interactions between the subject biological systems and the multi-component therapeutic will, therefore, be elucidated by an integrated metabolomics and PK-PD or PK-TOX strategy.

FIG. 4 illustrates variables in a combined plant metabolomics and human/animal metabolomics strategy for PK studies of multi-component herbal medicines in accordance with an embodiment of the present invention, where the window with the dashed line indicates the complexities derived from the individual variations, and where the dark to lighter-shaded multiple-blocks at the top of the box on the right side of the figure represents the complexities derived from the plant metabolome, which may overlap with the lightly-shaded food ingredients in the bottom of the box.

FIG. 5 shows a proposed method for an integrated metabolomics and PK study of a multi-component therapeutic, specifically, for example, in the context of herbal medicines, in accordance with an embodiment of the present invention. The method results in the identification of bioavailable plant components and their metabolites, as well as the significantly altered endogenous metabolites. The multi-shaded box on the right side represents the component profile of the multi-component therapeutic (e.g., plant metabolome of an herbal medicine), which can be derived from chromatographic and spectrometric analysis of the herbal medicine. The multi-shaded box on the left represents the metabolome of control/vehicle group (“pre-administration metabolome) as determined by chromatographic and spectrometric analysis of a subject sample (i.e., the subject prior to administration of the multi-component therapeutic). The multi-shaded box in the center represents the post-administration metabolome of the subject/group after multi-component therapeutic intervention, as determined by chromatographic and spectrometric analysis of a subject sample(s). Differential variables (i.e., metabolized and/or biotransformed components) in a subject sample. Differential variables, as represented in the multi-shaded box in the center, resulting from the multi-component drug intervention are derived from univariate analyses, such as, for example, analysis of variance (ANOVA), and multivariate analyses. Manual or computer-aided similarity analysis techniques can be used to compare and differentiate these variables. The identified bioavailable plant components and their in vivo metabolites may be further investigated at different time points for PK analysis of herbal medicines.

FIG. 6 illustrates a conceptual diagram of the arbitrary threshold for biomarker screening in the loadings plot in accordance with an embodiment of the present invention, where dots, triangles and squares represent the locations of variables in the loadings plot. The threshold for biomarker screening is arbitrarily set. When a higher threshold (outer dashed line) is set, only the variables in triangles are selected as potential markers. When a lower threshold was set (inner dashed line), the variables in dots are to be selected, which greatly augmented the number of differential variables.

FIG. 7 shows representative base peak intensity (BPI) chromatograms of pu-erh tea and urine at different time points derived from UPLC-QTOFMS analysis. Panel A shows the pu-erh tea BPI chromatogram prior to administration to subjects; and the BPI chromatogram of subject urine immediately after administration of pu-erh tea. Panels B, C and D shows the BPI chromatogram of subject urine 1 and 3 hrs, 6 and 9 hrs, and 12 and 24 hrs after administration of pu-erh tea, respectively.

FIG. 8 shows a representative total ion current (TIC) chromatograms of pu-erh team and urine at different time points derived from GC-TOFMS analysis. Panel A shows the pu-erh tea TIC chromatogram prior to administration to subjects; and the TIC chromatogram of subject urine immediately after administration of pu-erh tea. Panels B, C and D shows the TIC chromatogram of subject urine 1 and 3 hrs, 6 and 9 hrs, and 12 and 24 hrs after administration of pu-erh tea, respectively.

FIG. 9 shows PCA scores plot obtained from subject urine samples at different time points after administration of pu-erh tea. The PCA scores plots shows a clustering of the urine samples obtained before and after pu-erh tea ingestion and dynamic altered trajectory in a time-dependent manner. The data points reflect the overall metabolic status of a subject different time points (0 hr (), 1 hr (▪), 6 hr (♦), 9 hr (▾), 12 hr (*), and 24 hr (◯)).

FIG. 10 shows the urine concentration-time courses of representative absorbed plant metabolites, biotransformed plant metabolites and altered endogenous metabolites from subject samples after Pu-erh tea intake. Panel A shows urine concentration-time courses of absorbed Pu-erh tea components. Panel B shows urine concentration-time courses of biotransformed Pu-erh tea components. Panel C shows a time-dependent trajectory of metabolite profiles at different time points after Pu-erh tea intake. The PCA scores plot showed a time dependent trajectory of urinary metabolites which clustered at different spatial positions and time points.

FIG. 11 shows the effect of Pu-erh tea intake on human metabolite endpoints. Panel A shows a heatmap showing differences in altered endogenous metabolites detected from the metabolome after Pu-erh tea intake (post-dose) as compared to pre-dose metabolome. “I” represents metabolomic changes at 24 h post-dose relative to pre-dose; “II” represents 2 week post-dose vs. pre-dose; and “III” represents 2 week wash-out vs. pre-dose. Each cell in the heat map represents the fold change between the two time points, e.g., post-dose vs. the pre-dose) for a particular metabolite. It visualizes the level of each metabolite in each sample ranging from high (white) over average (grey) to low (black). Panel B shows a 3-D PCA scores plot of urinary metabolic profiles at pre-dose (white spheres), 24 h post-dose (light grey spheres), 2 week post-dose (dark grey spheres), and 2 week wash-out post-dose (black spheres).

FIG. 12 shows OPLS-DA scores plots and S-plots of metabolomic comparison among samples taken 24 hrs and 2 week post-pu-erh tea administration, and 2 weeks after terminating pu-erh tea ingestion (2 week wash-out), based on the spectral data of UPLC-QTOFMS analysis (Panel A) and GC-TOFMS analysis (Panel B).

FIG. 13 shows the correlation of absorbed plant metabolites, metabolites produced through in vivo biotransformation, and altered endogenous metabolites in response to Pu-erh tea exposure. The relationships among three groups of compounds were visualized in the form of correlation maps, which displayed by solid (positive) or dashed (negative) lines.

FIG. 14 shows a representative system embodiment of the present invention.

### DETAILED DESCRIPTION

The following descriptions are meant to clarify, but not limit, the terms defined. If a particular term used herein is not specifically defined, such term should not be considered indefinite. Rather, terms are used within their ordinary meanings. Unless otherwise defined, all technical and scientific terms used herein have the same meaning as commonly understood by one of ordinary skill in the art.

Unless indicated to the contrary, the numerical parameters set forth in the following specification are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

It is further noted that, as used in this specification, the singular forms “a,” “an,” and “the” include plural referents unless expressly and unequivocally limited to one referent. The term “or” is used interchangeably with the term “and/or” unless the context clearly indicates otherwise.

Also, where ranges are provided, it is understood that other embodiments within the specified ranges are to be included.

As used herein, a “subject” or an “individual” may be an animal. For example, the subject or individual may be a mammal. Also, the subject or individual may be a human. The subject or individual may be either a male or a female. The subject or individual may also be a patient, where a patient is an individual who is under dental or medical care and/or actively seeking medical care for a disorder or disease.

As used herein, “metabolism” refers to the set of chemical reactions that occur in a living organism to maintain life. Metabolism is usually divided into two categories: catabolism and anabolism. Catabolism is a set of chemical reactions that breaks down organic matter (e.g., to harvest energy in cellular respiration). Anabolism is a set of chemical reactions that use energy to construct components of cells (e.g., protein and nucleic acid synthesis). Xenobiotic metabolism involves the detoxification and removal of xenobiotics. Redox metabolism involves the removal of damaging oxidants by antioxidant metabolites and enzymes such as catalases and peroxidaes.

As used herein, a “metabolite” is an intermediate or product of metabolism. The team metabolite is generally restricted to small molecules. A “primary metabolite” is a metabolite directly involved in normal growth, development, and reproduction (e.g., alcohols, amino acids). A “secondary metabolite” is a metabolite not directly involved in those processes, but that usually has an important ecological function (e.g., antibiotics, flavones, pigments, alkanoids). Some antibiotics use primary metabolites as precursors, such as actinomycin which is created from the primary metabolite, tryptophan. Flavones, a class of flavonoids based on the backbone of 2-phenylchromen-4-one, are created from cinnamoyl-CoA, a product of phenylalanine, via extension and cyclization of the carbon chain. For the purposes of the present invention, the term metabolite does not refer to molecules such as nucleic acids or proteins. Rather, for the purposes of the present invention, the term metabolite refers to the small molecules (<1000 dalton) intermediates and products involved in metabolic pathways such as glycolysis, the citric acid (TCA) cycle, amino acid synthesis and fatty acid metabolism, amongst others.

As used herein, “metabolome” or “metabonome” refers to the complete set of small-molecule metabolites (such as metabolic intermediates, hormones and other signaling molecules, and secondary metabolites) found within a biological sample, such as a single organism.

As used herein, a “multi-component therapeutic agents” or “multi-component therapeutic” is a concerted pharmacological intervention of multiple compounds interacting with multiple targets which may possess mutually interdependent activities that are required for optimal effect. A multi-component therapeutic may include a drug cocktail, a nutraceutical, or an herbal medicine.

As used herein, “nutracuetical” refers to a food product that provides health and medical benefits, including the prevention and treatment of disease. Such products may range from isolated nutrients to dietary supplements to genetically engineered foods, herbal products. For example, a nutraceutical may be a food stuff, such as, e.g., a fortified food or a dietary supplement, that provides health benefits. A nutraceutical is a product isolated or purified from foods, and generally sold in medicinal forms not usually associated with food and demonstrated to have a physiological benefit or provide protection against chronic disease.

As used herein, “Pu-erh tea” is a variety of post-fermented tea produced in Yunnan province, China. It is also known as Pu'er, Puer, Po Lei or Bolay tea and is sometimes referred to as dark tea. Post-fermentation is a tea production style in which the tea leaves undergo a microbial fermentation process after they are dried and rolled. There are a few different provinces each with a few regions producing dark teas of different varieties. Tea produced in Yunnan are generally named Pu'er, referring to the name of Pu'er county which used to be a trading post for dark tea during imperial China. For the purposes of the data presented herein, pu-erh tea must have been cultivated in Yunnan province, particularly in the Simao district or Xishuangbanna prefecture. The raw material for producing the tea must use fresh leaves of a large-leaved variety of Camellia sinensis, which must undergo post-fermentation processes to produce its unique shape and inherent characteristics.

Individuals each possess a unique metabolic profile characterized by a panel of endogenous metabolites and acquired exogenous metabolites resulting from daily activity and consumption of food (such as fruits and vegetables) and supplements. This “metabolic footprint” conditions individual drug response and personalized intervention strategy.

Aspects of the invention comprise methods and systems of identifying biochemical changes in a subject in response to administration of a multi-component therapeutic and one or more active ingredients in the multi-component therapeutic.

In certain aspects of the invention, the methods comprise (a) determining a component profile for the multi-component therapeutic, (b) determining a pre-administration metabolome in a subject sample before administration of the multi-component therapeutic; (c) determining a post-administration metabolome in a subject sample after administration of the multi-component therapeutic; (d) comparing the component profile for the multi-component therapeutic to the subject's post-administration metabolome, wherein shared components are absorbed components from the multi-component therapeutic by the subject; (e) comparing the subject's pre-administration metabolome to the subject's post-administration metabolome, wherein shared components are altered endogenous components that are differentially expressed by administration of the multi-component therapeutic; wherein components in the subject's post-administration metabolome that are not absorbed components or altered endogenous components are metabolized and/or biotransformed components; and wherein the absorbed components, metabolized and/or biotransformed components and the altered endogenous components are used to characterize the biochemical changes in the subject in response to active ingredients in the multi-component therapeutic.

In some aspects of the invention, the systems comprise (a) a part for determining a component profile for the multi-component therapeutic, a pre-administration metabolome in a subject sample before administration of the multi-component therapeutic, and a post-administration metabolome in a subject sample after administration of the multi-component therapeutic; (b) a part for comparing the component profile for the multi-component therapeutic, the pre-administration metabolome in a subject sample before administration of the multi-component therapeutic, and the post-administration metabolome in a subject sample after administration of the multi-component therapeutic; wherein comparison of results in identification of absorbed components, the altered endogenous metabolites and the metabolized and/or biotransformed components; and (c) a part for analyzing correlations between the absorbed components, the altered endogenous metabolites and the metabolized and/or biotransformed components, wherein correlations between the absorbed components, the metabolized and/or biotransformed components and the altered endogenous components are used to characterize the biochemical changes in the subject in response to active ingredients in the multi-component therapeutic.

Each of the embodiments and aspects of the invention described herein apply to the methods and systems of the invention.

In certain aspects of the invention, the altered endogenous components and the metabolized and/or biotransformed components comprise biochemical changes in the subject in response to administration of the multi-component therapeutic, and the absorbed components comprise components in the multi-component therapeutic that are involved in the biochemical changes in the subject in response to administration of the multi-component therapeutic.

In some aspects of the invention, the multi-component therapeutic is a nutraceutical. In some aspects of the invention, the nutraceutical is an herbal medicine. For example, in some aspects, the nutraceutical is pu-erh tea.

In the aspects of the invention, the sample from the subject comprises a biofluid or a tissue. For example, the biofluid is serum, plasma, urine, saliva.

In various aspects of the invention, the multi-component therapeutic component profile and the subject's pre-administration and post-administration metabolomes determined using chromatographic and spectrometric analytical techniques. In certain aspects of the invention, the chromatographic and spectrometric analytical techniques comprise gas chromatography and/or liquid chromatography coupled with mass spectrometry (MS) and/or nuclear magnetic resonance (NMR).

In aspects of the invention, comparison of the multi-component therapeutic component profile and the subject's post-administration metabolome and comparison of the subject's pre-administration and post-administration metabolomes comprises multivariate and/or univariate statistical analysis. In some aspects of the invention, the shared components are identified using join properties. In various aspects of the invention, the join properties comprise one or more of retention time, accurate compound mass, fragmentation pattern and chemical shift. In some aspects of the invention, the univariate statistical analysis comprises Student's T-test univariate statistical analysis. In some aspects of the invention, the multivariate statistical analysis comprises Pearson product-moment correlation coefficient analysis, wherein pair-wise metabolite vectors are compared at one or more time points before and/or after administration of the multi-component therapeutic to identify linear correlations between the absorbed components, the altered endogenous metabolites and the metabolized and/or biotransformed components. In various aspects of the invention, the pair-wise metabolite vectors comprise one or more of an absorbed component vs. an altered endogenous metabolite, and a metabolized and/or biotransformed component vs. an altered endogenous component. In some aspects of the invention, the metabolite vectors are also derived using the mean value of a metabolite at more than one time point before and/or after administration of the multi-component therapeutic.

In certain aspects of the invention, the multi-component therapeutic is administered to the subject over time and/or at varying dosages to identify time-dependent and/or dosage-dependent biochemical changes in the subject's post-administration metabolome in response to administration of the multi-component therapeutic.

In various aspects of the invention, the linear correlations identified between the altered endogenous metabolites and the metabolized and/or biotransformed components are used to conduct pharmacodynamic and/or toxicology studies to characterize the biochemical changes in the subject in response to administration of the multi-component therapeutic. In various aspects of the invention, the linear correlations identified between the absorbed components, the altered endogenous metabolites and the metabolized and/or biotransformed components are used to conduct pharmacokinetic studies to characterize the biochemical changes in the subject in response to the one or more active ingredients in the multi-component therapeutic. In some aspects of the invention, the pharmacodynamic and/or toxicology studies can be used to assess efficacy of a treatment with the multi-component therapeutic, to predict probable side effects that may be associated with treatment with the multi-component therapeutic, and/or to determine optimal dosages and treatment schedules for treatment with the multi-component therapeutic for diseases involving the altered endogenous metabolites. In other aspects of the invention, the pharmacokinetic studies can be used to assess efficacy of a treatment with the multi-component therapeutic, to predict probable side effects that may be associated with treatment with the multi-component therapeutic, and/or to determine optimal dosages and treatment schedules for treatment with the multi-component therapeutic for diseases involving the altered endogenous metabolites. In various aspects of the invention, the absorbed components, the altered endogenous metabolites and the metabolized and/or biotransformed components comprise one or more compounds selected from the compounds listed in Tables 1-5.

PK studies typically involve profiling time-dependent changes of xenobiotics and their derived metabolites in vivo. However, because of potential drug-drug interactions in multi-component agents, the appropriate PK assay for such agents, as encompassed in aspects of the present invention, should simultaneously identify several groups of compounds. For example, a plant based nutraceutical intervention can be regarded as a process in which a plant metabolome interacts with an individual's biological system, which encompasses the individual's genome, proteome and metabolome. When plant derived compounds, such as a group of tea polyphenols, enter into an individual's body, significant changes can occur in the metabolite composition in the blood pool in a time-dependent manner. The metabolome will generally be comprised of: (1) a group of exogenous compounds absorbed in the circulating system, (2) a group of exogenous compounds transformed by hepatic enzymes and gut microbes, and (3) a group of endogenous metabolites that are significantly altered in response to the intake of the plant derived compounds. As such, a PK assay for a plant-based nutraceutical or herbal medicine intervention may assess the bioavailable phytochemical compounds in the herbal medicine (“what are absorbed”), the new compounds produced through in vivo biotransformation (“what are produced”), and the in vivo xenobiotic biotransformation time course of each.

The comparison of a disease-model profile with the drug-response profile can reveal, at a molecular level, the dynamic effects achieved by multi-target interactions of multi-component therapeutics. The methods and systems of the invention allow for the use of high throughput biochemical analyses coupled with chemo-informatics to address the in vivo evaluation of multi-component agents.

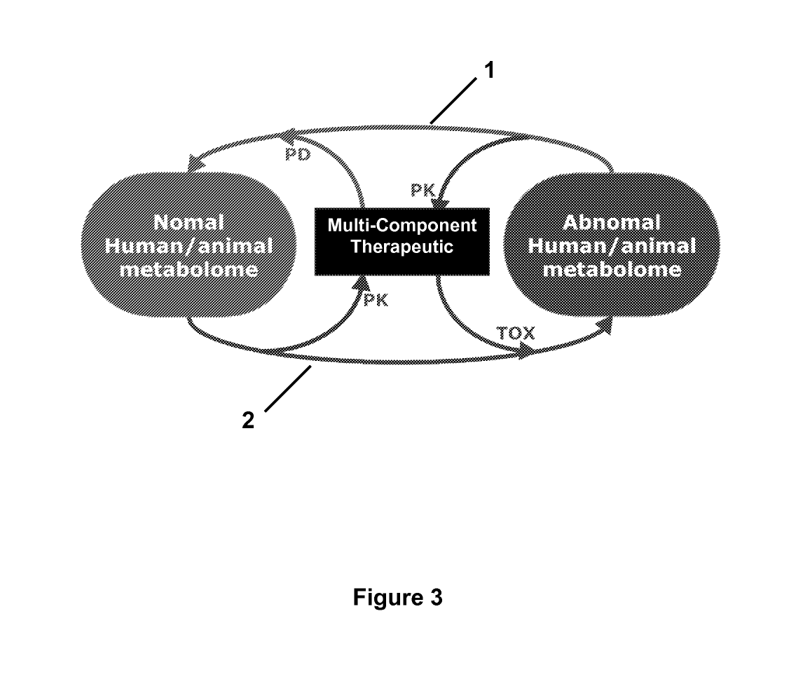

In some aspects of the invention, disease may result in a series of states which correspond to a characteristic change in the regulatory network due to perturbations by environmental factors and genetic alterations. The goal of a drug treatment is to reverse disease processes before irreversible pathologies are established or to restore homeostasis via multiple biochemical mechanisms and multi-component interactions, resulting in a trajectory of system recovery from a perturbed, unhealthy state to a healthier state closer to homeostasis. A systems pharmacology using an integrated metabolomics and PK-PD or PK-TOX strategy will be able to meet the unmet needs in the in vivo evaluation of multi-component therapeutic agents, such as herbal medicines. The role of metabolomics in the relationship between PK, PD and TOX of herbal medicines is outlined in FIG. 3.

In certain embodiments, the methods and systems of the present invention may be used to analyze the efficacy of a multi-component therapy used as a front-line defense against disease, aiming at long-term corrective treatment. There is clearly a need to design a pharmacological tool that will reflect and assess the holistic efficacy of the multi-component drug candidates. Acquisition of a complete and dynamic panel of pharmacokinetic parameters for multi-component dosage regimen to achieve a desired therapeutic efficacy of drug in the body will be essential to minimize the drug toxicity, reduce the overdosing or drug complications, keep health care at minimum cost and ultimately increase the patient compliance.

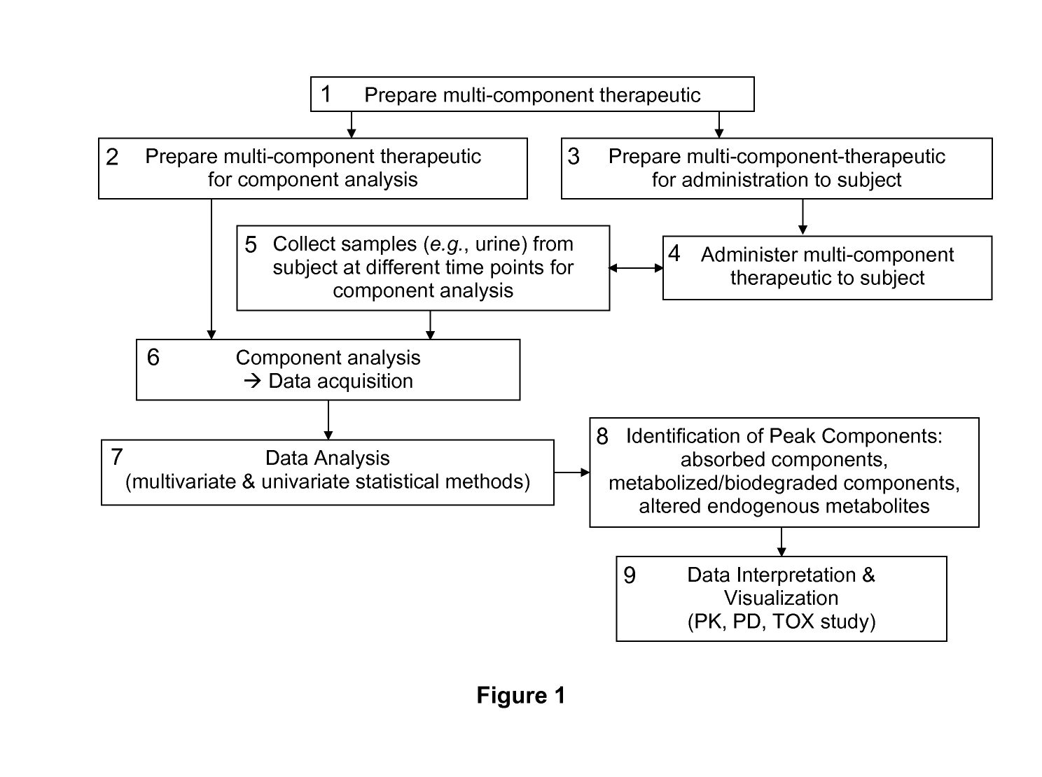

In an aspect of the invention, the treatment of a human disease or a disease model using multi-component therapeutic agents is regarded as a “system to system” approach; specifically, for example, with regards to herbal medicines, a plant metabolome interacting with human/animal biological system encompassing their genome, proteome and metabolome. The goal of integrated metabolomics and PK studies of multi-component therapeutics is firstly to identify “what are absorbed” and “what are produced” in the global metabolites pool, as well as to present their time-dependent alterations. Many important variables are included in such a “system to system” strategy, as illustrated in FIGS. 1, 2 and 4.

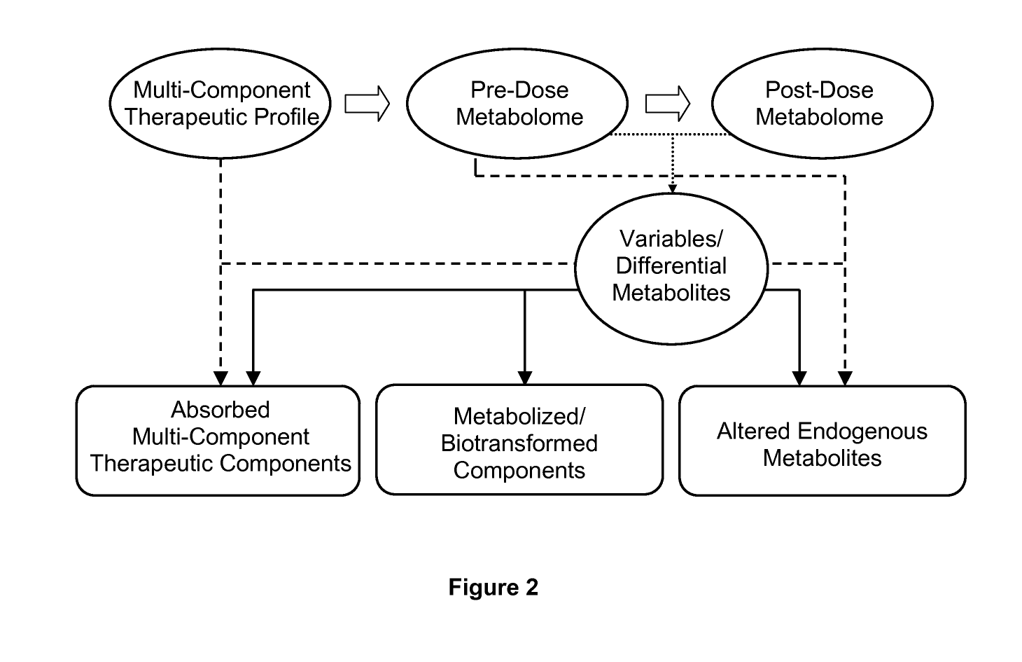

In certain aspects of the methods and systems of the invention, of the three categories of metabolite—“what are absorbed”, “what are produced” and “what are influenced”—the former two can be subjected to PK analysis. The third category of metabolites—the metabolomic data—which is not investigated in PK study, is the representation of the physiological alteration resulted from multi-component therapeutic intervention, which is associated with PD or TOX study. [15-19]; FIGS. 2, 4 and 5. Using metabolomics strategy, it is possible to integrate the PK, PD and TOX studies of herbal medicines, to become a new approach to a “systems” pharmacological research of multi-component herbal medicines.

Thus, embodiments of the present invention integrate metabolomics with pharmacokinetics to provide a quantitative assessment of a subject. The methods and systems of the invention may be used for pharmacological analysis of multi-component therapeutic agents, as well as personalized nutrition evaluation involving plant- and/or animal-derived foods and dietary supplements. Aspects of the invention include methods and systems for: (1) pharmacokinetic and pharmacodynamic study of compound/combination chemical drugs; (2) metabolomics study of multi-component drug intervention; (3) biomarker discovery for the evaluation of single or multi-component drug intervention; (4) phytochemical compound identification; and (5) nutra-kinetic study of nutritional intervention. However, for the sake of understanding the invention, the invention will generally be described below with respect to pharmacokinetic and pharmacodynamic study of a plant-based dietary supplement; specifically, an embodiment where the plant-based dietary supplement is pu-erh tea.

As such, in an embodiment of the present invention, an integrated metabonomic profiling strategy is used for PK and PD studies of multi-component drugs using tandem mass spectrometry (MS). In one aspect, the interaction between a multi-component therapeutic and a mammalian biological system will result in a time-dependent alteration in the mammalian metabolic pathways in response to the in vivo absorption and biodegradation and/or metabolism of components of the multi-component therapeutic. In another aspect, the measurement of dynamic changes in mammalian metabolic endpoints (pharmacodynamics) and changes in concentration of components of the multi-component therapeutic and metabolites in biofluids (e.g., blood and urine) (pharmacokinetics) can be achieved simultaneously using a MS-based global profiling approach. In some aspects, the multi-component therapeutic may be a nutraceutical, which in turn may be a traditional Chinese medicine or herbal medicine. In one aspect, the nutraceutical is Pu-erh tea.

An aspect of the invention is the differentiation of at least three categories of components (panels of variables) by the methods and systems of the present invention: the absorbed metabolome components from the administered therapeutic, the biotransformed metabolome components of the administered therapeutic, and the host metabolites altered by the administered therapeutic.

In another aspect of the invention, the multi-component therapeutic may be multiple compound chemical drugs, such as, for example, a chemotherapy cocktail. Thus, in certain aspects, the described methods and systems of the invention may be used for the PK, PD and toxicology study of multiple compound chemical drugs. Identification of pharmacokinetic properties of multiple drug components aids in the clarification of possible toxic or pharmacologically-active drug metabolites, and can also be used for the design of the next generation of drugs to circumvent an undesired metabolic fate of certain drug components. The methods and systems of the invention enable the combination study of PK, PD, and toxicity in a single in vivo model to assess treatment efficacy, predict probable side effects, and find optimal dosages and treatment schedules. A benefit of the invention is that pharmacological evaluation will be enhanced and the process of pre-clinical study of botanical drug candidates accelerated.

### Metabolomics Approaches

A metabolomics strategy to screen drug metabolites, with no prior knowledge of the compound administered, was first investigated in 2003. [23] Subsequently, Gonzalez, et al. designed several studies which successfully applied a metabolomics strategy to metabolites screening and metabolic pathway alterations in response to single xenobiotics, and extensively reviewed the relevant studies in 2007. [20, 24-28] Thereafter, several reports about in vivo xenobiotic metabolite screening were published, all of which employed urine samples. [29-35]

Recent metabolomics applications in PK studies are summarized in Table 1. Five different study designs were employed (A-E). Study Design A involved metabolite screening through metabolomics based comparison between vehicle treatment and xenobiotic treatment. Study Design B involved metabolite screening through metabolomics based comparison between unlabeled xenobiotic treatment and stable isotope-labeled xenobiotic treatment. Study Design C involved identification of metabolic pathways through metabolomics based comparison among wild-type and genetically-modified animals. Study Design D was a metabolomics approach for identifying human xenobiotics, metabolic enzymes, and polymorphism responsible for ADR. Study Design E was a crossover study design. Other studies using this type of analysis have shown the potential of the metabolomics approach (e.g., 38-40). Due to the complexities of this type of analysis, and the risk of false positive or false negative results, efforts are being made to generate guidelines, standards and protocols to facilitate more broad and consistent technology applications (e.g., for both data processing and data analyses, and analytical methods) (e.g., 41-56).

TABLE 1
Summary of metabolomics applications in PK studies.

| Drugs/Xenobiotics/ | Biological | Bioanalysis | Study | Multivariate | |
|---|---|---|---|---|---|
| Nutrients | Samples | Technique | Design | Analysis | Ref. |
| compound GSK-X | rat urine | LC-TOFMS | A | PCA, | [23] |
| | | | | Ward's HCA | |
| NSC686288 | mouse urine | UPLC-QTOFMS | A, C | PCA | [22], |
| (aminoflavone) | | | | | [24] |
| arecoline and | mouse urine | UPLC-QTOFMS | A | PCA, | [25] |
| arecaidine | | | | PLS-DA | |
| (±)-Arecoline 1- | mouse urine | UPLC-QTOFMS | A | PCA | [26] |
| oxide | | | | | |
| PhIP* | mouse urine | UPLC-QTOFMS | A, C | PCA | [27] |
| 3,4-dehydro- | human urine | UPLC-QTOFMS | D | OPLS | [22], |
| debrisoquine | | | | | [28] |
| acetaminophen | mouse urine | UPLC-QTOFMS | A, B | PCA | [29] |
| ferulic acid and | rat urine | HPLC-QTOFMS | A | PLS-DA | [30] |
| sinapic acid | | | | | |
| vitamin E | mouse urine | UPLC-TOFMS | C | PCA, | [31] |
| | | | | PLS-DA | |
| fenofibrate | rat urine | UPLC-QTOFMS | A | PLS-DA | [32] |
| fenofibrate | monkey | UPLC-QTOFMS | A | PLS-DA | [33] |
| | urine | | | | |
| tolcapone | rat urine | UPLC-QTOFMS | A | PCA | [34] |
| acetaminophen | rat urine | UPLC/MS, NMR | A | PCA, | [35] |
| | | | | PLS-DA | |
| rifampicin, | human | UPLC-TOFMS | A | PCA, OPLS, | [36] |
| phenobarbital and | hepatocytes | | | SUS plot | |
| CITCO** | | | | | |
| cocoa powder | human urine | HPLC-QTOFMS | A | PLS-DA, | [38] |
| | | | | two-way | |
| | | | | HCA | |
| a mix of wine extract | human urine | ¹H NMR | E | ANOVA- | [39] |
| and grape juice | | | | PCA/PLS | |
| extract | | | | | |
| dried black tea | human urine | ¹H NMR | E | ANOVA- | [40] |
| extract and red grape | | | | PCA/PLS | |
| extract | | | | | |

*2-amino-1-methyl-6-phenylimidazo[4,5-b]pyridine
**6-(4-chlorophenyl)imidazo[2,1-b][1,3]thiazole-5-carbaldehydeO-3,4-dichlorobenzyl) oxime

In an aspect of the invention, the use of metabonomics strategy in pharmacological study has several important advantages over conventional approaches for multi-component therapeutics. Such a profiling approach enables systematic integration of the overwhelming amount of relevant information, including changes in gut microbiota, aging, diet, diurnal variation, mental states, etc., that has accumulated from endogenous metabolite analyses. Further, this approach helps in establishing a mechanistic understanding of dynamic drug actions, including disposition and drug-drug interactions of the multi-component exogenous compounds within an organism, which is a marked shift from the traditional ‘black-box’ approach to a new phase of drug discovery. Finally, this comprehensive approach combines PK, PD, TOX studies in a single in vivo model that assesses treatment efficacy, predicts probable side effects, and finds optimal dosages and treatment schedules for complex diseases.

### Aspects of Metabolomics Study Preparation

In some aspects of the invention, the metabolomic changes can be regarded as a drug response profile consisting of “pharmacodynamic” endpoints, which can be used to evaluate the pharmacological or beneficial effects of a multi-component therapeutic intervention.

In certain aspects, the methods and systems of the invention are used to analyze plant products and/or plant-derived products, that may be consumed by a subject. For example, the same plant species grown in different regions and harvested in different seasons may have distinct chemical compositions. [14] There has always been a problem with how to control the quality of herbal medicine. Plant metabolomics, which provides deep insight into the plant metabolic networks [58, 59], has been successfully used in evaluating the quality and variability of herbs. [60-64]. However, the question regarding which marker(s) should be controlled and monitored in a plant, should be answered by the pharmacology of herbal medicine, in which PK profiles can provide the most relevant guidance. The next question is, which one comes first: PK studies or quality controls? In an embodiment, quality control of herbal medicine is of utmost importance for any studies to have baseline assurance, as well as reproducibility of experimental results. Then, the variation of plant metabolome should be carefully considered and well controlled before a PK study. Without detailed information about the plant composition, it may be difficult to interpret the results of bioactivity. Understanding the composition of the plant will greatly help with the interpretation and characterization of markers for quality control. Therefore, PK studies, as well as their corresponding pharmacological or toxicological studies, can benefit from controlling the phytochemical characterization and quality control of herbal medicines. Thus, aspects of the present invention provide that the PK study of a specific herbal medicine should be accompanied by a global plant metabolome profiling study. Preliminary explorations may, but are not required to begin with commercially available and well quality-controlled medicinal plant and extracts.

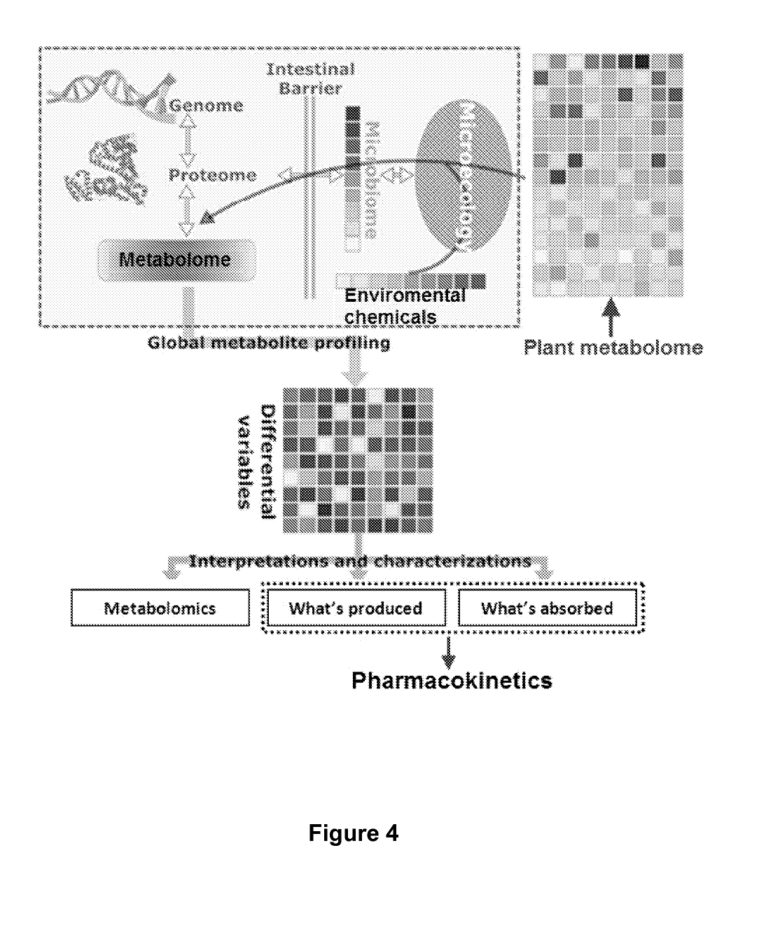

Even when variations from a test herbal medicine are well controlled and its composition is fully revealed, additional problems may still remain, for example, the ingredients of an herbal medicine may overlap to some extent with the food ingredients that the experiment subject receives (see FIG. 4). Both of them will be processed by the host's metabolic network as well as symbiotic gut microbiota. [65, 66] As subtle variations in diet during the study period might lead to certain false positive biomarkers, a strict diet control may, in certain aspects of the invention, be used to minimize the baseline individual variations.

Mammalian biocomplexity, which can bring confounding factors responsible for significant inter-subject biochemical variation in metabolism to the study of metabolomics, has had significant clarification using global systems biology studies. [67, 68] Metabolic variations in humans may be generally greater than controlled animal models due to the diversity in genetic and environmental factors, differences in diet, diurnal changes, gender, health status, and a wide range of lifestyle components such as smoking, alcohol consumption, and physical activity. [69] In fact, many of these biological variations have contributed to varied drug responses in randomized clinical trials, especially for herbal medicines. [70, 71] Mild treatment effects are often largely overwhelmed by the significant biological variations between subjects. [39] Thus, in certain aspects of the invention, one or more of these factors in the study cohort should be controlled for as much as possible. Also, an individual human/animal metabolome is continually changing with time. Thus, an aspectof the methods and systems of the invention is deciding whether to compare an instant metabolome or an average metabolome within a time course.

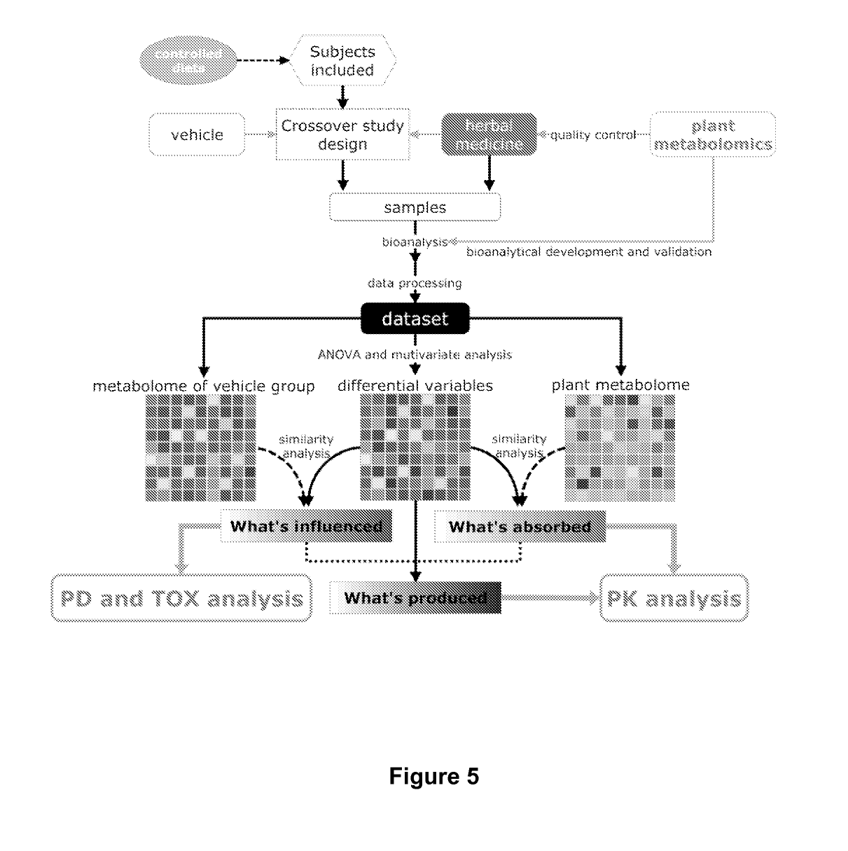

Thus, the present invention provides a strategy for an integrated metabolomics and PK study on a multi-component therapeutic such as a herbal medicine (FIG. 5). In certain aspects, the criteria for subject inclusion are carefully considered, such as gender (male, female or both), age, body weight, and so on. Also in certain embodiments, a two-way crossover study design is employed. In some aspects, a controlled diet recipe may be used throughout the study to minimize the number of ingredients concurrent in the herbal medicine to be tested. In certain aspects where a nutraceutical or an herbal medicine is assessed, the nutraceutical or herbal medicine may be characterized and orally administrated against control vehicles. In some aspects, biological samples (e.g., urine, serum, blood or other) are collected for assessment of the subject metabolome. In certain aspects, the analytical method used may be a combined LC-MS and GC-MS approach In some aspects, the analytical method is optimized during characterization of the components of the multi-component therapeutic.

In an aspect of the invention, various methodologies for sample collection may be used. Urine samples may be used to present the average metabolome, while serum and plasma are may be used to present an instantaneous metabolome. In certain aspects, an average metabolome might present less individual variations than an instant metabolome does. Additionally urinary metabolomics is advantageous in that urine sample is non-invasive and easily accessible, can be made in large volumes, and contains high metabolite concentration. Efficient and timely quenching is necessary to prevent biodegradation during urine collections. For example, in a rat study, urine collection is time consuming, and easily contaminated by feces. Ice-water bathed tubes containing sodium azide are commonly recommended for urine collections. The longer the collection period is, the more pitfalls might be included. Serum collection also incorporates a period for blood clotting at 37° C. In contrast to serum and urine, plasma can be timely collected and well-controlled. However, the necessary sample processing of plasma before analysis brings more potential problems with the reproducibility of bioanalysis.

In some aspects of the invention, multiple time points are chosen in the study design for sample collections. In one aspect of the invention, wherein multiple time points are chosen, a semi-quantitative time course for each of the identified bioavailable plant components (absorbed in vivo) and their derivatives (metabolized in vivo) can be obtained, to reflect a complete pharmacokinetic profile of the botanical agent. This has been partially demonstrated in the context of a tea, however, the quantitative measurement of the bioavailable and biodegraded plant components were limited by the sensitivity of the NMR technique. [40]

### Aspects of Analytical Methods

In some aspects of the invention, the metabolomic changes can be regarded as a drug response profile consisting of “pharmacodynamic” endpoints, which can be used to evaluate the pharmacological or beneficial effects of a multi-component therapeutic intervention.

In a preferred aspect of the invention, metabolomic-based PK, PD and toxicology studies of multi-component therapeutic involve a quantitative and dynamic metabolomic measurement to correlate the fluctuation of bioavailable multi-component therapeutic components with the response of subject metabolome. Such measurements involve significant bioanalytical strength and bioinformatics effort.

One challenge addressed by the methods and systems of the present invention in the analysis of an integrated metabolomics and PK, PD and toxicology studies of multi-component therapeutics, is how the variable profiles of multi-component therapeutic and the human/animal metabolome, including the subject's symbiotic microbiome, are converged in a biological organism so as to accurately and completely capture a global metabolite profile for the subject with a single analytical platform, such as mass spectrometry or nuclear magnetic resonance spectroscopy (NMR). [75]. The sensitivity, resolution and reproducibility of an analytical method should be well balanced to minimize the inclusion of possible false positive and false negative results. In an embodiment, abundance of the signals in metabolomic data sets is determined, firstly, by sensitivity; secondly, by resolution; thirdly, by reproducibility.

In one aspect of the invention, the components of a multi-component therapeutic and subject metabolome are determined using NMR. The advantages of NMR techniques are high-throughput, minimal requirements for sample preparation, and the non-destructive analysis of the biological samples. However, the relatively low sensitivity of NMR and metabolite identification based on mere chemical shift, can limit the applications of NMR in the study involving multi-component mixtures.

In another aspect of the invention, the components of a multi-component therapeutic and subject metabolome are determined using mass spectrometry. In some aspects, liquid chromatography-mass spectrometry is used. Ultra-performance liquid chromatography—quadruple time-of-flight mass spectrometry (UPLC-QTOFMS), an advanced version of a conventional LC-MS system, has achieved high throughput and high sensitivity, and therefore, has recently become a prevailing method used in this field, as indicated in Table 1. However, there are challenges with this method, and completely reliable LC-MS methods for metabolomics analysis are still being developed. For example, mass spectrometry-based techniques usually require lengthy sample preparations, which can cause metabolite loss and degradation, depending on the sample introduction system and the ionization technique used. [76] In addition, reproducibility and repeatability can be problematic with the application of LC-MS based methods [45], due to the potential drift in both chromatographic and mass-spectrometer performance and the problems associated with both ion suppression and enhancement. [77] A subtle, gradual change in the performance of the system over time will lead to a result which may be closely related to the run order, rather than any differences in the samples. [45, 47] False negative results are more acceptable than false positive results; therefore, reproducibility should be considered first and fully validated, even if sensitivity is sacrificed. A reliable LC-MS method with adequate reproducibility is critical to monitor and screen the pitfalls in each minor manipulation of the workflow.

Compared to traditional in vitro and in vivo methods in drug metabolism, the metabolomics approach using liquid chromatography coupled with mass spectrometry (LC-MS) shows clear advantages in the capacity of handling a great number of variables, hence, large datasets, and in the graphical representation of metabolism-related sample classification, as well as in the identification of drug compounds and significant drug metabolites. A recent publication also reported the use of the metabolomics approach in an in vitro hepatocyte assay to separately capture both drug derived metabolites and drug induced metabolites. [36]

In some aspects, gas chromatography-mass spectrometry (GC-MS) is used. However, a major shortcoming of GC-MS is that chemical derivatization is an essential prerequisite prior to analysis.

In some aspects, a combined LC-MS and GC-MS approach is used. A combined LC-MS and GC-MS approach can take advantage of complementary outcomes to amplify the vision of metabolite profiling. [78, 79] When combined with LC-MS, the major shortcoming of GC-MS, that chemical derivatization is essential prerequisites prior to analysis, might become an advantage, as various chemical derivatization approaches can act as a silencer or an activator for detections of specific groups of metabolites, thus facilitating good variable differentiation in data analysis, interpretation and characterization. Some other multiple dimensional separation techniques, such as GC×GC and LC×LC, are promising as well to increase the number of metabolites detected in the global metabolites profiling. [46, 80]

As such, in an aspect of the invention, the administered therapeutic and samples from subjects to whom the therapeutic is administered are analyzed by ultra-performance liquid chromatography-quadrupole time-of-flight mass spectrometry (UPLC-QTOFMS) and gas chromatography time-of-flight mass spectrometry (GC-TOFMS) to identify the origin of each significantly altered metabolite in a global metabolite pool resulting from the dietary intervention.

### Aspects of Data Analysis

In an aspect of the invention, effective and reliable strategies to differentiate components of the metabolome are of key importance for the PK, PD and toxicology studies of multi-component therapeutics. For example, in one aspect, components of the multi-component therapeutic and the subject metabolome determined before and/or after administration of the multi-component therapeutic can be annotated with available reference standards. For example, there are several reference spectral libraries and databases that are available for metabolomics. These include GC-MS, liquid chromatography (LC)/MS, electrospray ionization (ESI)-MS, Fourier transform (FT)-MS, and NMR spectral libraries. Representative spectral libraries or databases that are commonly used in metabolomics include the resource library from the U.S. National Institute of Science and Technology database (NIST, http://www.nist.gov/srd/nist1a.htm), the Golm Metabolite Database (GMD, http://csbdb.mpimp-golm.mpg.de/csbdb/gmd/gmd.html) (Kopka et al. 2005), MassBank (http://www.massbank.jp) (Horai et al. 2008), METLIN (http://metlin.scripps.edu) (Smith et al. 2005), the Human Metabolome Database (HMBD) (http://www.hmdb.ca/) and the Madison Metabolomics Consortium Database (MMCD, http://mmcd.nmrfam.wisc.edu/) (Cui et al. 2008; Markley et al. 2007). In an aspect of the invention, in-depth interrogation and characterization of these variables in m/z and retention time may be conducted during data analysis to avoid false-positive results. In another aspect, false positive or false negative results in the differential variables identified from the data analysis may be minimized by using a strong quality control protocol to eliminate the compositional variation of nutraceutical preparations (e.g., Pu-erh tea) and dynamic analytical variations during the instrumental analyses.

Statistical analysis may be used in various aspects of the methods and systems of the present invention. In one aspect, shared and unique structure (SUS) plot [37], which enables the comparison of different treatments having the same control, may be used to allow separation of clearly exogenous variables (multi-component therapeutic components) from endogenous metabolites (biomarkers). Another report discussed the urinary metabolomic alteration after cocoa powder consumption [38]. In another apect, combined partial least square discriminant analysis (PLS-DA) and two-way hierarchical clustering (two-way HCA), with Bonferroni correction as a filter, were employed to unravel the complex relationship between the consumption of phytochemicals and their expected bioefficacy.

In some aspects, an unsupervised method can be used first to monitor the time-dependent metabolome perturbations and establish inter-group differentiation. In some aspects, the unsupervised method is a PCA scores plot of the data set of the two groups at the same time points. In some aspects, multilevel PCA and multilevel PLS-DA may be employed to enable a separate analysis and interrogate the variables generated from the different interventions (multi-component therapeutic and vehicle) in the crossover design. The Receiver Operating Characteristic (ROC) curve may be utilized as a measure to validate the robustness of the multivariate models. [84] In additional aspects, the criterions for biomarker selection may be based on appropriate statistical methods, such as, e.g., permutation tests.

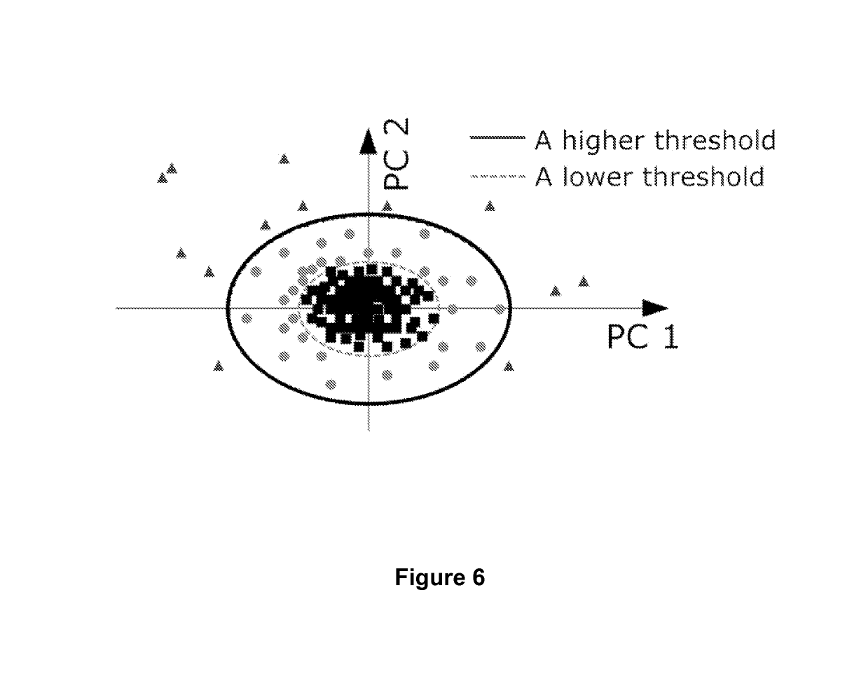

In aspects of the invention, various data pretreatment methods, such as centering, scaling, and transformations, may be utilized to minimize variability in the biological samples and detection. In various aspects, a data pretreatment method may be selected based on the expected effect on the data analysis, with different methods having different merits. [81] In selecting a data pretreatment method, the more abundant the signals observed in the data set, the less false negative results and more possible false positive results might be included; which results in greater difficultly with data handling, multivariate analysis, biomarker interpretations and characterizations. In some aspects, for example, when a clear sample clustering is observed in a PCA scores plot with satisfactory multivariate statistical significance, the contribution of variables (m/z and retention time in LC-MS or GC-MS, chemical shift in NMR) to the principal components (PCs) of the scores plot and to the group separation can be examined in the loadings plot. Subsequently, in some aspects, the differential variables (known as biomarkers) can be “captured” in the loadings plot and loading matrix. In certain aspects, this technique can be used to identify significant variables. As illustrated in FIG. 6, in some aspects, a lower threshold will help select more variables, which demands more resource in compound characterizations but potentially generates false positive results; while a higher threshold will rule out certain variables of biological significance. In some aspects, with respect to NMR-based metabolomic studies, rank products (RPs) can be used to evaluate the contributions of variables to PCs. [39, 40, 74, 82, 83]

In one aspect of the invention, the differential variables (e.g., m/z and retention time in LC-MS, for example), regardless of whether the ions are molecular ions, semi-molecular ions or fragment ions, are divided into three groups according to their origin: “what are absorbed”, “what are produced”, and “what are influenced” (the altered endogenous metabolites as a result of drug intervention). To identify the origin of the differential variables is a difficult task. In a recent publication, an SUS plot was used to differentiate exogenous variables (drug metabolites) from endogenous markers by comparing different treatments of hepatocytes with the same control. [37]

In some aspects of the invention, Pearson Product Moment Correlation (“Pearson's”) coefficients are used to find the high linear relationships among three groups of absorbed plant metabolites, metabolites produced through in vivo biotransformation and altered endogenous metabolites in response to nutraceutical exposure. In some aspects, reliable relationship enables identification of the correlated contribution of the bioactive nutrient components and their metabolites for pharmacological effects of the plant, and to evaluate the alteration of the endogenous metabolites. In one aspect of the invention, the Pearson correlation coefficients are used to find the high linear relationships among three groups of absorbed plant metabolites, metabolites produced through in vivo biotransforamtion and altered endogenous metabolites in response to Pu-erh tea exposure.

In some aspects of the invention, the study may use a crossover study design or a randomized block design. To cope with individual metabolic and diet variations, aspects of the methods and systems of the invention may utilize crossover study designs, rather than randomized block designs (which are prevalent in metabolomics studies), for PK analysis of herbal medicines (as is common in PK assay of NCEs). Double crossover design has also been employed in an integrated metabolomics and nutrikinetics analysis. [39, 40] In some aspects, ANOVA-SCA (ASCA) [72-74], a combination of ANOVA and simultaneous component analysis (SCA) may be used to separately analysis and interpret the variables induced by different factors in the design. In certain aspects, the analysis is a multivariate analysis. These multivariate analysis approaches may be ANOVA-PCA and ANOVA-PLS or multilevel PCA and multilevel PLS-DA, and/or ANOVA-SCA (ASCA). Such statistical methodologies may be used to deal with the multivariate dataset from metabolomics analysis with crossover design.

In various aspects of the invention, a single time point may used to represent a subject's metabolome or multiple time points can be used. In certain aspects, the crossover design requires a longer study period. Thus, where using the crossover design, multiple sampling time points, instead of single sampling, may be recommended after the administration of control placebos. In this way, any possible perturbations, caused by some known or unexpected factors other than herbal remedies, could be monitored by inspecting the metabolome after placebo treatment. The more individual variations within and between groups are controlled, the more reliable the results.

In some aspects of the methods and systems of the invention, comparison of a plant metabolome (multi-shaded box on right in FIGS. 2 and 3) with the validated differential variables (multi-shaded box in the center in FIGS. 2 and 3) derived from multivariate analysis is conducted. In aspects of the invention, manual or computer-aided similarity analysis can be conducted between the two data sets (e.g., m/z and retention time) to identify the bioavailable exogenous compounds (what are absorbed) and further characterize them. In some aspects, comparing the metabolome of a control group (multi-shaded box on left in FIGS. 2 and 3) to the differential variables using same approach can identify significantly altered endogenous metabolites, i.e., the metabolomic information. In certain aspects, metabolomic changes associated with herbal medicine intervention can be regarded as a drug response profile, which can be used to improve the activity spectrum of a multi-component therapeutic such as, for example, a herbal medicine, or to revise drug combinations for a better holistic therapeutic effect. In various aspects, the above-described comparison analyses (i.e., similarity analyses) can be performed with the aid of web-based resources such as the Human Metabonome Database (HMDB) of the Human Metabolome Project (http://www.hmdb.ca/), and the Metabolite and Tandem MS Database (METLIN) from the Scripps Center for Metabolomics (http://metlin.scripps.edu) for mass spectrometry-based metabolomics, amongst others. [85-87] In some aspects, after these two categories of components (“what are absorbed” and “what are influenced”) are removed from the datasets, the remaining significant components in the biological samples can be deduced to contain new compounds (“what are produced”). In further aspects, interrogation and characterizations of these components (e.g., m/z and retention time) can be conducted to exclude false-positive results. In some aspects where multiple time points are set in the study design for sample collections, a semi-quantitative time course for each of the identified bioavailable multi-component therapeutic components (what are absorbed) and their in vivo metabolites (what are produced) can be obtained. [40] In some aspects, a semi-quantitative time course for the identified bioavailable multi-component therapeutic components and their metabolites can be used to generate a semi-quantitative PK profile of the components of the multi-component therapeutic. In other aspects where a quantitative PK analysis is conducted, analytical approaches will include more stringent criteria.

### EXAMPLES

### Example 1

### Chemicals and Materials

The chemicals and Pu-erh tea used in this study were identical to those used in our previous study [57], which is incorporated herein by reference in its entirety.

Leucine-enkephalin and formic acid were purchased from Sigma-Aldrich (St. Louis, Mo., USA). Acetonitrile and methanol of HPLC grade were obtained from Sigma-Aldrich (St. Louis, Mo., USA). All aqueous solutions were prepared with ultrapure water produced by a Milli-Q system (18.2 MCI, Milipore, Bedford, Mass., USA). The chemical standards were purchased from Sigma-Aldrich (St. Louis, Mo., USA), J & K Chemical Ltd (Shanghai, China), Shanghai Shunbo Bioengineering Co, Ltd (Shanghai, China), and the National Institute for the Pharmaceutical and Biological Products (Beijing, China).

Genuine pu-erh tea has the following four characteristics. It must have been cultivated in Yunnan province, particularly in the Simao district or Xishuangbanna prefecture. The raw material for producing the tea must use fresh leaves of a large-leaved variety of Camellia sinensis, which must undergo post-fermentation processes to produce its unique shape and inherent characteristics, as set forth by the Chinese Tea Association of Japan. [116] The quality of the pu-erh tea material collected in this study was assessed to ensure that it met the requirements of the local standard DB53/T103-2006 of Yunnan Province, China, as described by the Chinese Tea Association of Japan. [116]; incorporated by reference herein in its entirety.

### Example 2

### Participants and Study Protocol

Approximately 1 kg of 5-year-old Pu-erh tea was mixed to produce a homogeneous sample, and then ground into a fine powder and filtered through a 20 mesh screen. The Pu-erh tea was prepared by infusing 10 g powder in 200 mL boiling water for 10 min, followed by straining. Participants received a dose equivalent to 5 cups of commercially prepared tea. Twenty healthy men (n=10) and women (n=10) whose mean age was 25±2 years (range 22-32) were enrolled in this study, and written consent was obtained from each participant.

The written consent form contained the following information: the purpose of the study (investigate the human metabolic response to pu-erh tea ingestion over a 6-week period using a metabolomics strategy combining UPLC-QTOFMS and multivariate statistical analysis), the participant criteria (men and women, ages 20-35, free of tobacco smoking and alcohol drinking, and with no medical history), the requirements of participants with respect to diet, exercise, sample collection/provision, physical examinations, and participation risks and benefits.

The volunteers did not consume tea and polyphenol-rich diets prior to the experiment and fasted overnight before Pu-erh tea intervention. Volunteers were provided with identical standard meals three times per day during the experiment (e.g., breakfast: milk and bread; lunch: beef and vegetables; dinner: pork and cabbage). Urine samples of 12 healthy men (n=6) and women (n=6) selected from the 20 participants were collected just before breakfast including the 200 mL Pu-erh tea and at 1 h, 3 h, 6 h, 9 h, 12 h, and 24 h thereafter. Spot urine samples of all 20 participants were collected daily between 11:00 and 11:30 a.m. during a 6-week period that included a 2-week baseline phase, a 2-week daily Pu-erh tea ingestion phase, and a 2-week post-dosing phase. Participants reported no adverse effects after the ingestion of Pu-erh tea. Urine samples were stored at −80° C. before analysis.

During the study, the following information was collected at each time point: date, volunteer name, body weight (kg), blood pressure (mmHg), other non-study diet foods eaten, times that volunteer awoke in the morning and went to sleep in the evening, time eaten and food content for breakfast, lunch and dinner, urina sanguinis (i.e., morning urination), any other information offered by the volunteer of potential relevance to the study (e.g., any feelings of unwellness) and general remarks made by the study administrator relating to the data collection.

### Example 3

### Tea and Urine Sample Preparation for UPLC-QTOFMS Analysis

The tea infusion used in this study and the collected urine samples were centrifuged at 13,000 rpm for 10 min at 4° C., and the resulting supernatants were immediately stored at −80° C. pending UPLC-QTOFMS analysis. Ultrapure water (500 μL) was added to the tea or urine sample (500 μL) and vortexed for 1 min. The sample was then filtered through a syringe filter (0.22 μm) for UPLC-QTOFMS analysis. [57]; incorporated by reference herein in its entirety.

### Example 4

### Tea and Urine Sample Preparation for GC-TOFMS Analysis

The tea infusion (100 μL) described in Example 2 and urine samples (100 μL) were spiked with two internal standard solutions (10 μL-2-chlorophenylalanine in water, 0.3 mg/ml; 10 μL heptadecanoic acid in methanol, 1 mg/mL), and vortexed for 10 seconds. The mixed solution was extracted with 300 μL of methanol:chloroform (v/v 3:1) and vortexed for 30 seconds. After storing for 10 min at −20° C., the samples were centrifuged at 10,000 rpm for 10 min. An aliquot of the 300 μL supernatant was transferred to a glass sampling vial to vacuum dry at room temperature. The residue was derivatized using a two-step procedure. First, 80 μL methoxyamine (15 mg/mL in pyridine,) was added to the vial and kept at 30° C. for 90 min followed by 80 μL BSTFA (1% TMCS) at 70° C. for 60 min. See protocols set forth in Ni et al., FEBS Lett. 581: 707-711 (2007). [78]; incorporated by reference herein in its entirety.

### Example 5

### Tea and Urine Analysis by UPLC-QTOFMS

UPLC: Tea and urine metabolite profiling were performed using a Waters ACQUITY UPLC system equipped with a binary solvent delivery manager and a sample manager (Waters Corporation, Milford, Mass., USA), coupled to a Micromass Q-TOF Premier mass spectrometry equipped with an electrospray interface (Waters Corporation, Milford, M A, USA). Chromatographic separations were performed on a 2.1×100 mm 1.7 μm ACQUITY BEH C18 chromatography column. The column was maintained at 45° C. and eluted with a 1-99% acetonitrile (0.1% (v/v) formic acid)-aqueous formic acid (0.1% (v/v) formic acid) gradient over 10 min at a flow rate of 0.40 mL/min. A 5 μL aliquot sample was injected onto the column.

Mass Spectrometry: The mass accuracy analysis and detailed MS parameters were optimized according to our prior studies [57], which is incorporated herein in its entirety. During metabolite profiling experiments, centroid data was acquired for each sample from 50 to 1000 Da with a 0.10 sec scan time and a 0.01 sec interscan delay over a 10 min analysis time. A metabonomics MS System Test Mixture including acetaminophen, tolbutamide, 3′-azido-3′-deoxythymidine, reserpine, verapamil and coumarin was used as chromatographic reference and mass accuracy quality control. This test mixture was injected every ten injections. The mass spectrometer was operated in positive ion mode. The desolvation temperature was set to 400° C. at a flow rate of 700 L/hr and source temperature of 100° C. The capillary and cone voltages were set to 3500 and 45 V, respectively. The data was collected between 50-1000 m/z with alternating collision energy, at 5 eV for precursor ion information generation and a collision profile from 10-40 eV for fragment ion information. The Q-TOF Premier™ was operated in v mode with 10,000 mass resolving power. Data were centroided during acquisition using independent reference lock-mass ions via the LockSpray™ interface to ensure mass accuracy and reproducibility. Leucine-enkephalin was used as the reference compound at a concentration of 50 pg/μL and an infusion flow rate of 0.05 mL/min. The Lockspray™ was operated at a reference scan frequency of 10 or analyte to reference scan ratio of 9:1 and a reference cone voltage of 45 V. For ES+, isotopic [M+H]+ ions of leucine-enkephalin at 556.2771 Da and 557.2804 Da were used as the attenuated lock mass and lock mass, respectively. During metabolite profiling experiments, centroided data were acquired for each sample from 50 to 1000 Da with a 0.10 sec scan time and a 0.01 sec interscan delay over a 10 min analysis time.

### Example 6

### Tea and Urine Analysis by GC-TOFMS

Each 1 μL aliquot of the derivatized solution was injected into an Agilent 6890N gas chromatography in splitless mode coupled with a Pegasus HT time-of-flight mass spectrometer (Leco Corporation, St Joseph, USA). Separation was achieved on a DB-5 MS capillary column (30 m×250 μm I.D., 0.25 μm film thickness; (5%-phenyl)-methylpolysiloxane bonded and crosslinked; Agilent J&W Scientific, Folsom, C A, USA) with helium as the carrier gas at a constant flow rate of 1.0 mL/min. The temperature of injection, transfer interface, and ion source was set to 270° C., 260° C., and 200° C., respectively. The GC temperature programming was set to 2 min isothermal heating at 80° C., followed by 10° C./min oven temperature ramps to 180° C., 5° C./min to 240° C., and 25° C./min to 290° C., and a final 9 min maintenance at 290° C. Electron impact ionization (70 eV) at full scan mode (m/z 30-600) was used, with an acquisition rate of 20 spectrum/seconds in the TOFMS setting.

### Example 7

### GC-TOFMS Data Analysis

The acquired MS files from GC-TOFMS analysis were exported in NetCDF format by ChromaTOF software (v3.30, Leco Co., CA, USA). CDF files were extracted using custom scripts (revised Matlab toolbox HDA, developed by Par Jonsson, et al.) in the MATLAB 7.1 (The MathWorks, Inc, USA) for data pretreatment procedures such as baseline correction, de-noising, smoothing, and alignment; time-window splitting; and peak feature extraction (based on multivariate curve resolution algorithm). [114, 115] The resulting three dimension data set included sample information, peak retention time and peak intensities. Internal standards and any known artificial peaks, such as peaks caused by noise, column bleed and BSTFA derivatization procedure, were removed from the data set. The resulting data was mean centered and unit variance scaled during chemometric data analysis in the SIMCA-P+12.0 Software package (Umetrics, Umeå, Sweden). Significantly expressed features (p<0.05) between the intervention and pre-intervention samples were selected using a student's T-test. The corresponding fold change shows how these selected differential metabolites varied before and after the pu-erh tea intervention. Additionally, compound identification was performed by comparing the mass fragments with NIST 05 Standard mass spectral databases in NIST MS search 2.0 (NIST, Gaithersburg, Md.) software with a similarity of more than 70% and finally verified by available reference compounds. Cluster heat map were performed in Matlab 7.1 software (Mathworks, Inc, USA).

Metabolites identification from these selected peaks was performed separately. GC-TOFMS metabolites were identified by comparing the mass fragments with NIST 05 Standard mass spectral databases in NIST MS search 2.0 (NIST, Gaithersburg, Md.) software with a similarity of more than 70% and finally verified by available reference compounds. Metabolites obtained from UPLC-QTOFMS analysis were identified with the aid of available reference standards in our lab and the web-based resources such as the Human Metabolome Database (http://www.hmdb.ca/).

### Example 8

### UPLC-QTOFMS Data Analysis

The UPLC-QTOFMS data from the urine samples was analyzed to identify potential discriminant variables. The ES+ raw data was analyzed by the MarkerLynx Applications Manager Version 4.1 (Waters, Manchester, UK). The parameters used were RT range 0-9.5 min, mass range 50-1000 Da, mass tolerance 0.02 Da, isotopic peaks were excluded for analysis, noise elimination level was set at 10.00, minimum intensity was set to 10% of base peak intensity, maximum masses per RT was set at 6 and, finally, RT tolerance was set at 0.01 min. [57]; incorporated by reference herein in its entirety.

After creating a suitable processing method, the dataset was processed through the Applications Manager Create Dataset window. Within the Create Dataset window, the method established above was selected, as was our dataset. The following options were selected from the Processing Options panel of the Create DataSet display: a) Detect Peaks, b) Collect Markers, and c) Perform PCA. At this point it is possible to automatically Print Reports and Export data into a text file for use in third party software such as Pirouette and SIMCA-P. After data processing, a list of the intensities of the peaks detected was generated for the first sample, using retention time (Rt) and m/z data pairs as the identifier of each peak. The resulting two-dimensional matrix of measured mass values and their intensity for each sample were further exported to SIMCA-P software 12.0 (Umetrics, Umeå, Sweden) for multivariate statistical analysis including unsupervised principal component analysis (PCA) and supervised orthogonal partial least squares-discriminant analysis (OPLS-DA).

The resulting data were mean centered (pareto-scaled in a column-wise manner) and unit variance scaled during chemometric data analysis in the SIMCA-P+12.0 Software package (Umetrics, Umeå, Sweden) before PCA and OPLS-DA modeling. Mean centering subtracts the average from the data sets column-wise, thereafter resulting in a shift of the data towards the mean. Pareto scaling gives each variable a variance equal to the square root of its standard deviation. As compared to UV-scaling (scaling to unit variance) method, the advantage of using this technique lies in the fact that it enhances the contribution of lower concentration metabolites without amplifying noise and artifacts commonly present in the metabonomic data sets. [99]; incorporated by reference herein in its entirety.

Principle component analysis (PCA) and orthogonal partial least squares-discriminant analysis (OPLS-DA) were carried out to visualize the metabolic alterations between post-dose metabolome and pre-dose metabolome after mean centering and unit variance scaling. PCA was universally used for achieving the natural interrelationship including grouping, clustering, and outliers among observations without prior knowledge of the data set. The first principal component (PC 1) contains the most variance in the data set. The second principal component, (PC2), is orthogonal to PC1, and represents maximum amount of variance not explained by PC1. The remaining components are attained in a similar manner, thereby reducing the high dimensional data sets to a two- or three-dimensional scores map without losing profound information.

In this application of the invention, the default 7-round cross-validation for the study was applied with 1/7^{th} of the samples being excluded from the mathematical model in each round, in order to guard against over-fitting. The variable importance parameter (VIP) values of all the peaks from the 7-fold cross-validated OPLS-DA model were taken as a coefficient for peak selection. VIP ranks the overall contribution of each variable to the OPLS-DA model, and those variables with VIP>1.0 are considered relevant for group discrimination. [37] Herein, VIP statistics and S-plot were applied to obtain the significant variables for subsequent metabolic pathway analysis. [113-115]

Significantly expressed features (p<0.05) between the intervention and pre-intervention samples were selected using a student's T-test. Accurate masses of features representing significant differences were searched against the HMDB. When standards were available, retention time and accurate mass was further used for metabolite identification. Cluster heat map were performed in Matlab 7.1 software (Mathworks, Inc, USA).

Besides the multivariate approaches, one univariate method, nonparametric Wilcoxon-Mann-Whitney test, was selected to measure the significance of each peak in separating post-dose metabolome from pre-dose metabolome. A number of peaks responsible for the differentiation of the metabolic profiles of individuals before and after pu-erh tea intake could be obtained by comprehensive consideration of these two coefficients. The corresponding up and down regulated trend shows how these selected differential metabolites varied between the individuals before and after pu-erh tea intake

### Example 9

### UPLC-QTOFMS and GC-TOFMS Profiles of Pu-erh Tea and Urine Samples

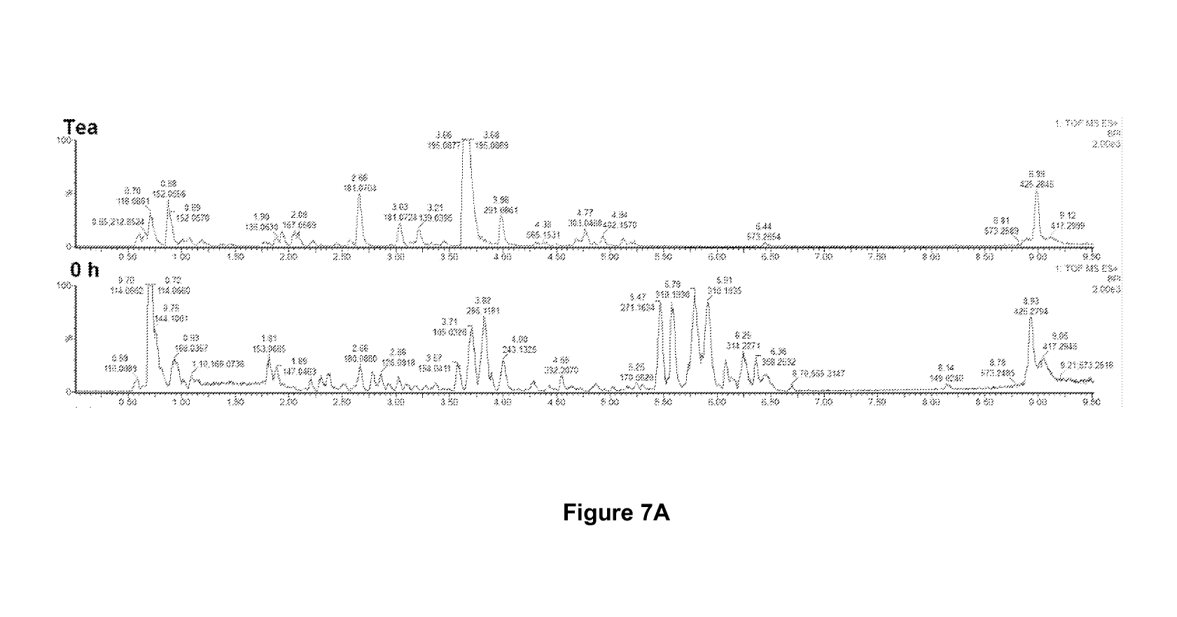

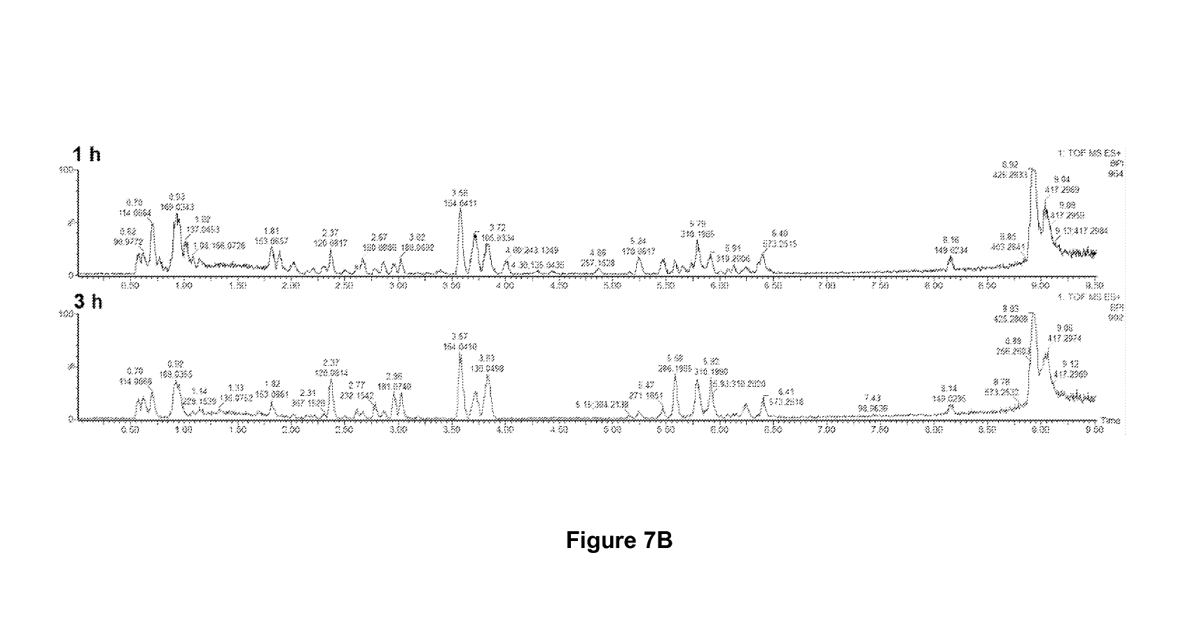

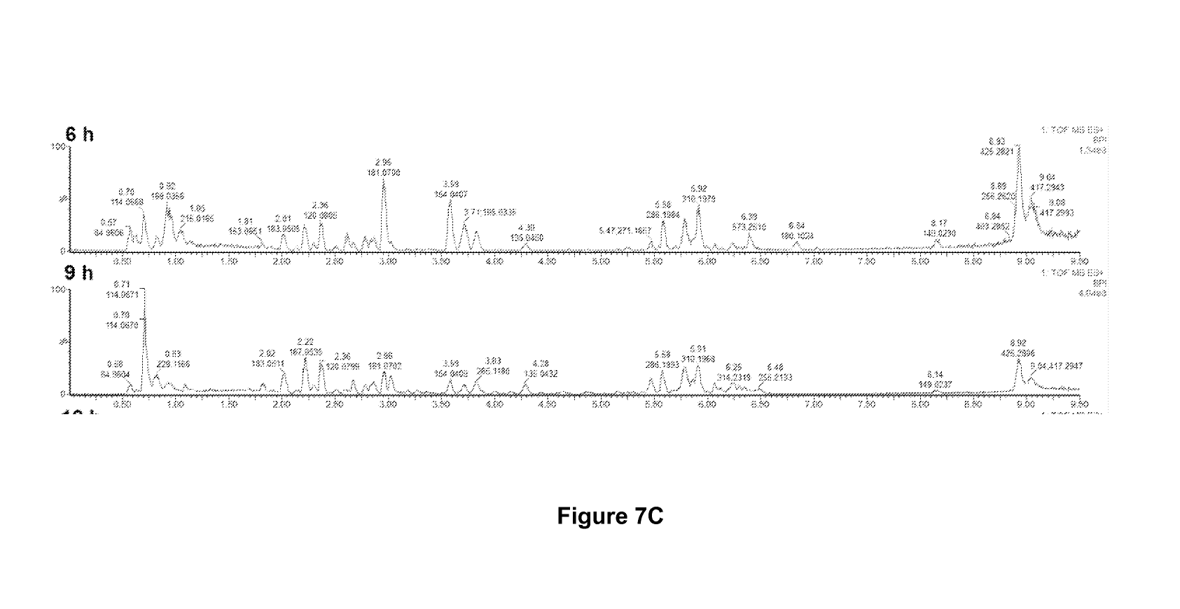

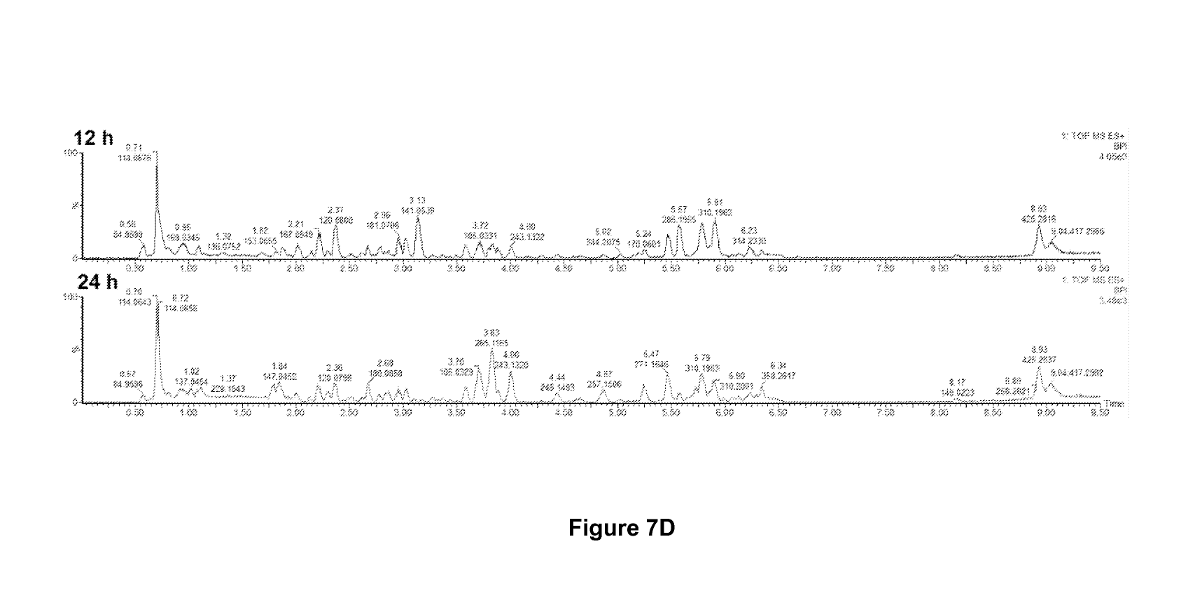

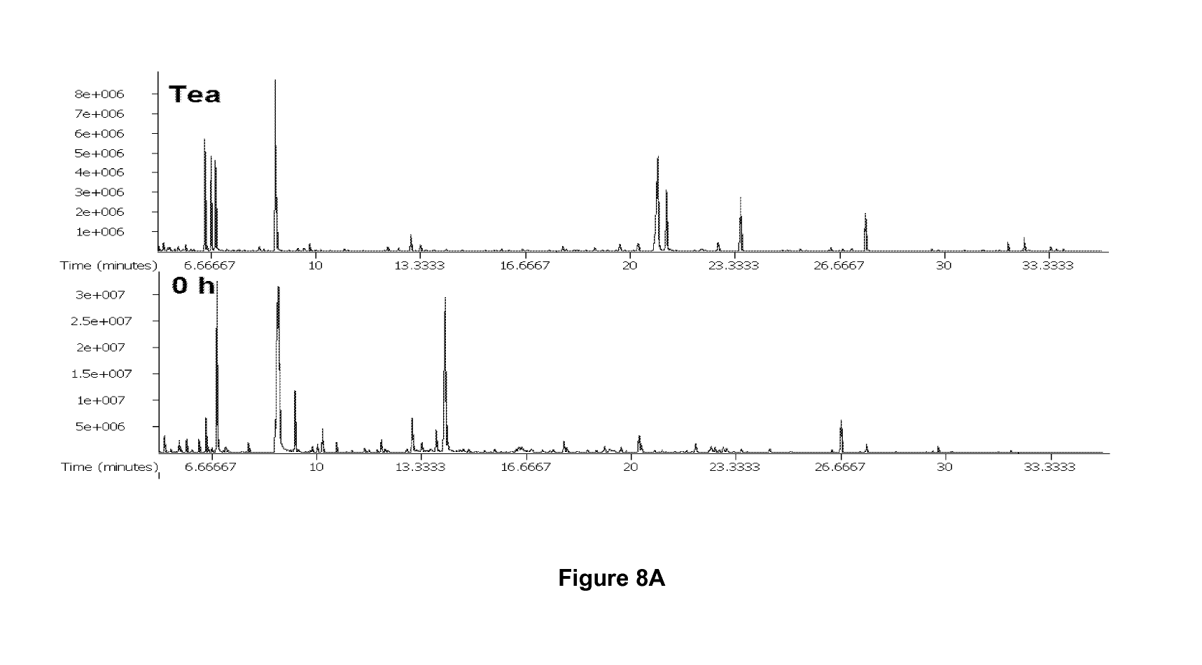

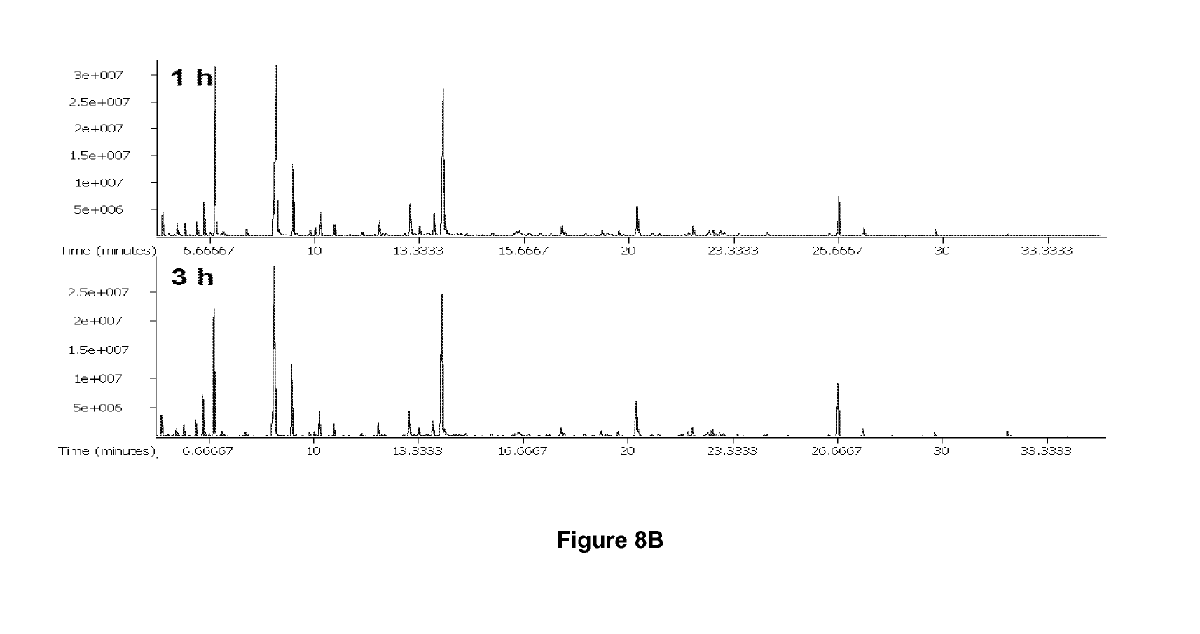

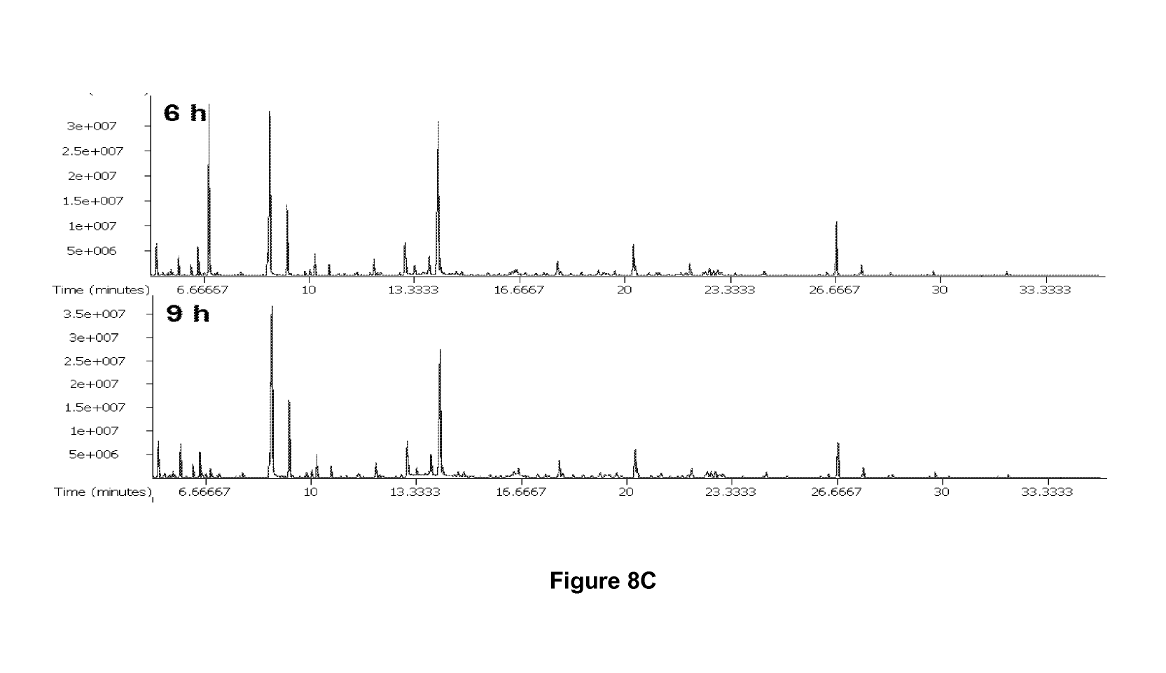

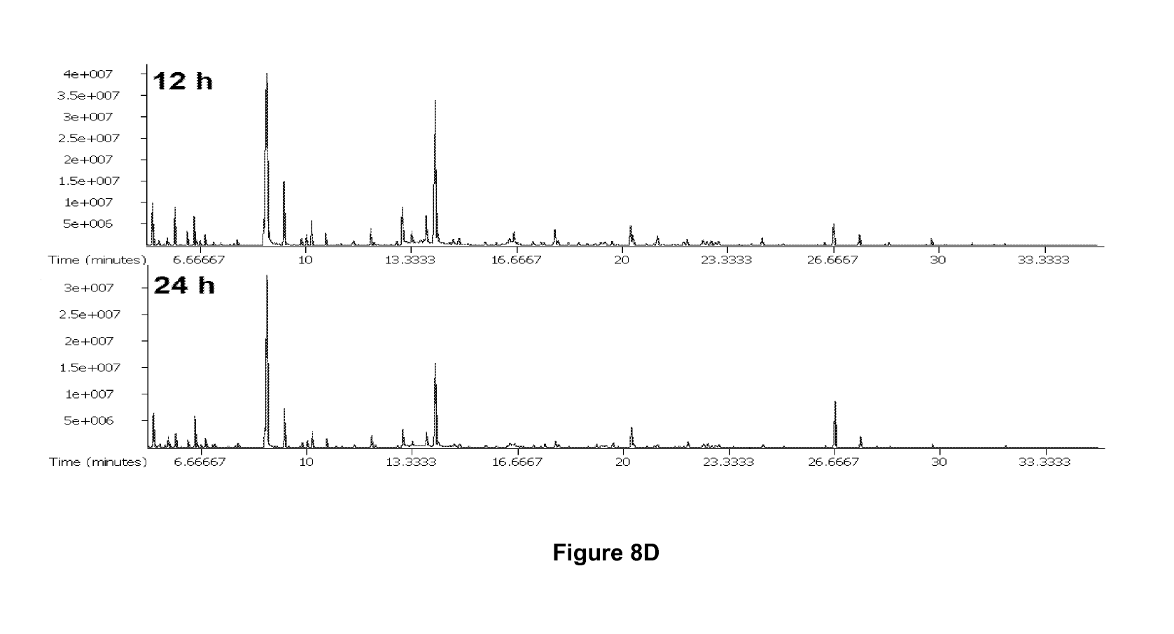

The untargeted MS profiling of Pu-erh tea and urine samples was conducted following the scheme shown in FIG. 1. Representative base peak intensity (BPI) chromatograms of UPLC-QTOFMS (A) and total ion current (TIC) chromatograms of GC-TOFMS (B) are shown in FIGS. 7 and 8.

A “pre-dose metabolome” of the participants was obtained from the analysis of urine samples at time-point 0 prior to the tea intake. All of the differentially expressed compounds (“altered endogenous metabolites”) in urinary at a post-dose time point were selected by comparing the compounds in post-dose (time-point 1) urine samples with the pre-dose urinary metabolome using a Student's T-test univariate statistical analysis. The plant metabolome was derived from the chemical profiling of Pu-erh tea.

Similarity analysis between plant metabolome and altered endogenous metabolites, and similarity analysis between “pre-dose” metabolome and altered endogenous metabolites, were performed with Microsoft Office Access 2007 to identify the shared variables between plant metabolome and post-dose variables. The similarity analysis procedure involved: establishing a new database, importing the source data you want to compare, designing the query, and establishing the join properties. In this study, the join properties are retention time and accurate mass for LC-MS and retention time and five principal fragments for GC-MS.

An example query is:

SELECT alteredendogenousmetabolite.*, plant_metabolome.*
FROM alteredendogenousmetabolite LEFT JOIN plant_metabolome ON
(abs(alteredendogenousmetabolite.Mass- plant_metabolome.Mass)<0.02)
AND
(abs(alteredendogenousmetabolite.[Ret Time]- plant_metabolome.[Ret
Time])<0.5);

The shared variables are actually the compounds in the urine sample that were absorbed from Pu-erh tea, as characterized by accurate mass (m/z) and retention time in the LC-MS spectra. The shared variables between the pre-dose metabolome of individuals and the post-dose variables are the endogenous metabolites altered as a result of tea exposure. After exclusion of the two sets of the shared variables (absorbed plant metabolites, altered human metabolites), the remaining of the post-dose variables are the metabolized or biotransformed compounds derived from Pu-erh tea. The identified bioavailable plant compounds, the absorbed and their derivatives, can be further investigated at different time points for PK of Pu-erh tea.

A total of 5,636 and 392 features were detected from UPLC-QTOFMS and GC-TOFMS spectral data set, respectively, for each urine sample, and a total of 647 and 428 features from the water extract of the Pu-erh tea were obtained from the two analytical platforms, respectively. Student's t-test was performed on all urinary features derived from UPLC-QTOFMS and GC-TOFMS and calculated at different time points before and after Pu-erh tea exposure. The variables selected were those with statistical significance (p<0.05) between pre-dose and post-dose samples at each time point of 1 h, 3 h, 6 h, 9 h, 12 h and 24 h. A total of 2,476 significant variables from UPLC-QTOFMS and 176 from GC-TOFMS were selected, with a p value less than 0.05 at least once at all time points.

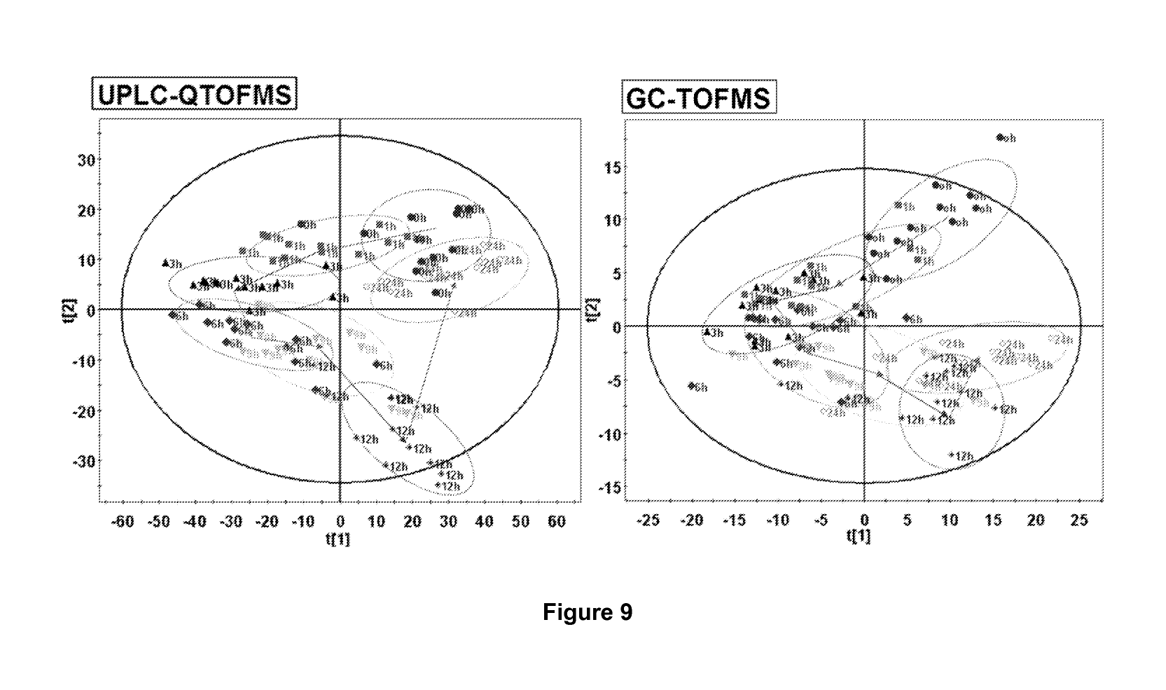

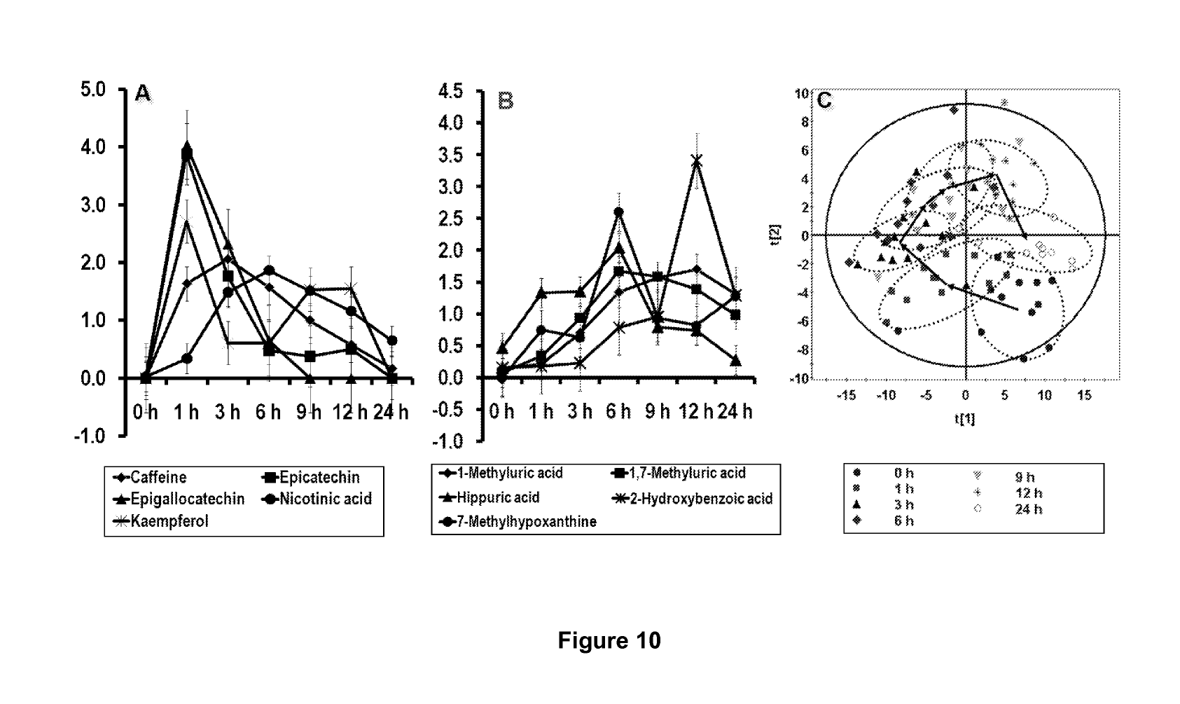

PCA scores plot of the data show a time dependent trajectory of urinary metabolites which clustered at different spatial positions and time points (FIGS. 9 and 10C).

### Example 10

### Compound Annotation

Among the 2,476 significantly altered features from UPLC-QTOFMS analysis, 796 were identified by searching against the HMDB library with accurate mass, and 132 were further verified by available reference standards. Analogously, among the 176 significantly altered compounds from GC-TOFMS data, 167 were identified with NIST 05 Standard mass spectral databases (NIST, Gaithersburg, Md.) with a similarity of greater than 70% and 58 were further verified by available standards.

A panel of 19 and 26 compounds were defined as absorbed and biotransformed substances from Pu-erh tea using the similarity analysis technique by comparing the retention time and accurate mass of the variables obtained from UPLC-QTOFMS and retention time and 5 principal fragment ions of GC-TOFMS. (FIG. 2) A panel of 117 compounds are the altered human endogenous metabolites resulting from Pu-erh tea intake. Representative metabolites with the retention time (RT; minutes), p value and fold change (FC) for each of these types of molecules are provided in Table 1. Complete lists of the three datasets are shown in Tables 2-4. Metabolites are annotated using (*) available reference standards; () accurate mass measurement with the aid of web-based resources, such as the Human Metabonome Database and METLIN; and ( [symbol] ) the mass fragments with those present in commercially available mass spectral databases such as NIST, Wiley, and NBS, with a similarity threshold of 70%. “U” means data obtained from UPLC-QTOFMS analysis; “G” means data obtained from GC-TOFMS analysis. The urine concentration-time courses of representative absorbed and biotransformed tea metabolites after Pu-erh tea intake are described in Example 11 and depicted in FIG. 10.

TABLE 1
Representative absorbed, biodegraded Pu-erh tea metabolites, and the altered endogenous metabolites.

| | | | P value | | | | | | FC | | | | | |
|---|---|---|---|---|---|---|---|---|---|---|---|---|---|---|
| No. | Metabolite | RT | l h | 3 h | 6 h | 9 h | 12 h | 24 h | l h | 3 h | 6 h | 9 h | 12 h | 24 h |

Absorded Pu-erh tea metabolites

| | | | | | | | | | | | | | | |
|---|---|---|---|---|---|---|---|---|---|---|---|---|---|---|
| 1 | 1,3- | 2.17 | 4.65 | 9.88 | 1.71 | 7.45 | 4.37 | 2.06 | 4.25 | 11.56 | 20.54 | 19.48 | 17.09 | 12.14 |
| | Dimethyl- | | E−01 | E−02 | E−02 | E−03 | E−02 | E−01 | | | | | | |
| | uric acid^{†,(U)} | | | | | | | | | | | | | |
| 2 | Caffeine^{†,(U)} | 3.60 | 9.34 | 5.29 | 7.76 | 3.30 | 1.50 | 5.84 | 454.37 | 573.74 | 437.21 | 277.02 | 160.06 | 46.28 |
| | | | E−06 | E−09 | E−08 | E−09 | E−05 | E−04 | | | | | | |
| 3 | Epigallo- | 2.95 | 1.21 | 3.53 | 3.28 | 1.00 | 1.00 | 1.00 | | | | | | |
| | catechin*^{(U)} | | E−01 | E−02 | E−01 | E+00 | E+00 | E+00 | | | | | | |
| 4 | Nicotinic | 2.96 | 2.11 | 1.25 | 1.14 | 1.71 | 2.51 | 4.86 | 14.31 | 62.95 | 78.98 | 63.95 | 49.02 | 27.31 |
| | acid^{†,(U)} | | E−05 | E−08 | E−07 | E−11 | E−11 | E−07 | | | | | | |
| 5 | Theo- | 2.60 | 4.39 | 9.48 | 1.57 | 1.56 | 2.92 | 1.70 | 4.04 | 6.76 | 7.75 | 5.42 | 4.43 | 2.67 |
| | bromine^{†,(U)} | | E−03 | E−06 | E−06 | E−06 | E−05 | E−02 | | | | | | |
| 6 | Theo- | 2.96 | 2.75 | 1.50 | 9.11 | 1.98 | 1.94 | 6.03 | 11.62 | 42.69 | 54.55 | 45.99 | 38.67 | 19.22 |
| | phylline^{†,(U)} | | E−06 | E−08 | E−08 | E−10 | E−11 | E−07 | | | | | | |
| 7 | 4-Amino- | 16.56 | 6.42 | 1.35 | 4.17 | 5.72 | 1.66 | 3.78 | 3.95 | 5.14 | 24.12 | 39.08 | 100.29 | 49.03 |
| | butanoioc | | E−02 | E−01 | E−03 | E−03 | E−04 | E−03 | | | | | | |
| | acid*^{(G)} | | | | | | | | | | | | | |
| 8 | 3,5- | 21.70 | 1.77 | 1.56 | 1.01 | 2.15 | 3.74 | 1.63 | 2.03 | 3.48 | 1.54 | 0.42 | 0.47 | 0.20 |
| | hydroxy | | E−02 | E−06 | E−01 | E−02 | E−02 | E−03 | | | | | | |
| | benzoic | | | | | | | | | | | | | |
| | acid [symbol] ^{,(G)} | | | | | | | | | | | | | |

Biotransformed pu-erh tea metabolites

| | | | | | | | | | | | | | | |
|---|---|---|---|---|---|---|---|---|---|---|---|---|---|---|
| A | 1- | 2.01 | 1.48 | 5.36 | 2.47 | 3.99 | 7.21 | 6.82 | 1.35 | 4.43 | 8.50 | 9.98 | 10.78 | 8.33 |
| | Methyluric | | E−02 | E−04 | E−06 | E−08 | E−08 | E−09 | | | | | | |
| | acid^{†,(U)} | | | | | | | | | | | | | |
| B | 1,7- | 2.17 | 7.38 | 9.84 | 4.52 | 1.03 | 4.76 | 8.91 | 4.25 | 11.56 | 20.54 | 19.48 | 17.09 | 12.14 |
| | Methyluric | | E−01 | E−02 | E−02 | E−01 | E−01 | E−01 | | | | | | |
| | acid^{†,(U)} | | | | | | | | | | | | | |
| C | 1-Methyl- | 1.49 | 1.0 | 1.61 | 7.83 | 9.88 | 4.33 | 1.99 | | | | | | |
| | xanthine^{†,(U)} | | E+00 | E−01 | E−02 | E−02 | E−03 | E−04 | | | | | | |
| D | 3-Hydroxy- | 7.03 | 5.23 | 3.09 | 2.52 | 5.22 | 2.29 | 2.15 | 4.36 | 5.84 | 6.29 | 2.04 | 3.09 | 3.77 |
| | phenyl- | | E−02 | E−02 | E−02 | E−01 | E−01 | E−01 | | | | | | |
| | acetic acid^{†,(U)} | | | | | | | | | | | | | |
| E | Para- | 1.49 | 3.28 | 3.41 | 6.20 | 2.20 | 2.40 | 5.26 | 0.00 | 4.27 | 11.43 | 24.53 | 27.51 | 27.14 |
| | xanthine^{†,(U)} | | E−01 | E−01 | E−02 | E−03 | E−04 | E−05 | | | | | | |
| F | Hippuric | 16.83 | 5.91 | 1.80 | 6.04 | 3.78 | 1.62 | 4.17 | 2.86 | 2.89 | 4.37 | 1.69 | 1.59 | 0.59 |
| | acid*^{(U)} | | E−01 | E−01 | E−01 | E−01 | E−02 | E−01 | | | | | | |
| G | 2-Hydroxy | 27.82 | 7.90 | 5.56 | 1.14 | 2.47 | 2.12 | 2.45 | 1.16 | 1.48 | 5.16 | 6.23 | 22.34 | 8.49 |
| | benzoic | | E−01 | E−01 | E−01 | E−02 | E−02 | E−02 | | | | | | |
| | acid [symbol] ^{,(G)} | | | | | | | | | | | | | |

Altered endogenous metabolites

| | | | | | | | | | | | | | | |
|---|---|---|---|---|---|---|---|---|---|---|---|---|---|---|
| i | Valine*^{(U)} | 0.90 | 1.88 | 7.35 | 1.95 | 1.34 | 3.14 | 5.76 | 2.58 | 1.25 | 2.16 | 2.32 | 2.76 | 1.38 |
| | | | E−01 | E−01 | E−01 | E−01 | E−02 | E−01 | | | | | | |
| ii | 4-Hydroxy- | 21.63 | 6.76 | 1.19 | 2.21 | 9.54 | 4.01 | 5.18 | 0.39 | 0.11 | 0.27 | 0.55 | 0.85 | 1.12 |
| | 3-methoxy- | | E−04 | E−06 | E−05 | E−03 | E−01 | E−01 | | | | | | |
| | phenyl- | | | | | | | | | | | | | |
| | acetic acid*^{(G)} | | | | | | | | | | | | | |
| iii | Ornithine [symbol] ^{,(G)} | 24.90 | 2.64 | 3.40 | 1.70 | 2.32 | 8.84 | 1.43 | 0.51 | 0.33 | 1.36 | 4.29 | 5.10 | 2.90 |
| | | | E−03 | E−04 | E−01 | E−04 | E−07 | E−04 | | | | | | |
| iv | 2-Methoxy- | 8.11 | 4.87 | 7.01 | 5.80 | 1.56 | 8.79 | 1.04 | 0.48 | 0.31 | 0.31 | 0.41 | 0.59 | 0.61 |
| | phenol [symbol] ^{,(G)} | | E−02 | E−03 | E−03 | E−02 | E−02 | E−01 | | | | | | |
| v | 4-Amino- | 16.56 | 6.42 | 1.35 | 4.17 | 5.72 | 1.66 | 3.78 | 3.95 | 5.14 | 24.12 | 39.08 | 100.29 | 49.03 |
| | butanoic | | E−02 | E−01 | E−03 | E−03 | E−04 | E−03 | | | | | | |
| | acid*^{(G)} | | | | | | | | | | | | | |
| vi | Amino- | 12.26 | 2.00 | 2.35 | 8.04 | 7.00 | 1.62 | 3.19 | 1.90 | 3.09 | 3.09 | 0.45 | 0.57 | 0.35 |
| | malonic | | E−01 | E−03 | E−03 | E−02 | E−01 | E−02 | | | | | | |
| | acid^{‡,(G)} | | | | | | | | | | | | | |
| vii | Phenol*^{(G)} | 5.63 | 8.44 | 1.70 | 1.07 | 4.72 | 2.29 | 9.04 | 1.04 | 1.22 | 1.43 | 1.14 | 1.32 | 2.22 |
| | | | E−01 | E−01 | E−01 | E−01 | E−01 | E−05 | | | | | | |

TABLE 2
Identified bioavailable pu-erh tea components.

| | | | P value | | | | | | FC | | | | | |
|---|---|---|---|---|---|---|---|---|---|---|---|---|---|---|
| No. | Metabolite | RT | l h | 3 h | 6 h | 9 h | 12 h | 24 h | l h | 3 h | 6 h | 9 h | 12 h | 24 h |
| 1 | 1,3-Dimethyluric | 2.17 | 4.65 | 9.88 | 1.71 | 7.45 | 4.37 | 2.06 | 4.25 | 11.56 | 20.54 | 19.48 | 17.09 | 12.14 |
| | acid^{†,(U)} | | E−01 | E−02 | E−02 | E−03 | E−02 | E−01 | | | | | | |
| 2 | 1-Methyluric | 1.79 | 1.00 | 1.00 | 3.28 | 1.00 | 2.05 | 3.28 | | | | | | |
| | acid^{†,(U)} | | E+00 | E+00 | E−01 | E+00 | E−01 | E−01 | | | | | | |
| 3 | Caffeine^{†,(U)} | 3.60 | 9.34 | 5.29 | 7.67 | 3.30 | 1.50 | 5.84 | 454.37 | 573.74 | 437.21 | 277.02 | 160.06 | 46.28 |
| | | | E−06 | E−09 | E−08 | E−09 | E−05 | E−04 | | | | | | |
| 4 | Epicatechin*^{(U)} | 3.73 | 2.15 | 1.44 | 1.77 | 1.57 | 3.12 | 1.00 | | | | | | |
| | | | E−02 | E−02 | E−01 | E−01 | E−02 | E+00 | | | | | | |
| 5 | Epigallo- | 2.95 | 1.21 | 3.53 | 3.28 | 1.00 | 1.00 | 1.00 | | | | | | |
| | catechin*^{(U)} | | E−01 | E−02 | E−01 | E+00 | E+00 | E+00 | | | | | | |
| 6 | Kaempferol*^{(U)} | 5.18 | 8.55 | 3.28 | 2.16 | 1.52 | 1.96 | 1.00 | | | | | | |
| | | | E−02 | E−01 | E−01 | E−01 | E−01 | E+00 | | | | | | |
| 7 | Nicotinic | 2.96 | 2.11 | 1.25 | 1.14 | 1.71 | 2.51 | 4.86 | 14.31 | 62.95 | 78.98 | 63.95 | 49.02 | 27.31 |
| | acid^{†,(U)} | | E−05 | E−08 | E−07 | E−11 | E−11 | E−07 | | | | | | |
| 8 | Theobromine^{†,(U)} | 2.60 | 4.39 | 9.48 | 1.57 | 1.56 | 2.92 | 1.70 | 4.04 | 6.76 | 7.75 | 5.42 | 4.43 | 2.67 |
| | | | E−03 | E−06 | E−06 | E−06 | E−05 | E−02 | | | | | | |
| 9 | Theophylline^{†,(U)} | 2.96 | 2.75 | 1.50 | 9.11 | 1.98 | 1.94 | 6.03 | 11.62 | 42.69 | 54.55 | 45.99 | 38.67 | 19.22 |
| | | | E−06 | E−08 | E−08 | E−10 | E−11 | E−07 | | | | | | |
| 10 | 4-Amino- | 16.56 | 6.42 | 1.35 | 4.17 | 5.72 | 1.66 | 3.78 | 3.95 | 5.14 | 24.12 | 39.08 | 100.29 | 49.03 |
| | butanoic acid*^{,(G)} | | E−02 | E−01 | E−03 | E−03 | E−04 | E−03 | | | | | | |
| 11 | 5-Deoxy- | 6.10 | 4.13 | 6.30 | 1.98 | 2.38 | 8.55 | 6.72 | 2.56 | 3.69 | 3.68 | 2.35 | 0.91 | 0.81 |
| | pyridoxal^{‡,(G)} | | E−02 | E−04 | E−03 | E−02 | E−01 | E−01 | | | | | | |
| 12 | 3,5-hydroxy | 21.70 | 1.77 | 1.56 | 1.01 | 2.15 | 3.74 | 1.63 | 2.03 | 3.48 | 1.54 | 0.42 | 0.47 | 0.20 |
| | benzoic acid [symbol] ^{,(G)} | | E−02 | E−06 | E−01 | E−02 | E−02 | E−03 | | | | | | |
| 13 | unknown | 6.47 | 7.18 | 2.08 | 1.07 | 6.73 | 6.35 | 8.58 | 1.73 | 2.42 | 2.44 | 1.70 | 1.12 | 1.04 |
| | (Amino acid, | | E−02 | E−03 | E−02 | E−02 | E−01 | E−01 | | | | | | |
| | suspected to | | | | | | | | | | | | | |
| | be alanine)^{‡,(G)} | | | | | | | | | | | | | |
| 14 | unknown | 6.82 | 4.17 | 9.15 | 2.12 | 8.18 | 7.91 | 4.55 | 1.49 | 2.59 | 1.78 | 0.20 | 0.10 | 0.09 |
| | (suspected to | | E−02 | E−04 | E−02 | E−06 | E−07 | E−07 | | | | | | |
| | beglycer- | | | | | | | | | | | | | |
| | aldhyde)^{‡,(G)} | | | | | | | | | | | | | |
| 15 | Citric acid*^{,(G)} | 20.25 | 1.07 | 3.63 | 1.68 | 3.85 | 1.03 | 5.20 | 1.42 | 1.76 | 1.59 | 1.20 | 1.42 | 1.17 |
| | | | E−01 | E−03 | E−02 | E−01 | E−01 | E−01 | | | | | | |
| 16 | Methyl- | 9.61 | 9.64 | 4.68 | 4.77 | 7.87 | 1.17 | 1.55 | 1.42 | 1.54 | 1.10 | 1.03 | 1.20 | 1.18 |
| | buatanedioic | | E−02 | E−04 | E−01 | E−01 | E−01 | E−01 | | | | | | |
| | acid*^{,(G)} | | | | | | | | | | | | | |
| 17 | Glycine*^{,(G)} | 9.30 | 2.04 | 2.09 | 5.78 | 3.12 | 9.80 | 7.72 | 1.28 | 1.67 | 2.32 | 1.53 | 1.77 | 1.04 |
| | | | E−01 | E−02 | E−04 | E−02 | E−04 | E−01 | | | | | | |
| 18 | Unknown^{‡,(G)} | 7.22 | 3.93 | 7.54 | 1.07 | 6.23 | 9.12 | 4.13 | 1.26 | 3.18 | 2.59 | 1.39 | 1.01 | 0.88 |
| | | | E−01 | E−04 | E−03 | E−02 | E−01 | E−01 | | | | | | |
| 19 | Succinate [symbol] ^{,(G)} | 9.43 | 5.74 | 5.22 | 8.66 | 6.48 | 2.75 | 7.14 | 1.15 | 0.90 | 0.74 | 0.57 | 0.84 | 0.93 |
| | | | E−01 | E−01 | E−02 | E−03 | E−01 | E−01 | | | | | | |

TABLE 3
Metabolites produced in vivo after pu-erh tea intake.

| | | | P value | | | | | | FC | | | | | |
|---|---|---|---|---|---|---|---|---|---|---|---|---|---|---|
| No. | Metabolite | RT | l h | 3 h | 6 h | 9 h | 12 h | 24 h | l h | 3 h | 6 h | 9 h | 12 h | 24 h |
| 1 | 1-Methyluric | 2.01 | 1.48 | 5.36 | 2.47 | 3.99 | 7.21 | 6.82 | 1.35 | 4.43 | 8.50 | 9.98 | 10.78 | 8.33 |
| | acid^{†,(U)} | | E−02 | E−04 | E−06 | E−08 | E−08 | E−09 | | | | | | |
| 2 | 1,7- | 2.17 | 7.38 | 9.84 | 4.52 | 1.03 | 4.76 | 8.91 | 4.25 | 11.56 | 20.54 | 19.48 | 17.09 | 12.14 |
| | Methyluric | | E−01 | E−02 | E−02 | E−01 | E−01 | E−01 | | | | | | |
| | acid^{†,(U)} | | | | | | | | | | | | | |
| 3 | 16- | 2.54 | 3.28 | 3.48 | 1.72 | 1.44 | 1.08 | 3.28 | | | | | | |
| | Oxoestrone^{†,(U)} | | E−01 | E−02 | E−02 | E−03 | E−05 | E−01 | | | | | | |
| 4 | 1-Methyl- | 1.49 | 1.0 | 1.61 | 7.83 | 9.88 | 4.33 | 1.99 | | | | | | |
| | xanthine^{†,(U)} | | E+00 | E−01 | E−02 | E−02 | E−03 | E−04 | | | | | | |
| 5 | 3-Hydroxy- | 7.03 | 5.23 | 3.09 | 2.52 | 5.22 | 2.29 | 2.15 | 4.36 | 5.84 | 6.29 | 2.04 | 3.09 | 3.77 |
| | phenylacetic | | E−02 | E−02 | E−02 | E−01 | E−01 | E−01 | | | | | | |
| | acid^{†,(U)} | | | | | | | | | | | | | |
| 6 | 3'-O-Methyl- | 2.37 | 1.88 | 2.08 | 2.06 | 7.71 | 9.78 | 8.96 | 2.89 | 5.36 | 7.20 | 0.76 | 1.02 | 1.13 |
| | adenosine^{†,(U)} | | E−01 | E−02 | E−02 | E−01 | E−01 | E−01 | | | | | | |
| 7 | 7-Methyl- | 9.22 | 1.57 | 3.28 | 1.67 | 1.60 | 6.95 | 3.08 | | | | | | |
| | hypo- | | E−01 | E−01 | E−01 | E−01 | E−02 | E−02 | | | | | | |
| | xanthine^{†,(U)} | | | | | | | | | | | | | |
| 9 | Glycylprolyl | 0.90 | 9.93 | 4.53 | 5.40 | 5.30 | 1.66 | 9.42 | 1.00 | 0.63 | 3.54 | 2.79 | 1.92 | 0.24 |
| | hydroxy- | | E−01 | E−01 | E−03 | E−09 | E−01 | E−02 | | | | | | |
| | proline^{†,(U)} | | | | | | | | | | | | | |
| 10 | Propynoic | 3.14 | 1.83 | 3.04 | 3.28 | 1.56 | 7.79 | 7.48 | | | | | | |
| | acid^{†,(U)} | | E−01 | E−02 | E−01 | E−01 | E−04 | E−02 | | | | | | |
| 11 | Paraxanthine^{†,(U)} | 1.49 | 3.28 | 3.41 | 6.20 | 2.20 | 2.40 | 5.26 | 0.00 | 4.27 | 11.43 | 24.53 | 27.51 | 27.14 |
| | | | E−01 | E−01 | E−02 | E−03 | E−04 | E−05 | | | | | | |
| 12 | Theophylline^{†,(U)} | 0.98 | 1.57 | 2.67 | 3.13 | 7.29 | 8.50 | 5.61 | 0.30 | 0.42 | 1.47 | 2.59 | 3.74 | 3.52 |
| | | | E−03 | E−02 | E−01 | E−04 | E−05 | E−06 | | | | | | |
| 13 | Xanthosine^{†,(U)} | 5.46 | 9.53 | 8.86 | 8.07 | 4.15 | 4.15 | 8.43 | 0.97 | 0.96 | 0.44 | 0.34 | 0.00 | 0.93 |
| | | | E−01 | E−01 | E−02 | E−02 | E−04 | E−01 | | | | | | |
| 14 | Hippuric | 16.83 | 5.91 | 1.80 | 6.04 | 3.78 | 1.62 | 4.17 | 2.86 | 2.89 | 4.37 | 1.69 | 1.59 | 0.59 |
| | acid*^{.(U)} | | E−01 | E−01 | E−01 | E−01 | E−02 | E−01 | | | | | | |
| 15 | 3-Hydroxy- | 2.64 | 8.06 | 2.53 | 3.63 | 2.47 | 4.63 | 4.11 | 1.09 | 0.68 | 0.58 | 0.66 | 0.72 | 0.67 |
| | hippuric acid^{†,(U)} | | E−01 | E−01 | E−01 | E−01 | E−01 | E−02 | | | | | | |
| 16 | L-pipecolic | 7.97 | 9.58 | 7.17 | 2.58 | 1.74 | 2.24 | 3.84 | 2.00 | 2.70 | 2.35 | 1.67 | 1.41 | 1.29 |
| | acid*^{(G)} | | E−03 | E−05 | E−03 | E−02 | E−01 | E−01 | | | | | | |
| 17 | Galactose*^{(G)} | 22.39 | 1.57 | 1.37 | 5.62 | 1.66 | 1.93 | 6.09 | 13.88 | 31.98 | 6.63 | 3.86 | 1.93 | 1.25 |
| | | | E−02 | E−04 | E−06 | E−03 | E−01 | E−01 | | | | | | |
| 18 | 3,5- | 21.70 | 1.77 | 1.56 | 1.01 | 2.15 | 3.74 | 1.63 | 2.03 | 3.48 | 1.54 | 0.42 | 0.47 | 0.20 |
| | Dihydroxy | | E−02 | E−06 | E−01 | E−02 | E−02 | E−03 | | | | | | |
| | benzoic acid [symbol] ^{,(G)} | | | | | | | | | | | | | |
| 19 | 2-methyl- | 32.26 | 2.45 | 3.84 | 1.90 | 6.35 | 2.38 | 3.14 | 3.28 | 4.35 | 3.60 | 1.24 | 0.42 | 0.50 |
| | octadecane^{‡,(G)} | | E−02 | E−04 | E−03 | E−01 | E−01 | E−01 | | | | | | |
| 20 | 1-(1-Ethoxy- | 25.60 | 3.82 | 1.98 | 1.51 | 4.57 | 2.15 | 1.52 | 1.90 | 2.22 | 1.93 | 1.23 | 0.70 | 0.42 |
| | ethoxy)-3- | | E−02 | E−03 | E−02 | E−01 | E−01 | E−02 | | | | | | |
| | hexene^{‡,(G)} | | | | | | | | | | | | | |
| 21 | Ethylamine^{‡,(G)} | 31.23 | 9.60 | 6.18 | 3.73 | 8.47 | 2.46 | 2.32 | 1.73 | 3.10 | 3.87 | 2.65 | 3.09 | 1.58 |
| | | | E−02 | E−05 | E−05 | E−04 | E−04 | E−02 | | | | | | |
| 22 | 2-2- | 10.64 | 2.57 | 1.25 | 5.83 | 5.65 | 1.74 | 2.28 | 1.20 | 1.80 | 1.59 | 1.11 | 1.24 | 0.84 |
| | Hydroxy- | | E−01 | E−02 | E−03 | E−01 | E−01 | E−01 | | | | | | |
| | butane^{‡,(G)} | | | | | | | | | | | | | |
| 23 | 2-Methyl- | 13.09 | 4.14 | 5.45 | 2.51 | 5.13 | 5.13 | 3.46 | 2.27 | 1.74 | 2.51 | 17.23 | 20.48 | 86.17 |
| | propylene^{‡,(G)} | | E−01 | E−01 | E−01 | E−03 | E−03 | E−03 | | | | | | |
| 24 | 1-Propene- | 18.62 | 4.23 | 3.48 | 8.45 | 4.20 | 4.06 | 8.17 | 1.29 | 1.98 | 2.26 | 2.61 | 4.12 | 3.97 |
| | 1,2,3- | | E−01 | E−02 | E−04 | E−04 | E−09 | E−06 | | | | | | |
| | tricarboxylic | | | | | | | | | | | | | |
| | acid*^{(G)} | | | | | | | | | | | | | |
| 25 | 3-Hydroxy | | | | | | | | | | | | | |
| | benzene- | 16.00 | 4.69 | 5.34 | 2.72 | 3.32 | 7.10 | 1.50 | 0.88 | 0.89 | 1.24 | 1.27 | 1.41 | 1.74 |
| | acetic acid^{‡,(G)} | | E−01 | E−01 | E−01 | E−01 | E−02 | E−02 | | | | | | |
| 26 | 5-[3,4- | | | | | | | | | | | | | |
| | Dihydroxy- | | | | | | | | | | | | | |
| | phenyl]-3- | | | | | | | | | | | | | |
| | methyl-5- | 31.11 | 6.91 | 4.42 | 2.33 | 5.63 | 2.23 | 2.41 | 1.16 | 0.76 | 1.61 | 2.74 | 1.55 | 2.38 |
| | phenyl-2,4- | | E−01 | E−01 | E−01 | E−03 | E−01 | E−03 | | | | | | |
| | imidazol- | | | | | | | | | | | | | |
| | idinedione^{‡,(G)} | | | | | | | | | | | | | |
| 27 | 2-Hydroxy | 27.82 | 7.90 | 5.56 | 1.14 | 2.47 | 2.12 | 2.45 | 1.16 | 1.48 | 5.16 | 6.23 | 22.34 | 8.49 |
| | benzoic acid^{‡,G)} | | E−01 | E−01 | E−01 | E−02 | E−02 | E−02 | | | | | | |

TABLE 4
Altered endogenous metabolites intervened by pu-erh tea ingestion.

| | | | P value | | | | | | FC | | | | | |
|---|---|---|---|---|---|---|---|---|---|---|---|---|---|---|
| No. | Metabolite | RT | l h | 3 h | 6 h | 9 h | 12 h | 24 h | l h | 3 h | 6 h | 9 h | 12 h | 24 h |
| 1 | 1-Methyl- | 1.10 | 1.54 | 2.68 | 5.88 | 8.35 | 9.35 | 5.54 | 0.83 | 0.65 | 0.76 | 0.81 | 0.99 | 1.28 |
| | adenosine^{†,(U)} | | E−01 | E−03 | E−02 | E−02 | E−01 | E−02 | | | | | | |
| 2 | 1-Methyl- | 2.29 | 2.87 | 7.26 | 9.72 | 6.07 | 4.29 | 3.38 | 0.56 | 0.43 | 0.47 | 0.59 | 0.79 | 1.12 |
| | inosine^{†,(U)} | | E−03 | E−05 | E−04 | E−03 | E−02 | E−01 | | | | | | |
| 3 | 2-Hydroxy- | 3.58 | 2.11 | 2.36 | 6.32 | 1.15 | 6.22 | 7.01 | 1.78 | 2.07 | 1.80 | 1.75 | 1.11 | 0.92 |
| | 2-methyl- | | E−02 | E−04 | E−03 | E−02 | E−01 | E−01 | | | | | | |
| | butyric acid^{†,(U)} | | | | | | | | | | | | | |
| 4 | 2-Methyl- | 2.21 | 5.14 | 1.21 | 6.07 | 8.74 | 2.58 | 4.50 | 0.82 | 0.62 | 0.86 | 1.04 | 1.29 | 1.76 |
| | guanosine^{†,(U)} | | E−01 | E−01 | E−01 | E−01 | E−01 | E−03 | | | | | | |
| 5 | 3-Butyn-1-al^{†,(U)} | 3.17 | 1.07 | 3.82 | 3.34 | 1.61 | 1.01 | 2.06 | 0.41 | 0.40 | 0.36 | 0.71 | 0.67 | 0.77 |
| | | | E−02 | E−03 | E−03 | E−01 | E−01 | E−01 | | | | | | |
| 6 | 3- | 5.41 | 9.09 | 6.14 | 1.90 | 9.18 | 3.05 | 1.44 | 0.93 | 0.70 | 2.06 | 1.07 | 5.32 | 0.22 |
| | Nitrotyrosine^{†,(U)} | | E−01 | E−01 | E−01 | E−01 | E−07 | E−01 | | | | | | |
| 7 | 3-Phenyl- | 9.45 | 7.83 | 5.67 | 3.53 | 9.68 | 3.53 | 1.56 | 1 25 | 0.63 | 0.00 | 1.03 | 0.00 | 0.25 |
| | butyric acid^{†,(U)} | | E−01 | E−01 | E−02 | E−01 | E−02 | E−01 | | | | | | |
| 8 | 4-Andro- | 6.49 | 3.47 | 8.36 | 5.56 | 1.35 | 3.11 | 3.02 | 0.75 | 0.36 | 0.34 | 0.65 | 0.79 | 1.28 |
| | stenediol^{†,(U)} | | E−01 | E−03 | E−03 | E−01 | E−01 | E−01 | | | | | | |
| 9 | 4-Hydroxy- | 6.44 | 2.19 | 2.24 | 3.66 | 1.40 | 1.03 | 8.96 | 0.19 | 0.16 | 0.06 | 0.19 | 0.54 | 0.72 |
| | 3-methyl- | | E−05 | E−05 | E−07 | E−04 | E−02 | E−02 | | | | | | |
| | benzoic acid^{†,(U)} | | | | | | | | | | | | | |
| 10 | 4-Hydroxy- | 6.45 | 1.32 | 4.64 | 4.64 | 4.64 | 8.32 | 2.10 | 0.10 | 0.00 | 0.00 | 0.00 | 0.31 | 0.50 |
| | benzoic acid*^{,(U)} | | E−02 | E−03 | E−03 | E−03 | E−02 | E−01 | | | | | | |
| 11 | Adipic acid*^{,(U)} | 3.82 | 5.20 | 4.26 | 2.54 | 1.73 | 7.14 | 2.73 | 0.92 | 0.69 | 0.62 | 0.78 | 0.70 | 1.18 |
| | | | E−01 | E−02 | E−02 | E−01 | E−02 | E−01 | | | | | | |
| 12 | Cytosine*^{,(U)} | 2.43 | 7.75 | 3.58 | 7.64 | 8.68 | 7.83 | 5.25 | 0.65 | 0.31 | 0.51 | 0.70 | 0.96 | 1.30 |
| | | | E−02 | E−04 | E−03 | E−02 | E−01 | E−02 | | | | | | |
| 13 | Glucosamine*^{,(U)} | 0.77 | 4.50 | 1.97 | 4.50 | 4.50 | 4.50 | 9.83 | 0.00 | 0.31 | 0.00 | 0.00 | 0.00 | 0.98 |
| | | | E−02 | E−01 | E−02 | E−02 | E−02 | E−01 | | | | | | |
| 14 | Homoserine*^{,(U)} | 0.78 | 3.55 | 1.57 | 2.36 | 7.37 | 3.70 | 5.07 | 0.45 | 0.29 | 0.45 | 0.40 | 0.81 | 1.21 |
| | | | E−02 | E−03 | E−02 | E−03 | E−01 | E−01 | | | | | | |
| 15 | Dihydro- | 0.73 | 8.12 | 8.65 | 2.57 | 4.91 | 2.36 | 5.04 | 1.32 | 0.96 | 1.33 | 0.84 | 1.40 | 1.10 |
| | thymine^{†,(U)} | | E−02 | E−01 | E−01 | E−01 | E−02 | E−01 | | | | | | |
| 16 | Homo- | 0.70 | 4.84 | 4.14 | 2.39 | 2.05 | 4.71 | 5.25 | 1.88 | 1.96 | 2.41 | 1.99 | 1.17 | 0.84 |
| | cysteine*^{,(U)} | | E−03 | E−03 | E−05 | E−04 | E−01 | E−01 | | | | | | |
| 17 | Hypox- | 1.01 | 2.94 | 2.58 | 5.83 | 5.93 | 9.07 | 1.39 | 1.52 | 0.44 | 0.34 | 0.50 | 0.53 | 1.68 |
| | anthin*^{,(U)} | | E−02 | E−03 | E−04 | E−03 | E−03 | E−02 | | | | | | |
| 18 | Kynurenine^{†,(U)} | 2.28 | 7.61 | 1.37 | 7.62 | 3.32 | 7.08 | 5.79 | 0.48 | 0.55 | 0.45 | 0.36 | 0.89 | 0.85 |
| | | | E−02 | E−01 | E−02 | E−02 | E−01 | E−01 | | | | | | |
| 19 | Methionine*^{,(U)} | 1.10 | 7.37 | 3.93 | 1.38 | 5.22 | 7.35 | 5.69 | 0.95 | 0.75 | 0.81 | 0.94 | 0.96 | 1.25 |
| | | | E−01 | E−02 | E−01 | E−01 | E−01 | E−02 | | | | | | |
| 20 | Valine*^{,(U)} | 0.90 | 1.88 | 7.35 | 1.95 | 1.34 | 3.14 | 5.76 | 7.58 | 1.25 | 2.16 | 2.32 | 2.76 | 1.38 |
| | | | E−01 | E−01 | E−01 | E−01 | E−02 | E−01 | | | | | | |
| 21 | Methyl- | 1.88 | 6.54 | 7.10 | 6.77 | 1.18 | 5.02 | 5.07 | 0.89 | 0.59 | 0.39 | 0.65 | 0.83 | 1.22 |
| | malonic acid*^{,(U)} | | E−01 | E−02 | E−03 | E−01 | E−01 | E−01 | | | | | | |
| 22 | N-Acetyl- | 0.80 | 2.52 | 3.72 | 2.61 | 8.47 | 2.50 | 9.53 | 0.59 | 0.35 | 0.45 | 0.63 | 0.84 | 0.99 |
| | putrescine^{†,(U)} | | E−02 | E−04 | E−03 | E−03 | E−01 | E−01 | | | | | | |
| 23 | N-Acetyl-L- | 0.89 | 5.08 | 8.01 | 8.36 | 9.99 | 4.54 | 2.75 | 0.92 | 0.77 | 0.97 | 1.00 | 1.22 | 1.12 |
| | lysine*^{,(U)} | | E−01 | E−02 | E−01 | E−01 | E−02 | E−01 | | | | | | |
| 24 | N-Methyl-L- | 0.66 | 5.10 | 7.85 | 9.01 | 2.35 | 2.45 | 1.25 | 0.78 | 0.92 | 1.64 | 1.67 | 1.37 | 1.50 |
| | histidine*^{,(U)} | | E−01 | E−01 | E−02 | E−02 | E−01 | E−01 | | | | | | |
| 25 | O-Acetyl-L- | 1.29 | 3.46 | 3.46 | 3.46 | 3.76 | 7.40 | 9.25 | 0.00 | 0.00 | 0.00 | 0.44 | 0.79 | 1.07 |
| | serine*^{,(U)} | | E−02 | E−02 | E−02 | E−01 | E−01 | E−01 | | | | | | |
| 26 | Pantetheine^{†,(U)} | 2.82 | 3.81 | 3.41 | 3.90 | 7.24 | 3.90 | 9.13 | 0.33 | 0.09 | 0.73 | 0.89 | 1.21 | 1.02 |
| | | | E−03 | E−05 | E−01 | E−01 | E−01 | E−01 | | | | | | |
| 27 | Paraxanthine^{†,(U)} | 2.96 | 2.75 | 1.50 | 9.11 | 1.98 | 1.94 | 6.03 | 11.62 | 42.69 | 54.55 | 45.99 | 38.67 | 19.22 |
| | | | E−06 | E−08 | E−08 | E−10 | E−11 | E−07 | | | | | | |
| 28 | p-Coumaric | 5.34 | 5.66 | 2.72 | 6.72 | 8.79 | 1.45 | 1.01 | 0.21 | 0.17 | 0.21 | 0.29 | 0.51 | 0.76 |
| | acid*^{,(U)} | | E−06 | E−06 | E−06 | E−05 | E−03 | E−01 | | | | | | |
| 29 | Phospho- | 0.69 | 4.32 | 5.41 | 6.14 | 1.23 | 7.23 | 2.22 | 1.77 | 0.83 | 1.18 | 1.51 | 0.91 | 0.67 |
| | creatine*^{,(U)} | | E−02 | E−01 | E−01 | E−01 | E−01 | E−01 | | | | | | |
| 30 | Queuine^{†,(U)} | 0.88 | 1.03 | 1.62 | 1.56 | 8.60 | 6.72 | 4.98 | 0.71 | 0.39 | 0.39 | 0.68 | 0.95 | 1.29 |
| | | | E−01 | E−03 | E−03 | E−02 | E−01 | E−02 | | | | | | |
| 31 | Taurine*^{,(U)} | 0.96 | 3.35 | 7.59 | 6.13 | 5.06 | 4.37 | 8.37 | 1.48 | 1.39 | 1.78 | 1.12 | 0.82 | 0.96 |
| | | | E−02 | E−02 | E−03 | E−01 | E−01 | E−01 | | | | | | |
| 32 | Tetradeca- | 5.79 | 5.38 | 2.30 | 4.47 | 2.18 | 1.45 | 5.24 | 0.13 | 0.42 | 0.11 | 0.00 | 0.31 | 0.13 |
| | nedioic acid^{†,(U)} | | E−02 | E−01 | E−02 | E−02 | E−01 | E−02 | | | | | | |
| 33 | Theophylline^{†,(U)} | 2.60 | 4.39 | 9.48 | 1.57 | 1.56 | 2.92 | 1.70 | 4.04 | 6.76 | 7.75 | 5.42 | 4.43 | 2.67 |
| | | | E−03 | E−06 | E−06 | E−06 | E−05 | E−02 | | | | | | |
| 34 | Thymidine^{†,(U)} | 0.76 | 1.55 | 1.16 | 5.82 | 1.44 | 6.15 | 3.46 | 0.25 | 0.04 | 0.16 | 0.46 | 0.36 | |
| | | | E−02 | E−03 | E−03 | E−01 | E−02 | E−01 | | | | | | |
| 35 | Thymine*^{,(U)} | 0.80 | 1.69 | 1.07 | 2.78 | 5.46 | 2.87 | 7.76 | 0.21 | 0.17 | 0.21 | 0.38 | 0.77 | 1.06 |
| | | | E−04 | E−04 | E−04 | E−03 | E−01 | E−01 | | | | | | |
| 36 | Urea*^{,(U)} | 0.69 | 1.61 | 3.87 | 3.35 | 2.08 | 5.97 | 7.20 | 1.81 | 1.83 | 1.73 | 1.58 | 0.91 | 0.94 |
| | | | E−02 | E−05 | E−04 | E−02 | E−01 | E−01 | | | | | | |
| 37 | Uric acid*^{,(U)} | 0.94 | 1.18 | 2.09 | 1.06 | 7.80 | 6.86 | 9.45 | 1.53 | 1.59 | 1.47 | 1.31 | 1.07 | 1.01 |
| | | | E−02 | E−03 | E−02 | E−02 | E−01 | E−01 | | | | | | |
| 38 | Xanthosine*^{,(U)} | 2.11 | 7.15 | 2.52 | 1.53 | 7.95 | 3.61 | 4.91 | 0.91 | 0.34 | 0.16 | 0.32 | 0.78 | 1.17 |
| | | | E−01 | E−03 | E−04 | E−03 | E−01 | E−01 | | | | | | |
| 39 | Inositol*^{,(U)} | 2.96 | 2.75 | 1.50 | 9.11 | 1.98 | 1.94 | 6.03 | 11.62 | 42.69 | 54.55 | 45.99 | 38.67 | 19.22 |
| | | | E−06 | E−08 | E−08 | E−10 | E−11 | E−07 | | | | | | |
| 40 | Isocitric acid*^{,(U)} | 20.33 | 3.17 | 1.09 | 2.18 | 2.00 | 5.34 | 5.48 | 0.09 | 0.06 | 0.16 | 0.43 | 0.81 | 1.19 |
| | | | E−05 | E−05 | E−04 | E−02 | E−01 | E−01 | | | | | | |
| 41 | Carnosine*^{,(U)} | 26.48 | 4.33 | 2.52 | 1.58 | 6.87 | 1.79 | 8.49 | 2.30 | 2.93 | 2.60 | 2.20 | 2.18 | 2.71 |
| | | | E−04 | E−04 | E−04 | E−05 | E−03 | E−04 | | | | | | |
| 42 | 4-Hydroxy- | 21.63 | 6.76 | 1.19 | 2.21 | 9.54 | 4.01 | 5.18 | 0.39 | 0.11 | 0.27 | 0.55 | 0.85 | 1.12 |
| | 3-methoxy- | | E−04 | E−06 | E−05 | E−03 | E−01 | E−01 | | | | | | |
| | phenylacetic | | | | | | | | | | | | | |
| | acid*^{,(G)} | | | | | | | | | | | | | |
| 43 | 5-(1- | 29.99 | 8.54 | 1.45 | 4.30 | 9.91 | 1.13 | 9.04 | 0.41 | 0.20 | 0.26 | 0.29 | 0.30 | 0.38 |
| | Ethoxyethox | | E−04 | E−05 | E−05 | E−05 | E−04 | E−04 | | | | | | |
| | y)-2-hexenoic | | | | | | | | | | | | | |
| | acid [symbol] ^{,(G)} | | | | | | | | | | | | | |
| 44 | Threonic | 13.79 | 1.32 | 2.56 | 4.85 | 1.62 | 7.48 | 4.81 | 0.70 | 0.48 | 0.33 | 0.46 | 0.63 | 1.07 |
| | acid [symbol] ^{,(G)} | | E−03 | E−05 | E−07 | E−05 | E−04 | E−01 | | | | | | |
| 45 | 2-O-methyl- | 21.57 | 1.32 | 1.25 | 2.89 | 1.84 | 7.50 | 2.10 | 0.63 | 0.43 | 0.49 | 0.83 | 0.97 | 1.35 |
| | 3,5,6- | | E−03 | E−05 | E−05 | E−01 | E−01 | E−03 | | | | | | |
| | trihydroxy- | | | | | | | | | | | | | |
| | ascorbic acid [symbol] ^{,(G)} | | | | | | | | | | | | | |
| 46 | Fructose*^{,(G)} | 16.50 | 1.60 | 1.48 | 1.08 | 2.60 | 2.17 | 2.69 | 0.32 | 0.25 | 0.21 | 0.14 | 0.26 | 0.54 |
| | | | E−03 | E−04 | E−04 | E−05 | E−04 | E−02 | | | | | | |
| 47 | Ornithine | 24.90 | 2.64 | 3.40 | 1.70 | 2.32 | 8.84 | 1.43 | 0.51 | 0.33 | 1.36 | 4.29 | 5.10 | 2.90 |
| | | | E−03 | E−04 | E−01 | E−04 | E−07 | E−04 | | | | | | |
| 48 | 2-Deoxy- | 16.43 | 2.65 | 2.85 | 4.48 | 9.27 | 4.73 | 1.50 | 0.44 | 0.31 | 0.33 | 0.50 | 0.87 | 1.32 |
| | 3,4,5- | | E−03 | E−04 | E−04 | E−03 | E−01 | E−01 | | | | | | |
| | trihydroxy- | | | | | | | | | | | | | |
| | erythro- | | | | | | | | | | | | | |
| | pentonic acid [symbol] ^{,(G)} | | | | | | | | | | | | | |
| 49 | Pseudo | 29.76 | 4.16 | 2.15 | 4.14 | 5.59 | 9.05 | 4.49 | 0.72 | 0.43 | 0.48 | 0.63 | 0.84 | 1.27 |
| | uridine^{‡,(G)} | | E−03 | E−05 | E−06 | E−04 | E−02 | E−02 | | | | | | |
| 50 | (4-Hydroxy- | | | | | | | | | | | | | |
| | 3-methoxy- | 20.5 | 4.49 | 1.73 | 3.73 | 1.28 | 2.47 | 6.87 | 0.52 | 0.51 | 0.44 | 0.45 | 0.80 | 0.93 |
| | phenyl)ethylene | | E−03 | E−03 | E−04 | E−03 | E−01 | E−01 | | | | | | |
| | glycol^{‡,(G)} | | | | | | | | | | | | | |
| 51 | N-Acetyl-L- | 19.35 | 5.60 | 4.67 | 2.45 | 2.18 | 8.89 | 8.56 | 0.47 | 0.47 | 0.58 | 0.55 | 1.03 | 1.04 |
| | glutamic acid*^{,(G)} | | E−03 | E−03 | E−02 | E−02 | E−01 | E−01 | | | | | | |
| 52 | 2,4- | 11.12 | 6.51 | 1.77 | 2.32 | 2.44 | 3.24 | 5.45 | 0.49 | 0.57 | 0.61 | 0.59 | 0.83 | 0.90 |
| | bishydroxy- | | E−03 | E−02 | E−02 | E−02 | E−01 | E−01 | | | | | | |
| | butanoic acid*^{,(G)} | | | | | | | | | | | | | |
| 53 | 1,2,3- | 9.00 | 6.89 | 6.96 | 3.72 | 2.22 | 2.38 | 2.20 | 0.49 | 0.61 | 0.61 | 0.59 | 0.79 | 0.77 |
| | trihydroxy- | | E−03 | E−02 | E−02 | E−02 | E−01 | E−01 | | | | | | |
| | butane [symbol] ^{,(G)} | | | | | | | | | | | | | |
| 54 | 2,4,6- | 16.77 | 1.20 | 2.33 | 6.81 | 3.60 | 1.51 | 2.13 | 044 | 0.13 | 0.16 | 0.55 | 0.73 | 1.47 |
| | trihydroxy- | | E−02 | E−05 | E−05 | E−02 | E−01 | E−02 | | | | | | |
| | 1,3,5-triazine^{‡,(G)} | | | | | | | | | | | | | |
| 55 | 2-oxo- | 6.03 | 1.23 | 3.98 | 8.28 | 4.00 | 1.55 | 8.82 | 0.53 | 0.51 | 0.41 | 0.50 | 0.58 | 0.57 |
| | propanoic acid^{‡,(G)} | | E−02 | E−03 | E−04 | E−03 | E−02 | E−03 | | | | | | |
| 56 | 2,3- | 9.65 | 1.33 | 1.98 | 1.31 | 2.93 | 7.36 | 1.40 | 0.56 | 0.61 | 0.61 | 0.62 | 1.06 | 0.78 |
| | dihydroxy- | | E−02 | E−02 | E−02 | E−02 | E−01 | E−01 | | | | | | |
| | propanoic | | | | | | | | | | | | | |
| | acid^{‡,(G)} | | | | | | | | | | | | | |
| 57 | Mannose*^{,(G)} | 21.62 | 1.45 | 7.20 | 1.22 | 1.17 | 4.86 | 9.70 | 0.33 | 0.25 | 0.31 | 0.31 | 0.47 | 0.56 |
| | | | E−02 | E−03 | E−02 | E−02 | E−02 | E−02 | | | | | | |
| 58 | Xanthine*^{,(G)} | 24.84 | 1.53 | 2.09 | 1.15 | 2.37 | 1.38 | 9.68 | 0.42 | 0.12 | 0.07 | 0.12 | 0.23 | 1.01 |
| | | | E−02 | E−05 | E−05 | E−05 | E−04 | E−01 | | | | | | |
| 59 | 3-Methyl-3- | 15.13 | 1.64 | 6.02 | 4.51 | 1.13 | 5.29 | 8.30 | 0.72 | 0.54 | 0.56 | 0.79 | 0.94 | 1.22 |
| | hydroxy- | | E−02 | E−04 | E−04 | E−01 | E−01 | E−02 | | | | | | |
| | pentanedioic | | | | | | | | | | | | | |
| | acid^{‡,(G)} | | | | | | | | | | | | | |
| 60 | Glycerol- | 18.87 | 1.70 | 7.81 | 1.92 | 7.20 | 5.22 | 9.40 | 0.57 | 0.37 | 0.41 | 0.70 | 0.86 | 1.02 |
| | phosphate*^{,(G)} | | E−02 | E−04 | E−03 | E−02 | E−01 | E−01 | | | | | | |
| 61 | Homo- | 19.07 | 1.93 | 4.94 | 4.76 | 9.93 | 8.55 | 1.93 | 0.38 | 0.13 | 0.11 | 0.32 | 1.05 | 1.48 |
| | vanillic acid*^{,(G)} | | E−02 | E−04 | E−04 | E−03 | E−01 | E−01 | | | | | | |
| 62 | Arabitol*^{,(G)} | 17.86 | 2.13 | 2.85 | 8.52 | 4.70 | 4.06 | 4.71 | 0.69 | 0.69 | 1.03 | 1.11 | 1.11 | 1.11 |
| | | | E−02 | E−02 | E−01 | E−01 | E−01 | E−01 | | | | | | |
| 63 | D-Gluconic | 24.41 | 2.74 | 4.24 | 1.02 | 6.43 | 7.48 | 7.08 | 0.74 | 0.57 | 0.78 | 1.06 | 1.71 | 1.50 |
| | acid*^{,(G)} | | E−02 | E−04 | E−01 | E−01 | E−04 | E−03 | | | | | | |
| 64 | Pyruvic acid*^{,(G)} | 5.47 | 3.11 | 1.00 | 2.95 | 1.70 | 6.70 | 2.20 | 0.53 | 0.66 | 0.71 | 0.65 | 0.90 | 0.51 |
| | | | E−02 | E−01 | E−01 | E−01 | E−01 | E−02 | | | | | | |
| 65 | Cyclohexyl- | 5.79 | 4.06 | 6.35 | 4.15 | 7.51 | 3.54 | 8.65 | 0.22 | 0.29 | 0.21 | 0.31 | 0.57 | 0.91 |
| | amine [symbol] ^{,(G)} | | E−02 | E−02 | E−02 | E−02 | E−01 | E−01 | | | | | | |
| 66 | Isoleucine*^{,(G)} | 9.07 | 4.15 | 6.46 | 9.56 | 6.89 | 1.33 | 2.11 | 0.74 | 0.77 | 0.81 | 1.06 | 1.48 | 1.48 |
| | | | E−02 | E−02 | E−02 | E−01 | E−03 | E−04 | | | | | | |
| 67 | Gluconic | 21.76 | 4.27 | 2.52 | 3.84 | 2.83 | 5.69 | 2.83 | 0.82 | 0.88 | 0.91 | 0.78 | 0.95 | 0.89 |
| | acid, lactone^{‡,(G)} | | E−02 | E−01 | E−01 | E−02 | E−01 | E−01 | | | | | | |
| 68 | Lysine*^{,(G)} | 14.67 | 4.70 | 8.99 | 2.58 | 5.34 | 7.47 | 8.80 | 0.61 | 0.49 | 0.57 | 0.86 | 0.93 | 0.97 |
| | | | E−02 | E−03 | E−02 | E−01 | E−01 | E−01 | | | | | | |
| 69 | 2-Methoxy- | 8.11 | 4.87 | 7.01 | 5.80 | 1.56 | 8.79 | 1.04 | 0.48 | 0.31 | 0.31 | 0.41 | 0.59 | 0.61 |
| | phenol^{‡,(G)} | | E−02 | E−03 | E−03 | E−02 | E−02 | E−01 | | | | | | |
| 70 | cis-4,5- | 14.73 | 5.29 | 1.18 | 2.22 | 1.70 | 3.82 | 5.76 | 1.63 | 2.23 | 2.35 | 1.76 | 1.14 | 1.09 |
| | dihydroxy- | | E−02 | E−03 | E−03 | E−03 | E−01 | E−01 | | | | | | |
| | 3,4,5,6- | | | | | | | | | | | | | |
| | tetrahydro- | | | | | | | | | | | | | |
| | 1,2-dithiane [symbol] ^{,(G)} | | | | | | | | | | | | | |
| 71 | Matitol*^{,(G)} | 32.20 | 5.38 | 4.91 | 2.95 | 1.92 | 7.88 | 5.80 | 1.64 | 3.18 | 2.44 | 1.63 | 1.04 | 0.92 |
| | | | E−02 | E−06 | E−05 | E−02 | E−01 | E−01 | | | | | | |
| 72 | 2-Hydroxy- | 8.67 | 5.77 | 3.30 | 8.43 | 3.67 | 4.01 | 1.14 | 0.56 | 0.58 | 0.50 | 0.54 | 0.84 | 1.38 |
| | ehtylamine^{‡,(G)} | | E−02 | E−02 | E−03 | E−02 | E−01 | E−01 | | | | | | |
| 73 | 1,2,3- | 5.32 | 5.92 | 2.77 | 1.01 | 5.40 | 9.01 | 6.61 | 2.05 | 2.74 | 2.86 | 1.96 | 1.04 | 0.89 |
| | trimethyl- | | E−02 | E−03 | E−02 | E−02 | E−01 | E−01 | | | | | | |
| | benzene^{‡,(G)} | | | | | | | | | | | | | |
| 74 | Sucrose*^{,(G)} | 31.73 | 5.99. | 4.24 | 5.63 | 1.01 | 6.83 | 8.73 | 0.11 | 0.03 | 0.09 | 0.22 | 1.24 | 0.19 |
| | | | E−02 | E−02 | E−02 | E−01 | E−01 | E−02 | | | | | | |
| 75 | 4-amino- | 16.56 | 6.42 | 1.35 | 4.17 | 5.72 | 1.66 | 3.78 | 3.95 | 5.14 | 24.12 | 39.08 | 100.29 | 49.03 |
| | butanoic acid*^{,(G)} | | E−02 | E−01 | E−03 | E−03 | E−04 | E−03 | | | | | | |
| 76 | Palmitic acid*^{,(G)} | 25.60 | 6.46 | 3.53 | 2.22 | 6.74 | 1.06 | 2.81 | 1.82 | 2.17 | 1.89 | 1.13 | 0.60 | 0.50 |
| | | | E−02 | E−03 | E−02 | E−01 | E−01 | E−02 | | | | | | |
| 77 | Glycer- | 7.74 | 6.70 | 8.52 | 9.15 | 9.59 | 2.46 | 1.04 | 0.70 | 0.74 | 0.99 | 1.01 | 1.90 | 2.51 |
| | aldehyde*^{,(G)} | | E−02 | E−02 | E−01 | E−01 | E−04 | E−05 | | | | | | |
| 78 | 2-Methyl-3- | 7.63 | 7.21 | 1.68 | 1.47 | 4.55 | 4.66 | 2.07 | 0.74 | 0.83 | 0.70 | 0.72 | 0.91 | 0.71 |
| | hyroxy- | | E−02 | E−01 | E−02 | E−02 | E−01 | E−02 | | | | | | |
| | butanoic acid [symbol] ^{,(G)} | | | | | | | | | | | | | |
| 79 | Oxalic acid*^{,(G)} | 6.67 | 8.12 | 4.96 | 1.95 | 1.01 | 5.73 | 2.37 | 0.80 | 0.78 | 0.77 | 0.85 | 0.96 | 0.89 |
| | | | E−02 | E−02 | E−02 | E−01 | E−01 | E−01 | | | | | | |
| 80 | 2-Amino- | 7.27 | 9.10 | 4.58 | 1.39 | 8.99 | 1.80 | 9.86 | 1.42 | 1.87 | 1.69 | 1.51 | 1.39 | 1.60 |
| | butyric acid*^{,(G)} | | E−02 | E−03 | E−02 | E−02 | E−01 | E−02 | | | | | | |
| 81 | Cystine*^{,(G)} | 28.88 | 9.36 | 1.75 | 4.34 | 2.20 | 3.90 | 7.00 | 0.70 | 0.54 | 0.44 | 0.47 | 0.80 | 1.09 |
| | | | E−02 | E−02 | E−03 | E−02 | E−01 | E−01 | | | | | | |
| 82 | [(phenylmeth | 28.09 | 9.58 | 1.30 | 2.81 | 2.13 | 4.98 | 4.83 | 0.59 | 0.27 | 0.30 | 0.64 | 0.82 | 1.87 |
| | oxy)imino]- | | E−02 | E−03 | E−03 | E−01 | E−01 | E−03 | | | | | | |
| | acetic acid [symbol] ^{,(G)} | | | | | | | | | | | | | |
| 83 | Trans- | 18.62 | 9.84 | 1.36 | 5.72 | 1.45 | 1.01 | 4.77 | 0.84 | 0.71 | 0.71 | 0.82 | 1.16 | 1.10 |
| | acontic acid*^{,(G)} | | E−02 | E−02 | E−03 | E−01 | E−01 | E−01 | | | | | | |
| 84 | Citric acid*^{,(G)} | 20.25 | 1.07 | 3.63 | 1.68 | 3.85 | 1.03 | 5.20 | 1.42 | 1.76 | 1.59 | 1.20 | 1.42 | 1.17 |
| | | | E−01 | E−03 | E−02 | E−01 | E−01 | E−01 | | | | | | |
| 85 | 3-Hydroxy- | 5.36 | 1.17 | 8.77 | 1.44 | 1.15 | 2.74 | 4.40 | 1.19 | 1.42 | 1.51 | 1.51 | 1.74 | 2.23 |
| | pyridine^{‡,(G)} | | E−01 | E−04 | E−03 | E−04 | E−09 | E−13 | | | | | | |
| 86 | 2,5- | 26.28 | 1.22 | 1.21 | 1.13 | 1.18 | 7.06 | 7.34 | 0.53 | 0.35 | 0.35 | 0.34 | 0.53 | 1.11 |
| | dihydroxy- | | E−01 | E−02 | E−02 | E−02 | E−02 | E−01 | | | | | | |
| | 1H-indole [symbol] ^{,(G)} | | | | | | | | | | | | | |
| 87 | 9,11,15- | 25.36 | 1.24 | 1.57 | 4.02 | 9.93 | 5.91 | 3.76 | 0.73 | 0.50 | 0.53 | 1.00 | 0.90 | 1.53 |
| | trihydroxy- | | E−01 | E−03 | E−03 | E−01 | E−01 | E−01 | E−02 | | | | | |
| | prosta-5,13- | | | | | | | | | | | | | |
| | dien-1-oic | | | | | | | | | | | | | |
| | acid^{‡,(G)} | | | | | | | | | | | | | |
| 88 | Ethanol- | 6.55 | 1.28 | 3.35 | 1.63 | 7.81 | 3.35 | 1.19 | 4.47 | 1.59 | 1.37 | 1.48 | 1.30 | 1.49 |
| | amine^{‡,(G)} | | E−01 | E−02 | E−01 | E−02 | E−01 | E-01 | | | | | | |
| 89 | 3- | 17.02 | 1.38 | 7.68 | 9.07 | 9.73 | 3.63 | 1.14 | 0.65 | 0.37 | 0.40 | 0.99 | 1.34 | 2.15 |
| | Hydroxyhex | | E−01 | E−03 | E−03 | E−01 | E−01 | E−01 | | | | | | |
| | anedioic acid^{‡,(G)} | | | | | | | | | | | | | |
| 90 | Creatinine*^{,(G)} | 14.06 | 1.39 | 2.83 | 1.32 | 5.37 | 2.00 | 1.95 | 0.88 | 0.75 | 0.86 | 0.83 | 0.80 | 0.74 |
| | | | E−01 | E−02 | E−01 | E−02 | E−02 | E−03 | | | | | | |
| 91 | Rhamnose*^{,(G)} | 18.25 | 1.50 | 1.12 | 2.27 | 1.10 | 1.25 | 5.75 | 0.79 | 0.58 | 0.63 | 0.74 | 0.75 | 1.10 |
| | | | E−01 | E−02 | E−02 | E−01 | E−01 | E−01 | | | | | | |
| 92 | Amino- | 12.26 | 2.00 | 2.35 | 8.04 | 7.00 | 1.62 | 3.19 | 1.90 | 3.09 | 3.09 | 0.45 | 0.57 | 0.35 |
| | malonic acid [symbol] ^{,(G)} | | E−01 | E−03 | E−03 | E−02 | E−01 | E−02 | | | | | | |
| 93 | Glycine*^{,(G)} | 9.30 | 2.04 | 2.09 | 5.78 | 3.12 | 9.80 | 7.72 | 1.28 | 1.67 | 2.32 | 1.53 | 1.77 | 1.04 |
| | | | E−01 | E−02 | E−04 | E−02 | E−04 | E−01 | | | | | | |
| 94 | 5-Hydroxy- | 17.53 | 2.23 | 4.55 | 2.66 | 1.38 | 7.55 | 4.74 | 0.70 | 0.52 | 0.47 | 0.60 | 0.55 | 1.21 |
| | 1H-indole^{‡,(G)} | | E−01 | E−02 | E−02 | E−01 | E−02 | E−01 | | | | | | |
| 95 | Octa- | 28.90 | 2.29 | 6.60 | 2.11 | 1.22 | 2.30 | 1.63 | 1.28 | 1.66 | 1.29 | 0.72 | 0.42 | 0.40 |
| | decanoic acid^{‡,(G)} | | E−01 | E−03 | E−01 | E−01 | E−04 | E−04 | | | | | | |
| 96 | Threonine*^{,(G)} | 10.63 | 2.44 | 2.08 | 1.14 | 6.27 | 7.16 | 1.45 | 1.30 | 2.30 | 2.20 | 1.58 | 2.16 | 1.34 |
| | | | E−01 | E−02 | E−02 | E−02 | E−03 | E−01 | | | | | | |
| 97 | Glutamine*^{,(G)} | 19.15 | 2.63 | 3.11 | 3.40 | 1.90 | 7.34 | 9.88 | 1.21 | 1.5.3 | 1.47 | 1.26 | 0.95 | 1.00 |
| | | | E−01 | E−02 | E−02 | E−01 | E−01 | E−01 | | | | | | |
| 98 | Uracil*^{,(G)} | 9.80 | 2.69 | 1.11 | 1.43 | 8.46 | 7.31 | 2.46 | 0.63 | 0.12 | 0.12 | 0.22 | 0.40 | 1.45 |
| | | | E−01 | E−04 | E−04 | E−04 | E−03 | E−01 | | | | | | |
| 99 | 3-Hydroxy | 26.02 | 2.98 | 6.52 | 2.85 | 3.75 | 5.88 | 1.13 | 0.74 | 0.47 | 0.58 | 1.46 | 1.70 | 2.17 |
| | sebacic acid^{‡,(G)} | | E−01 | E−03 | E−02 | E−01 | E−02 | E−01 | | | | | | |
| 100 | Threonine*^{,(G)} | 10.63 | 3.16 | 1.78 | 8.34 | 3.37 | 6.22 | 5.72 | 0.84 | 0.60 | 0.55 | 0.50 | 0.41 | 0.42 |
| | | | E−01 | E−02 | E−04 | E−04 | E−05 | E−05 | | | | | | |
| | 2,3- | | | | | | | | | | | | | |
| 101 | Dihydroxybu-2 | 10.0 | 3.26 | 1.66 | 5.21 | 2.94 | 7.18 | 1.01 | 0.85 | 0.72 | 0.66 | 0.81 | 1.08 | 1.65 |
| | tanoic acid [symbol] ^{,(G)} | | E−01 | E−01 | E−02 | E−01 | E−01 | E−02 | | | | | | |
| 102 | Gluticol*^{,(G)} | 15.34 | 3.34 | 7.27 | 5.14 | 6.63 | 5.73 | 3.92 | 0.63 | 0.40 | 0.33 | 0.38 | 0.37 | 0.33 |
| | | | E−01 | E−02 | E−02 | E−02 | E−02 | E−02 | | | | | | |
| 103 | Uridine*^{,(G)} | 30.20 | 3.49 | 2.02 | 6.24 | 4.34 | 2.17 | 5.25 | 0.84 | 0.63 | 0.72 | 0.88 | 0.64 | 1.26 |
| | | | E−01 | E−02 | E−02 | E−01 | E−02 | E−02 | | | | | | |
| 104 | Malic acid*^{,(G)} | 14.55 | 4.41 | 5.07 | 3.16 | 9.13 | 2.04 | 1.00 | 0.84 | 0.64 | 0.69 | 1.03 | 1.22 | 1.99 |
| | | | E−01 | E−02 | E−02 | E−01 | E−01 | E−02 | | | | | | |
| 105 | m-Hydroxy | 28.61 | 4.82 | 7.82 | 5.45 | 1.73 | 9.67 | 1.24 | 0.88 | 0.55 | 0.53 | 0.75 | 0.99 | 1.27 |
| | hippuric acid^{‡,(G)} | | E−01 | E−03 | E−03 | E−01 | E−01 | E−01 | | | | | | |
| 106 | 2-Methyl-2- | 6.71 | 4.91 | 2.87 | 1.70 | 3.19 | 1.20 | 3.07 | 0.88 | 0.48 | 0.59 | 0.62 | 0.75 | 0.82 |
| | hydroxy- | | E−01 | E−03 | E−02 | E−02 | E−01 | E−01 | | | | | | |
| | butanoic acid^{‡,(G)} | | | | | | | | | | | | | |
| 107 | o-Methyloxime | 16.82 | 5.06 | 5.30 | 7.73 | 6.82 | 6.31 | 2.25 | 0.84 | 0.86 | 0.93 | 0.16 | 0.03 | 0.09 |
| | -xylulose [symbol] ^{,(G)} | | E−01 | E−01 | E−01 | E−05 | E−06 | E−05 | | | | | | |
| 108 | 2-Ethyl-3- | 8.09 | 5.30 | 8.14 | 1.34 | 1.62 | 3.20 | 1.07 | 1.14 | 1.73 | 1.62 | 1.60 | 1.99 | 1.93 |
| | hydroxyprop | | E−01 | E−03 | E−02 | E−01 | E−03 | E−01 | | | | | | |
| | ionic acid^{‡,(G)} | | | | | | | | | | | | | |
| 109 | 4-Hydroxy | 8.21 | 5.87 | 8.87 | 5.67 | 3.22 | 8.42 | 1.05 | 1.07 | 0.97 | 0.91 | 0.71 | 0.55 | 0.62 |
| | butanoic acid^{‡,(G)} | | E−01 | E−01 | E−01 | E−02 | E−04 | E−01 | | | | | | |
| 110 | Alanine*^{,(G)} | 6.26 | 6.39 | 4.76 | 1.26 | 4.07 | 1.87 | 1.51 | 1.09 | 1.87 | 1.94 | 1.20 | 2.16 | 1.31 |
| | | | E−01 | E−03 | E−02 | E−01 | E−03 | E−01 | | | | | | |
| 111 | Serine*^{,(G)} | 10.18 | 7.70 | 7.03 | 2.85 | 2.16 | 8.04 | 5.03 | 1.05 | 1.55 | 1.58 | 1.25 | 1.64 | 1.31 |
| | | | E−01 | E−02 | E−02 | E−01 | E−03 | E−02 | | | | | | |
| 112 | Tyrosine*^{,(G)} | 23.03 | 8.09 | 6.35 | 8.80 | 2.95 | 7.16 | 1.47 | 1.04 | 1.09 | 0.98 | 1.20 | 1.25 | 1.39 |
| | | | E−01 | E−01 | E−01 | E−01 | E−02 | E−02 | | | | | | |
| 113 | Hippuric | 20.75 | 8.20 | 2.68 | 4.75 | 2.21 | 2.37 | 3.42 | 0.95 | 0.76 | 0.53 | 0.62 | 0.79 | 1.22 |
| | acid*^{,(G)} | | E−01 | E−01 | E−03 | E−02 | E−01 | E−01 | | | | | | |
| 114 | Phenol*^{,(G)} | 5.63 | 8.44 | 1.70 | 1.07 | 4.72 | 2.29 | 9.04 | 1.04 | 1.22 | 1.43 | 1.14 | 1.32 | 2.22 |
| | | | E−01 | E−01 | E−01 | E−01 | E−01 | E−05 | | | | | | |
| 115 | Guanidino.- | 14.65 | 8.56 | 8.69 | 1.77 | 2.58 | 1.45 | 5.07 | 1.06 | 1.05 | 1.41 | 1.93 | 1.94 | 1.93 |
| | succinic acid [symbol] ^{,(G)} | | E−01 | E−01 | E−01 | E−02 | E−02 | E−02 | | | | | | |
| 116 | 2-Acetyl- | 5.22 | 8.92 | 6.36 | 7.54 | 1.67 | 3.11 | 1.98 | 0.98 | 1.07 | 1.07 | 1.53 | 1.57 | 1.97 |
| | tropidine^{‡,(G)} | | E−01 | E−01 | E−01 | E−02 | E−03 | E−03 | | | | | | |
| 117 | 3,4- | 5.97 | 9.30 | 1.98 | 9.55 | 4.88 | 7.95 | 9.07 | 1.03 | 2.31 | 1.61 | 1.15 | 0.96 | 1.02 |
| | Dimethyl-2- | | E−01 | E−03 | E−02 | E−01 | E−01 | E−01 | | | | | | |
| | cyclopenten- | | | | | | | | | | | | | |
| | 1-one^{‡,(G)} | | | | | | | | | | | | | |

### Example 11

### Dynamic Concentration Profiles of Absorbed and Biotransformed Plant Metabolites and Endogenous Urine Metabolites

Examples an of the compounds set forth in Tables 2-4, the concentrations of two absorbed plant metabolites, epigallocatechin and caffeine, reached maximum levels in urine at 1 h after oral administration (FIG. 10A). These metabolites were cleared away from urine 9 h post-dose. Another plant metabolite, kaempferol, presents two peaks in the urine profile at 1 and 9 h, respectively. This finding is consistent with previous PK results of this compound, presumably due to enterogastric and enterohepatic circulations. [98-100]

FIG. 10B shows the concentration profiles of several representative metabolites produced through in vivo biotransformation. For example, of the compounds set forth in Tables 2-4, 1,7-dimethyluric acid, hippuric acid, and 7-methylhypoxanthine reached maximum levels in urine 6 h post-dose.

A time-dependent trajectory of endogenous urinary metabolite profiles at different time points after Pu-erh tea intake is shown in FIG. 10C. In the PCA map, each spot represents a sample, and each assembly of samples indicates a particular metabolic profile at different time points. The locus marked by arrows represents the spatial location of the center of a metabolite cluster changing by the time, starting from the pre-dose assembly. From FIG. 10C, urinary metabolite profiles at different time points showed distinct difference from that at the “pre-dose” time point. Furthermore, metabolite profile at 24 h is approaching the pre-dose profile, suggesting that the metabolic homeostasis was being restored.

### Example 12

### Effect of Pu-erh Tea Intake on Human Metabolite Endpoints

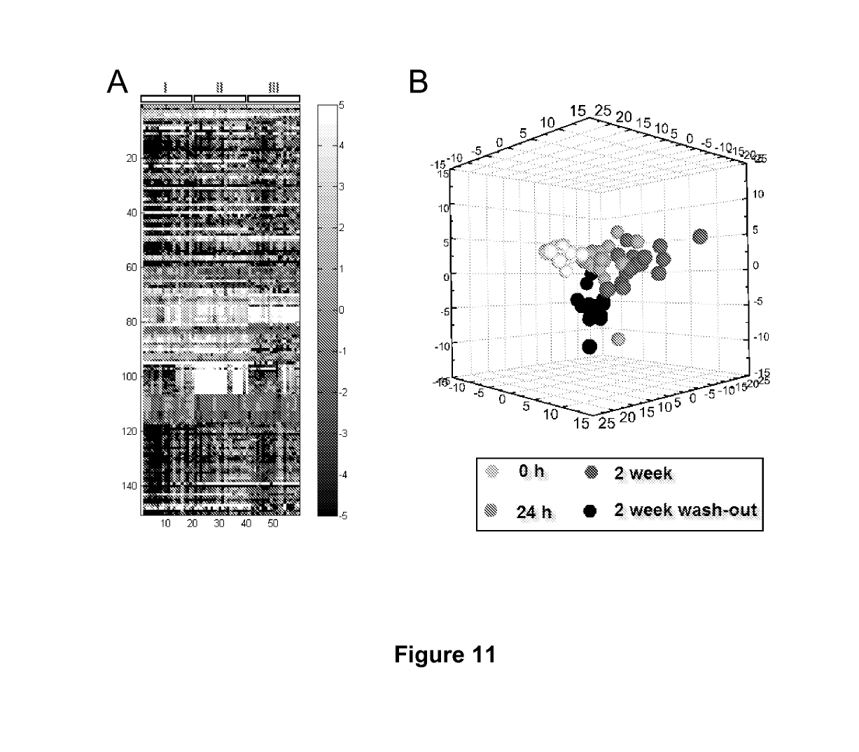

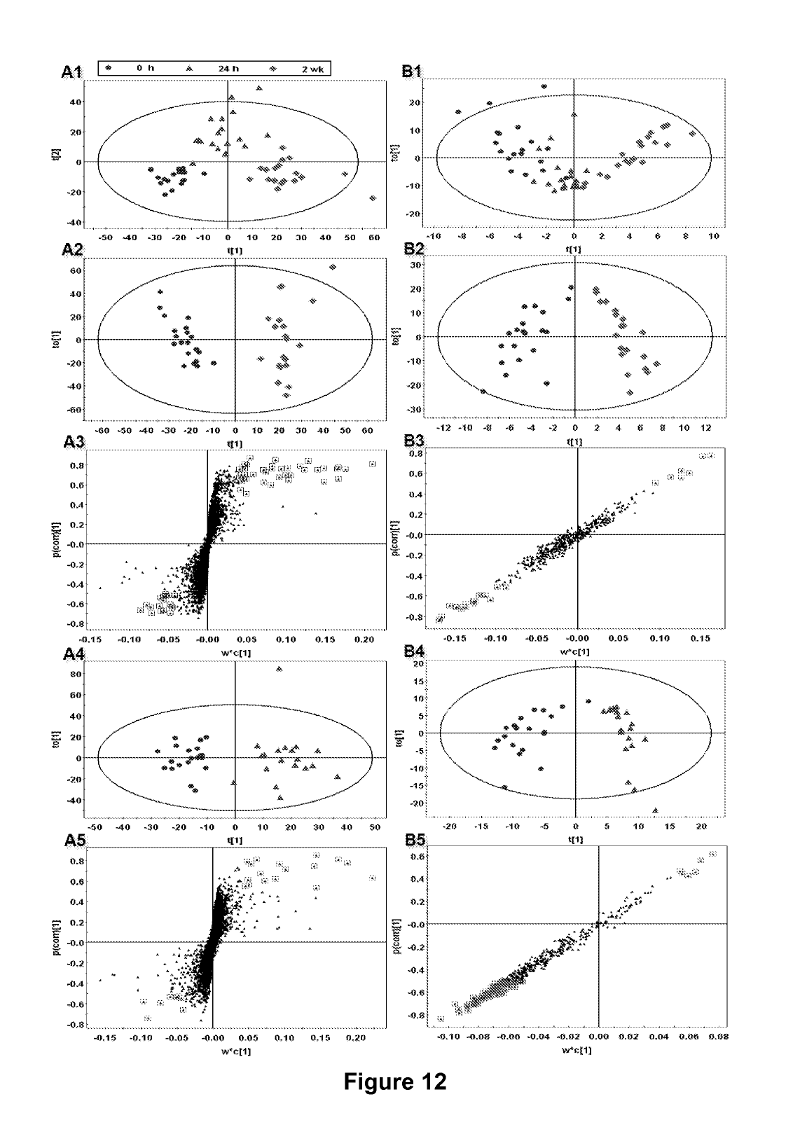

Metabolomic response profiles at 24 h, 2 week, and 2 week wash-out to Pu-erh tea intervention was depicted as a heat map in FIG. 11 by means of Matlab 7.1 software. The differentially expressed (endogenous) metabolites in response to Pu-erh tea intake were selected by multivariate statistical models, orthogonal partial least squares-discriminant analysis (OPLS-DA) and S-plot, with the very important parameters in the projection (VIP) greater than 1.0 and absolute p(corr) value greater than 0.5 (FIG. 12). [95, 101] Representative metabolites most significantly altered in urine are listed in Table 5 along with fold changes (representative profiles: (1) metabolomic changes at 24 h post-dose relative to pre-dose; (2) metabolomic changes at 2 week post-dose relative to pre-dose; (3) metabolomic changes at 2-11 week wash-out relative to pre-dose). Urinary metabolite profile at 2 week of Pu-erh tea daily intake showed distinct difference from that at the “pre-dose” time point in FIG. 11. The metabolic difference is primarily due to the altered gut microbial-human co-metabolism including the increased urinary excretion of 4-methoxyphenylacetic acid, inositol, and 5-hydroxytryptophan, and decreased concentration of 3-chlorotyrosine-2-aminobenzoic acid and 2,5-dihydroxy-1H-indole. The change of these metabolites and their metabolic pathways seems to be consistent with the cholesterol and plasma triglyceride reducing effects of Pu-erh tea. [102, 103]

TABLE 5
Differential metabolites detected from the metabolome after Pu-
erh tea intake (post-dose) as compared to pre-dose metabolome.

| Metabolite | Source | Pathway |
|---|---|---|
| 2-Aminobenzoic acid | Gut microflora | Tryptophan Metabolism |
| 4-Methoxyphenylacetic acid | Gut microflora | Gut microflora |
| 5-Hydroxy-tryptophan | Gut microflora | Tryptophan Metabolism |
| 3,4-Dihydroxyphenylglycol | Gut microflora | Tyrosine Metabolism |
| 3,4-Dimethylbenzoic acid | Gut microflora | Gut microflora |
| 4-Phenoxybutanol | Gut microflora | |
| 1H-Indole-3-methanamine, N,N- | Gut microflora | |
| dimethyl- | | |
| 1,2-Dihydroxy benzene | Gut microflora | |
| 2-Hydroxy-3-methylbutric acid | Gut microflora | |
| 2,3-Dihydroxysuccinic acid | Gut microflora | Citric Acid Cycle, Glutamate |
| | | Metabolism |
| m-Hydroxyphenylacetic acid | Gut microflora | Gut microflora |
| 4-Aminobutanoic acid | Gut microflora | Glutamate Metabolism |
| 2-Ethoxyphenol | Gut microflora | Gut microflora |
| Homovanillic acid | Gut microflora | Tyrosine Metabolism |
| Hydrocaffeic acid | Gut microflora | Gut microflora |
| 3-Methoxy-4-hydroxyphenylacetic | Gut microflora | |
| acid | | |
| 2,5-dihydroxy-1H-indole | Gut microflora | Tryptophan metabolism |
| 4-[10-(3,4-Dimethylphenyl)-1,1,10- | Gut microflora | |
| trimethylundecyl]-1,2- | | |
| dimethylbenzene | | |
| Acetic acid, | Gut microflora | |
| [(phenylmethoxy)imino]-, | | |
| 3,5-Bis(2,5-dimethylphenyl)-2,3- | Gut microflora | |
| dihydro-1H-inden-1-one | | |
| Glyoxylic acid | | Alanine Metabolism, Glycine |
| | | and Serine Metabolism |
| Urea | | Arginine and Proline |
| | | Metabolism, Urea Cycle |
| Citrulline | | Arginine and Proline |
| | | Metabolism, Urea Cycle, |
| | | Aspartate Metabolism |
| Asparagine | | Aspartate Metabolism, |
| | | Ammonia Recycling |
| 1,7-Dimethyluric acid | | Caffeine Metabolism |
| Cyclohexylamine | | Caprolactam degradation |
| Malic acid | | Citric Acid Cycle, Pyruvate |
| | | Metabolism |
| Malonic acid | | Fatty Acid Biosynthesis |
| Butanoic acid | | Fatty Acid Biosynthesis, |
| | | Butyrate Metabolism |
| Inositol | | Galactose Metabolism |
| D-Galactose | | Galactose Metabolism |
| D-Fructose | | Galactose Metabolism |
| D-Fructose | | Galactose Metabolism |
| D-Glucose | | Galactose Metabolism |
| Glucopyranose | | Galactose Metabolism |
| Pyroglutamic acid | | Glutathione Metabolism |
| Pyroglutamic acid | | Gutathione Metabolism |
| Glyceraldehyde | | Glycerolipid Metabolism |
| Carnosine | | Histidine Metabolism |
| Myo-Inositol | | Inositol Metabolism, Galactose |
| | | Metabolism |
| Lysine | | Lysine Degradation |
| Homocysteine | | Methionine Metabolism |
| Serine | | Methionine Metabolism, |
| | | Homocysteine Degradation, |
| | | Ammonia Recycling |
| Arabitol | | Pentose and glucuronate |
| | | interconversions |
| Gluconic acid | | Pentose phosphate pathway |
| Gluconic acid, lactone | | Pentose Phosphate Pathway |
| D-Gluconic acid | | Pentose phosphate pathway |
| 5-Aminoimidazole | | Purine metabolism |
| Guanosine | | Purine Metabolism |
| Pseudo uridine | | Pyrimidine metabolism |
| Uridine | | Pyrimidine Metabolism |
| Uracil | | Pyrimidine Metabolism, Beta- |
| | | Alanine Metabolism |
| Ribitol | | Riboflavin metabolism |
| Ecgonine | | Tropane, piperidine and |
| | | pyridine alkaloid biosynthesis |
| Kynurenine | | Tryptophan Metabolism |
| Vanillylmandelic acid | | Tyrosine Metabolism |
| S-(2-Methylbutanoyl)- | | Valine, Leucine and Isoleucine |
| dihydrolipoamide | | Degradation |
| Leucine | | Valine, Leucine and Isoleucine |
| | | Degradation |
| 1,3-Dimethyluracil | | |
| 3-Chlorotyrosine | | |
| 5-Tetradecenoic acid | | |
| D-Glucuronic acid | | |
| Oleoyl glycine | | |
| Cholestane-3,7,12,24,25-pentol | | |
| 2-Hydroxy-propenoic acid | | |
| Phosphate (3:1) | | |
| 2,3-Dihydroxybutanol | | |
| N-Acetylglutamine | | |
| 2,3-dihydroxy propanoic acid | | |
| 5-Hydroxy-n-valeric acid | | |
| 2,3-Dihydroxybutanoic acid | | |
| 2,3-Dihydroxybutane | | |
| Ethanedioic acid | | |
| Cyclobutanol | | |
| Decanedioic acid | | |
| 6-N,N-Diethylamino-1-hexanal | | |
| diethyl acetal | | |
| Methyl-propanedioic acid | | |
| Propanedioic acid | | |
| Threonic acid | | |
| 2-Hydroxyglutaric acid | | |
| 2-(methoxyimino)-pentanedioic acid | | |
| 2,4-Dihydroxybutanoic acid | | |
| Pentitol | | |
| 3,4,5-Trihydroxypentonic acid | | |
| 2,3,4,5-Tetrahydroxy Ribonic acid | | |
| Mannonic acid, lactone | | |
| 2-Piperidone, 3-amino | | |
| L-Ascorbic acid, 2-O-methyl-3,5,6- | | |
| trihydroxy | | |
| 3,7-Dihydro-1,3-dimethyl-1H- | | |
| Purine-2,6-dione | | |
| Cystine | | |
| Oxypertine | | |
| 2,2′-Dimethoxy-4′,6- | | |
| bis(methylthio)-4,5′-Bipyrimidine | | |
| 1,6-Dihydroxy-3- | | |
| methylanthraquinone | | |
| Hydroxy proline dipeptide | | |

The metabolic profile of the subjects (black dots in FIG. 11) after 2 week wash out showed a recovery trend, but was distinct from that at the pre-dose state, suggesting an incomplete recovery after the washout phase. Disruption of the gut microbial populations by Pu-erh tea could at least partially account for this result, as evidenced by altered metabolites such as 4-methoxyphenylacetic acid, 5-hydroxy-tryptophan, 3,4-dimethylbenzoic acid, 2-ethoxyphenol, and hydrocaffeic acid (see Table 5) associated with gut microbial co-metabolism.

### Example 13

### Correlation of Absorbed, Biodegradated Plant Metabolites and Endogenous Metabolite Markers

Metabolites of interest with high linear relationship were found using the Pearson correlation (|ρ|≧0.7) when pair-wise metabolite vectors were compared at a certain time point, such as absorbed plant metabolites vs. biotransformed metabolites derived from Pu-erh tea, or biotransformed metabolites derived from Pu-erh tea vs. differentially expressed endogenous metabolites, from urine samples at 24 h. Similarly, in order to study the relationship of dynamic response of metabolites along with the time course, mean value of each metabolite was calculated at each time point (0 h→1 h→2 h→3 h→6 h→12 h→24 h). A new metabolite vector with 7 mean values calculated at 7 different time points, representing the average response, was constructed and the Pearson correlation coefficients were calculated similarly with the pair-wise comparison of metabolites.

$${ρ}_{X metabolite , Y metabolite} = \frac{Cov ( {X}_{metabolite} - {Y}_{metabolite} )}{{σ}_{X metablite} \cdot {σ}_{Y metabolite}}$$

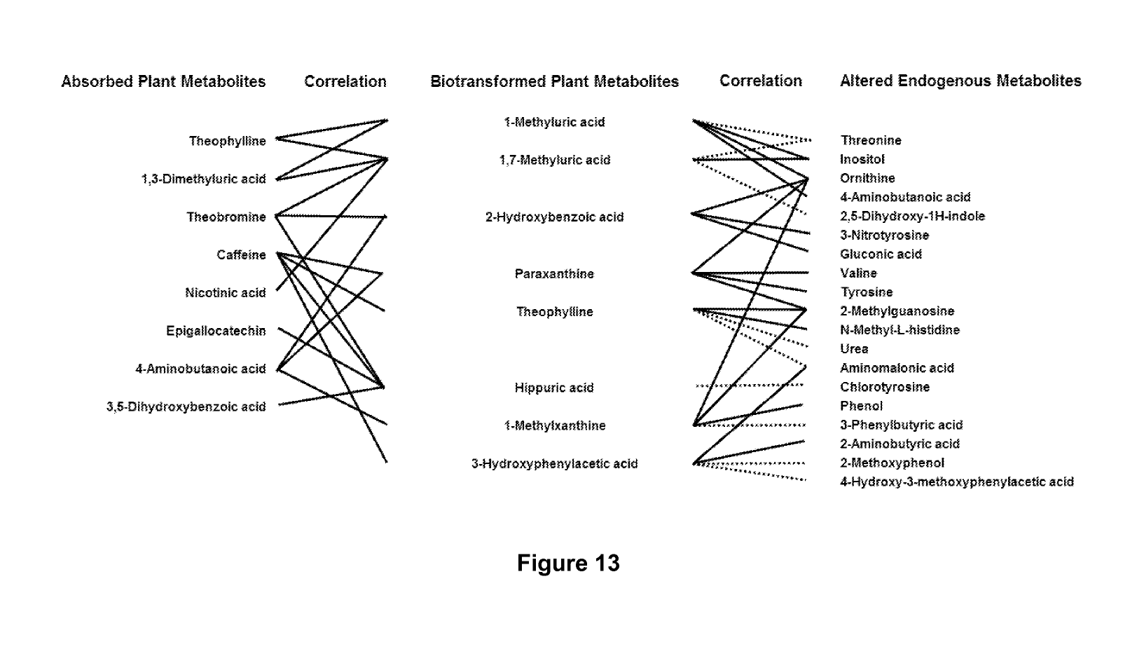

The correlation among the absorbed plant metabolites, metabolites produced through in vivo biotransfoiivation and the altered endogenous metabolites is illustrated in FIG. 13, with positive (solid lines) and negative (dashed lines) (here, ρ≧0.7 or ρ≦−0.7) values. In general, absorbed tea metabolites are positively corrected with their biodegradated products, whereas, the urinary concentration of endogenous metabolites either increased or decreased in response to the alteration of the bioavailable tea metabolites. Caffeine, for example, was positively corrected with its biodegradated metabolites, paraxanthine, theophylline, hippuric acid and 3-hydroxyphenylacetic acid. Paraxanthine was positively corrected with ornithine, valine, tyrosine, and 2-methylguanosine, whereas theophylline was positively corrected with 2-methylguanosine but negatively corrected with urea and aminomalonic acid. The increase in urine concentration of tea metabolite, 3-hydroxyphenylacetic acid, resulted in the elevated level of aminomalonic acid and 2-aminobutyric acid.

### Example 14

### Assessment of Metabolomic Changes (“Pharmacodynamic Endpoints”)

The novel profiling approach of the described invention was employed to address the question of whether or not the measurement of dynamic changes of human metabolic endpoints (metabolomics/PD) and concentrations of plant components and metabolites in biofluids such as blood and urine (PK) can be achieved simultaneously. In the presented Examples, the disclosed invention was used to assess the nutraceutical aspect of Pu-erh tea to show the general utility of the invention.

In the Examples, the Pearson correlation coefficients are used to find the high linear relationships among three groups of absorbed plant metabolites, metabolites produced through in vivo biotransforamtion and altered endogenous metabolites in response to Pu-erh tea exposure.

Without being tied to any particular theory or model, the following observations are made.

In some aspects of the invention, the metabolomic changes can be regarded as a drug response profile consisting of “pharmacodynamic” endpoints, which can be used to evaluate the pharmacological or beneficial effects of a specific dietary or botanical drug intervention. The time-dependent changes of 10 representative substances (Table 1), absorbed and biotransformed plant metabolites were shown in FIG. 10. For example, as shown in FIGS. 10 and 11, in one aspect of the invention, the established relationships among absorbed Pu-erh tea components, biotransformed tea components and altered endogenous metabolites were supported by published literatures.

In one aspect, for example, increased nicotinic acid levels in the urine after Pu-erh tea intake may be responsible for the cholesterol reducing and the lipid-lowering effects of Pu-erh tea, as reported in the literature.[102, 108] In another aspect, for example, 3-chlorotyrosine may reflect myeloperoxidase-catalyzed oxidation, and the depleted concentration of the biometabolite in urine may be associated with a low plasma concentration of low-density lipoprotein and triglyceride. [102]

One of the tea components, caffeine, is metabolized in the liver by the cytochrome P450 oxidase enzyme system (specifically, the 1A2 isozyme) into 3 metabolic dimethylxanthines: paraxanthine, theobromine, and theophylline. [109] Theobromine and theophylline are then metabolized in liver into 1,7-methyluric acid and 1-methylxanthine and subsequently into 1-methyluric acid. These tea metabolites were found in urine samples as both Pu-erh tea metabolites and biotransformed metabolites.

In one aspect of the invention, flavonoids and hydroxycinnamic acids, which are polyphenolic compounds present in the diet of subject from plants and vegetables, as well as in herbal remedies used in herbal medicine, may be involved in a metabolomic change.[107] The putative quercetin metabolites, hydroxyphenylacetic acid and 4-hydroxy-3-methoxyphenylacetic acid (homovanillic acid), were detected in urine. Hippuric acid and hydroxyhippuric acid, the glycine conjugate of benzoic acid, were also detected in urine samples, which supports the previous findings that these metabolites are involved in a central metabolic pathway for dietary flavonoids. [110, 111] Hippuric acid may originate, in part, from the catechins and their condensed polymers such as theaflavins and thearubigins, which are an important group of phenols in tea.[112] Catechins and their condensed polymers are metabolized into valerolactones and then to phenylpropionic acids by gut microbes, which are further metabolized to benzoic acids and excreted in urine as hippuric acid.[113]

The application of the methods of the described invention to the administration of Pu-erh tea substantially advances understanding of the pharmacokinetics of this multi-component nutraceutical, as well as of the dynamic response of the human metabolic system.[107] The characterization of hepatic and gut microbial biodegradation of plant components as well as the plant-induced alterations in metabolites of symbiotic gut microbes in this study advances the mechanistic understanding of and biomarker discovery for multi-component botanical agents. The overwhelming amount of metabolic endpoints, including changes in metabolic regulatory pathways and gut microbial-mammalian co-metabolism, can be integrated as a systems response to the absorption, disposition and drug-drug interactions of the botanical intervention system. The integrated approach with the utilization of multivariate statistical tools, as demonstrated by the preceding Examples, simultaneously visualize the inter-correlation between compounds originating from different sources and the metabolic impact of a botanical/drug intervention, which has never before been accessible to the pharmaceutical and nutraceutical industries.

The present invention has been described generally and with an emphasis on particular embodiments. It should be apparent to those of ordinary skill in the art that modifications can be made to the above disclosure and still fit within the scope and spirit of the invention. It is intended, contemplated, and therefore within the scope of the invention to combine any of the plurality of different elements in each of the embodiments in the above disclosure with any other embodiment. The invention is not to be limited by the disclosure above but rather is defined by the claims below.

### Systems

Aspects of the present invention provide systems for carrying out the analysis of the invention. Thus, an aspect of the present invention comprises a computer-readable medium on which is encoded programming code for the statistical methods described herein. Also, aspects of present invention may comprise a system comprising a processor in communication with a computer-readable medium, the processor configured to perform the statistical methods described herein. In some aspects of the invention, the system may comprise an apparatus for chromatographic and/or spectrometric analysis of chemical compounds. In some aspects of the invention, the system may be configured to receive data input from an apparatus for chromatographic and/or spectrometric analysis of chemical compounds. Suitable processors and computer-readable media for various embodiments of the present invention are described in greater detail below.

The system may comprise a data compiling system as well as a means for the user to interact with the system as the analysis proceeds. Thus, in certain aspects, the present invention may comprise a system for collecting and/or compiling data from a plurality of assay measurements and/or sequencing data and transmitting the data to a computer, and a system for transmitting the results of the analysis to a user. The systems of the present invention may be designed for high-throughput analysis of small molecule metabolites. Thus, in an embodiment, the plurality of measured signals comprise a plurality of compounds isolated from a subject sample before and/or after administration of a multi-component therapeutic, or compounds isolated from the multi-component therapeutic.

Thus, in certain aspects, the invention comprises (a) a part for determining a component profile for the multi-component therapeutic, a pre-administration metabolome in a subject sample before administration of the multi-component therapeutic, and a post-administration metabolome in a subject sample after administration of the multi-component therapeutic; (b) a part for comparing the component profile for the multi-component therapeutic, the pre-administration metabolome in a subject sample before administration of the multi-component therapeutic, and the post-administration metabolome in a subject sample after administration of the multi-component therapeutic; wherein comparison of results in identification of absorbed components, the altered endogenous metabolites and the metabolized and/or biotransformed components; and (c) a part for analyzing correlations between the absorbed components, the altered endogenous metabolites and the metabolized and/or biotransformed components, wherein correlations between the absorbed components, the metabolized and/or biotransformed components and the altered endogenous components are used to characterize the biochemical changes in the subject in response to active ingredients in the multi-component therapeutic.

For certain aspects of the systems and computer readable media of the invention, the subject may be exposed to a multi-component therapeutic (e.g., an herbal medicine, nutraceutical, multi-drug cocktail) that can effect biochemical changes in the subject.

For certain aspects of the systems and computer readable media of the invention, one or more statistical methods may be employed.

Aspects of the present subject matter can be implemented in digital electronic circuitry, in computer hardware, firmware, software, or in combinations of the preceding. In one embodiment, a computer may comprise a processor or processors. The processor may comprise, or have access to, a computer-readable medium, such as a random access memory coupled to the processor. The processor may execute computer-executable program instructions stored in memory, such as executing one or more computer programs including a sampling routine, a statistical routine, and suitable programming to produce output to generate the analysis described in detail herein.

Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example tangible computer-readable media that may store instructions that when executed by the processor, can cause the processor to perform the steps described herein as carried out, or assisted, by a processor. Aspects of computer-readable media may comprise, but are not limited to, all electronic, optical, magnetic, or other storage devices capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other devices may include computer-readable media, such as a router, private or public network, or other transmission device. The processor, and the processing may be in one or more structures, and may be dispersed through one or more structures. The processor may comprise code for carrying out one or more of the methods (or parts of methods) described herein.

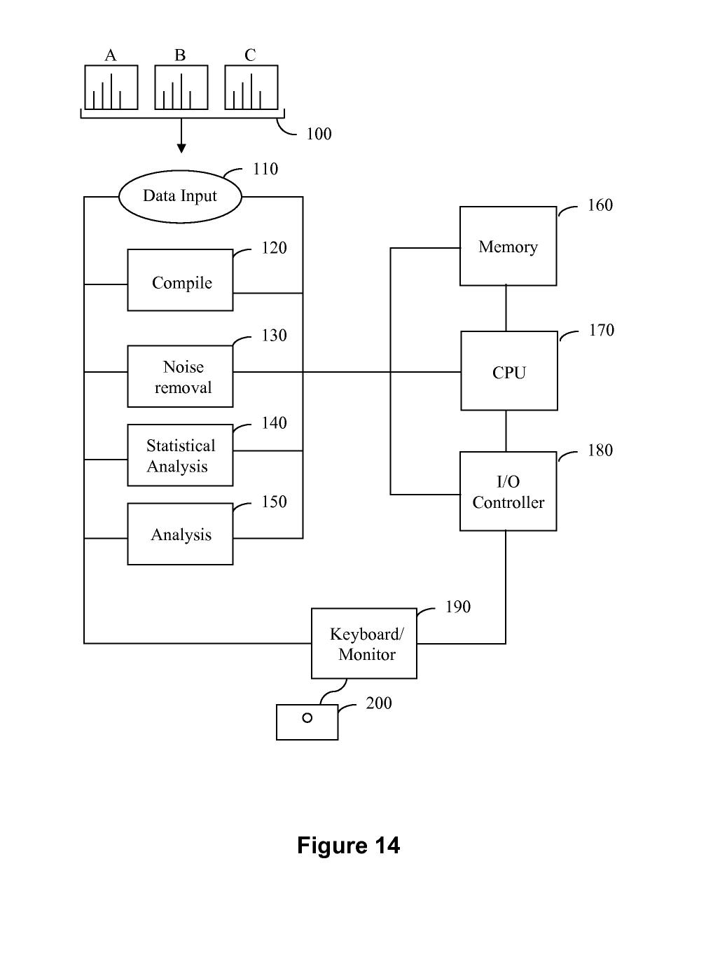

FIG. 14 shows aspects of the flow of information in a system comprising the software of the present invention. As discussed above, a computer processor or CPU may include, for example, digital logic processors capable of processing input, executing algorithms, and generating output as necessary in response to the inputs received from the touch-sensitive input device. As detailed herein, such processors may include a microprocessor, such as an ASIC, and state machines, and/or other components. Such processors include, or may be in communication with, media, for example computer-readable media, which stores instructions that, when executed by the processor, cause the processor to perform the steps described herein.

Thus, in an embodiment, the starting point may comprise data (100) generated from chromatographic and/or spectrometric analysis of a plurality of compounds isolated from a subject sample before and/or after administration of a multi-component therapeutic, or compounds isolated from the multi-component therapeutic. For example, in some aspects, the data comprises chromatographic and/or spectrometric data. The data (100) may also comprise data of known compounds [100C] obtained from publicly-accessible databases. Once the data has been collected (110), it may be compiled (120) and/or transformed if necessary using any standard spreadsheet software such as Microsoft Excel, FoxPro, Lotus, or the like. In an embodiment, the data are entered into the system for each experiment. Alternatively, data from previous runs are stored in the computer memory (160) and used as required. In certain aspects, data of known compounds [100C] is stored in the computer memory (160) and used as required. Alternatively, in certain aspects, the system of the invention may be configured to interact with external systems storing the publicly-accessible databases of data of known compounds (100C).

At each point in the analysis, the user may input instructions via a keyboard (190), floppy disk, remote access (e.g., via the internet) (200), or other access means. The user may enter instructions including options for the run, how reports should be printed out, and the like. In aspects of the invention, the user may enter instructions regarding the nature of the data (100) being inputted, the type of statistical analysis or analyses to be performed, and/or the type of publicly-accessible databases of data of known compounds (100C) to access. Also, at each step in the analysis, the data may be stored in the computer using a storage device common in the art such as disks, drives or memory (160). As is understood in the art, the processor (170) and I/O controller (180) are required for multiple aspects of computer function. Also, in aspect, there may be more than one processor.

The data may also be processed to remove noise (130). In some cases, the user, via the keyboard (190), floppy disk, or remote access (200), may want to input variables or constraints for the analysis, as for example, the threshold for determining noise.

In the next step, generalized ridge regression analysis is performed as described herein (140). The results of the analysis may then be compiled and provided in a form for review by a user (150).

### REFERENCES

[1] Chan K. Progress in traditional Chinese medicine. Trends Pharmacol Sci. 1995; 16(6):182-7.
[2] Williamson E M. Synergy and other interactions in phytomedicines. Phytomedicine. 2001; 8(5):401-9.
[3] Wald D S, Law M, Morris J K, Bestwick J P, Wald N J. Combination therapy versus monotherapy in reducing blood pressure: meta-analysis on 11,000 participants from 42 trials. Am J. Med. 2009; 122(3):290-300.
[4] Lipscombe L L, Gomes T, Levesque L E, Hux J E, Juurlink D N, Alter D A. Thiazolidinediones and cardiovascular outcomes in older patients with diabetes. JAMA. 2007; 298(22):2634-43.
[5] Tariot P N, Farlow M R, Grossberg G T, Graham S M, McDonald S, Gergel I. Memantine treatment in patients with moderate to severe Alzheimer disease already receiving donepezil: a randomized controlled trial. JAMA. 2004; 291(3):317-24.
[6] Greenspan S L, Resnick N M, Parker R A. Combination therapy with hormone replacement and alendronate for prevention of bone loss in elderly women: a randomized controlled trial. JAMA. 2003; 289(19):2525-33.
[7] Geyer C E, Forster J, Lindquist D, Chan S, Romieu C G, Pienkowski T, et al. Lapatinib plus capecitabine for HER2-positive advanced breast cancer. N Engl J. Med. 2006; 355(26):2733-43.
[8] Xue T, Roy R. Studying traditional Chinese medicine. Science. 2003; 300(5620):740-1.
[9] Fiehn O, Kopka J, Dormann P, Altmann T, Trethewey R N, Willmitzer L. Metabolite profiling for plant functional genomics. Nat. Biotechnol. 2000; 18(11):1157-61.
[10] Goodacre R, Vaidyanathan S, Dunn W B, Harrigan G G, Kell D B. Metabolomics by numbers: acquiring and understanding global metabolite data. Trends Biotechnol. 2004; 22(5):245-52.
[11] Mitchell S, Holmes E, Carmichael P. Metabonomics and medicine: the Biochemical Oracle. Biologist (London). 2002; 49(5):217-21.
[12] Nicholson J K, Lindon J C. Systems biology: Metabonomics. Nature. 2008; 455(7216):1054-6.
[13] Wang M, Lamers R J, Korthout H A, van Nesselrooij J H, Witkamp R F, van der Heijden R, et al. Metabolomics in the context of systems biology: bridging traditional Chinese medicine and molecular pharmacology. Phytother Res. 2005; 19(3):173-82.
[14] Qiu J. ‘Back to the future’ for Chinese herbal medicines. Nat Rev Drug Discov. 2007; 6(7):506-7.
[15] Zhao X, Zhang Y, Meng X, Yin P, Deng C, Chen J, et al. Effect of a traditional Chinese medicine preparation Xindi soft capsule on rat model of acute blood stasis: A urinary metabonomics study based on liquid chromatography-mass spectrometry. J Chromatogr B Analyt Technol Biomed Life Sci. 2008; 873(2):151-8.
[16] Wang X, Lv H, Sun H, Liu L, Yang B, Sun W, et al. Metabolic urinary profiling of alcohol hepatotoxicity and intervention effects of Yin Chen Hao Tang in rats using ultra-performance liquid chromatography/electrospray ionization quadruple time-of-flight mass spectrometry. J Pharm Biomed Anal. 2008.
[17] Wang X, Su M, Qiu Y, Ni Y, Zhao T, Zhou M, et al. Metabolic regulatory network alterations in response to acute cold stress and ginsenoside intervention. J Proteome Res. 2007; 6(9):3449-55.
[18] Chen M, Ni Y, Duan H, Qiu Y, Guo C, Jiao Y, et al. Mass spectrometry-based metabolic profiling of rat urine associated with general toxicity induced by the multiglycoside of Tripterygium wilfordii Hook. f. Chem Res Toxicol. 2008; 21(2):288-94.
[19] Sun B, Wu S, Li L, Li H, Zhang Q, Chen H, et al. A metabolomic analysis of the toxicity of Aconitum sp. alkaloids in rats using gas chromatography/mass spectrometry. Rapid Commun Mass Spectrom. 2009; 23(8):1221-8.
[20] Chen C, Gonzalez F J, Idle J R. LC-MS-based metabolomics in drug metabolism. Drug Metab Rev. 2007; 39(2-3):581-97.
[21] Li M, Wang B, Zhang M, Rantalainen M, Wang S, Zhou H, et al. Symbiotic gut microbes modulate human metabolic phenotypes. Proc Natl Acad Sci USA. 2008; 105(6):2117-22.
[22] Wikoff W R, Anfora A T, Liu J, Schultz P G, Lesley S A, Peters E C, et al. Metabolomics analysis reveals large effects of gut microflora on mammalian blood metabolites. Proc Natl Acad Sci USA. 2009; 106(10):3698-703.
[23] Plumb R S, Stumpf C L, Granger J H, Castro-Perez J, Haselden J N, Dear G J. Use of liquid chromatography/time-of-flight mass spectrometry and multivariate statistical analysis shows promise for the detection of drug metabolites in biological fluids. Rapid Commun Mass Spectrom. 2003; 17(23):2632-8.
[24] Chen C, Meng L, Ma X, Krausz K W, Pommier Y, Idle J R, et al. Urinary metabolite profiling reveals CYP1A2-mediated metabolism of NSC686288 (aminoflavone). J Pharmacol Exp Ther. 2006; 318(3):1330-42.
[25] Giri 5, Idle J R, Chen C, Zabriskie T M, Krausz K W, Gonzalez F J. A metabolomic approach to the metabolism of the areca nut alkaloids arecoline and arecaidine in the mouse. Chem Res Toxicol. 2006; 19(6):818-27.
[26] Giri S, Krausz K W, Idle J R, Gonzalez F J. The metabolomics of (+/−)-arecoline 1-oxide in the mouse and its formation by human flavin-containing monooxygenases. Biochem Pharmacol. 2007; 73(4):561-73.
[27] Chen C, Ma X, Malfatti M A, Krausz K W, Kimura S, Felton J S, et al. A comprehensive investigation of 2-amino-1-methyl-6-phenylimidazo[4,5-b]pyridine (PhIP) metabolism in the mouse using a multivariate data analysis approach. Chem Res Toxicol. 2007; 20(3):531-42.
[28] Zhen Y, Slanar O, Krausz K W, Chen C, Slavik J, McPhail K L, et al. 3,4-Dehydrodebrisoquine, a novel debrisoquine metabolite formed from 4-hydroxydebrisoquine that affects the CYP2D6 metabolic ratio. Drug Metab Dispos. 2006; 34(9):1563-74.
[29] Chen C, Krausz K W, Idle J R, Gonzalez F J. Identification of novel toxicity-associated metabolites by metabolomics and mass isotopomer analysis of acetaminophen metabolism in wild-type and Cyp2e1-null mice. J Biol. Chem. 2008; 283(8):4543-59.
[30] Fardet A, Llorach R, Orsoni A, Martin J F, Pujos-Guillot E, Lapierre C, et al. Metabolomics provide new insight on the metabolism of dietary phytochemicals in rats. J. Nutr. 2008; 138(7):1282-7.
[31] Cho J Y, Kang D W, Ma X, Ahn S H, Krausz K W, Luecke H, et al. Metabolomics reveals a novel vitamin E metabolite and attenuated vitamin E metabolism upon PXR activation. J Lipid Res. 2009; 50(5):924-37.
[32] Liu A, Chen Y, Yang Z, Feng Y, Rui W, Luo W, et al. New metabolites of fenofibrate in Sprague-Dawley rats by UPLC-ESI-QTOF-MS-based metabolomics coupled with LC-MS/MS. Xenobiotica. 2009; 39(4):345-54.
[33] Liu A, Patterson A D, Yang Z, Zhang X, Liu W, Qiu F, et al. Fenofibrate metabolism in the cynomolgus monkey using ultraperformance liquid chromatography-quadrupole time-of-flight mass spectrometry-based metabolomics. Drug Metab Dispos. 2009; 37(6):1157-63.
[34] Sun J, Von Tungeln L S, Hines W, Beger R D. Identification of metabolite profiles of the catechol-O-methyl transferase inhibitor tolcapone in rat urine using LC/MS-based metabonomics analysis. J Chromatogr B Analyt Technol Biomed Life Sci. 2009; 877(24):2557-65.
[35] Sun J, Schnackenberg L K, Beger R D. Studies of acetaminophen and metabolites in urine and their correlations with toxicity using metabolomics. Drug Metab Lett. 2009; 3(3):130-6.
[36] Croixmarie V, Umbdenstock T, Cloarec O, Moreau A, Pascussi J M, Boursier-Neyret C, et al. Integrated Comparison of Drug-Related and Drug-Induced Ultra Performance Liquid Chromatography/Mass Spectrometry Metabonomic Profiles Using Human Hepatocyte Cultures. Anal Chem. 2009; 81(15):6061-9.
[37] Wiklund S, Johansson E, Sjostrom L, Mellerowicz E J, Edlund U, Shockcor J P, et al. Visualization of GC/TOF-MS-based metabolomics data for identification of biochemically interesting compounds using OPLS class models. Anal Chem. 2008; 80(1):115-22.
[38] Llorach-Asuncion R, Jauregui O, Urpi-Sarda M, Andres-Lacueva C. Methodological aspects for metabolome visualization and characterization: a metabolomic evaluation of the 24 h evolution of human urine after cocoa powder consumption. J Pharm Biomed Anal. 51(2):373-81.
[39] van Velzen E J, Westerhuis J A, van Duynhoven J P, van Dorsten F A, Hoefsloot H C, Jacobs D M, et al. Multilevel data analysis of a crossover designed human nutritional intervention study. J Proteome Res. 2008; 7(10):4483-91.
[40] van Velzen E J, Westerhuis J A, van Duynhoven J P, van Dorsten F A, Grun C H, Jacobs D M, et al. Phenotyping Tea Consumers by Nutrikinetic Analysis of Polyphenolic End-Metabolites. J Proteome Res. 2009; 8(7):3317-30.
[41] Nicholson J K, Lindon J C, Holmes E. ‘Metabonomics’: understanding the metabolic responses of living systems to pathophysiological stimuli via multivariate statistical analysis of biological NMR spectroscopic data. Xenobiotica. 1999; 29(11):1181-9.
[42] Sansone S A, Fan T, Goodacre R, Griffin J L, Hardy N R, Kaddurah-Daouk R, et al. The metabolomics standards initiative. Nat. Biotechnol. 2007; 25(8):846-8.
[43] Sumner L W, Amberg A, Barrett D, Beale M H, Beger R, Daykin C A, et al. Proposed minimum reporting standards for chemical analysis. Metabolomics. 2007; 3(3):211-21.
[44] Want E J, O'Maille G, Smith C A, Brandon T R, Uritboonthai W, Qin C, et al. Solvent-dependent metabolite distribution, clustering, and protein extraction for serum profiling with mass spectrometry. Anal Chem. 2006; 78(3):743-52.
[45] Sangster T, Major H, Plumb R, Wilson A J, Wilson I D. A pragmatic and readily implemented quality control strategy for HPLC-MS and GC-MS-based metabonomic analysis. Analyst. 2006; 131(10):1075-8.
[46] O'Hagan S, Dunn W B, Knowles J D, Broadhurst D, Williams R, Ashworth J J, et al. Closed-loop, multiobjective optimization of two-dimensional gas chromatography/mass spectrometry for serum metabolomics. Anal Chem. 2007; 79(2):464-76.
[47] Gika H G, Theodoridis G A, Wingate J E, Wilson I D. Within-day reproducibility of an HPLC-MS-based method for metabonomic analysis: application to human urine. J Proteome Res. 2007; 6(8):3291-303.
[48] Bruce S J, Jonsson P, Antti H, Cloarec 0, Trygg J, Marklund S L, et al. Evaluation of a protocol for metabolic profiling studies on human blood plasma by combined ultra-performance liquid chromatography/mass spectrometry: From extraction to data analysis. Anal Biochem. 2008; 372(2):237-49.
[49] Gika H G, Macpherson E, Theodoridis G A, Wilson I D. Evaluation of the repeatability of ultra-performance liquid chromatography-TOF-MS for global metabolic profiling of human urine samples. J Chromatogr B Analyt Technol Biomed Life Sci. 2008; 871(2):299-305.
[50] Zelena E, Dunn W B, Broadhurst D, Francis-McIntyre S, Carroll K M, Begley P, et al. Development of a robust and repeatable UPLC-MS method for the long-term metabolomic study of human serum. Anal Chem. 2009; 81(4):1357-64.
[51] Bruce S J, Tavazzi I, Parisod V, Rezzi S, Kochhar S, Guy P A. Investigation of human blood plasma sample preparation for performing metabolomics using ultrahigh performance liquid chromatography/mass spectrometry. Anal Chem. 2009; 81(9):3285-96.
[52] Michopoulos F, Lai L, Gika H, Theodoridis G, Wilson I. UPLC-MS-based analysis of human plasma for metabonomics using solvent precipitation or solid phase extraction. J Proteome Res. 2009; 8(4):2114-21.
[53] Katajamaa M, Oresic M. Data processing for mass spectrometry-based metabolomics. J Chromatogr A. 2007; 1158(1-2):318-28.
[54] Schlotterbeck G, Ross A, Dieterle F, Senn H. Metabolic profiling technologies for biomarker discovery in biomedicine and drug development. Pharmacogenomics. 2006; 7(7):1055-75.
[55] Sumner L W, Urbanczyk-Wochniak E, Broeckling C D. Metabolomics data analysis, visualization, and integration. Methods Mol Biol. 2007; 406:409-36.
[56] Aberg K M, Alm E, Torgrip R J. The correspondence problem for metabonomics datasets. Anal Bioanal Chem. 2009; 394(1):151-62.
[57] Xie G, Ye M, Wang Y, Ni Y, Su M, Huang H, et al. Characterization of pu-erh tea using chemical and metabolic profiling approaches. J Agric Food Chem. 2009; 57(8):3046-54.
[58] Hall R, Beale M, Fiehn 0, Hardy N, Sumner L, Bino R. Plant metabolomics: the missing link in functional genomics strategies. Plant Cell. 2002; 14(7):1437-40.
[59] Schauer N, Femie A R. Plant metabolomics: towards biological function and mechanism. Trends Plant Sci. 2006; 11(10):508-16.
[60] Wang Y, Tang H, Nicholson J K, Hylands P J, Sampson J, Whitcombe I, et al. Metabolomic strategy for the classification and quality control of phytomedicine: a case study of chamomile flower (Matricaria recutita L.). Planta Med. 2004; 70(3):250-5.
[61] Chan E C, Yap S L, Lau A J, Leow P C, Toh D F, Koh H L. Ultra-performance liquid chromatography/time-of-flight mass spectrometry based metabolomics of raw and steamed Panax notoginseng. Rapid Commun Mass Spectrom. 2007; 21(4):519-28.
[62] Li W, Deng Y, Dai R, Yu Y, Saeed M K, Li L, et al. Chromatographic fingerprint analysis of Cephalotaxus sinensis from various sources by high-performance liquid chromatography-diodearray detection-electrospray ionization-tandem mass spectrometry. J Pharm Biomed Anal. 2007; 45(1):38-46.
[63] Xie G, Plumb R, Su M, Xu Z, Zhao A, Qiu M, et al. Ultra-performance LC/TOF MS analysis of medicinal Panax herbs for metabolomic research. J Sep Sci. 2008; 31(6-7):1015-26.
[64] Ma C, Wang H, Lu X, Xu G, Liu B. Metabolic fingerprinting investigation of Artemisia annua L. in different stages of development by gas chromatography and gas chromatography-mass spectrometry. J Chromatogr A. 2008; 1186(1-2):412-9.
[65] Clayton T A, Lindon J C, Cloarec O, Antti H, Charuel C, Hanton G, et al. Pharmaco-metabonomic phenotyping and personalized drug treatment. Nature. 2006; 440(7087):1073-7.
[66] Li H, Zhou M, Zhao A, Jia W. Traditional Chinese medicine: balancing the gut ecosystem. Phytother Res. 2009; 23(9):1332-5.
[67] Nicholson J K, Wilson I D. Opinion: understanding ‘global’ systems biology: metabonomics and the continuum of metabolism. Nat Rev Drug Discov. 2003; 2(8):668-76.
[68] Nicholson J K, Holmes E, Lindon J C, Wilson I D. The challenges of modeling mammalian biocomplexity. Nat. Biotechnol. 2004; 22(10):1268-74.
[69] Rezzi S, Ramadan Z, Fay L B, Kochhar S, Nutritional metabonomics: applications and perspectives. J Proteome Res. 2007; 6(2):513-25.
[70] Stella C, Beckwith-Hall B, Cloarec O, Holmes E, Lindon J C, Powell J, et al. Susceptibility of human metabolic phenotypes to dietary modulation. J Proteome Res. 2006; 5(10):2780-8.
[71] Maher A D, Zirah S F, Holmes E, Nicholson J K. Experimental and analytical variation in human urine in ¹H NMR spectroscopy-based metabolic phenotyping studies. Anal Chem. 2007; 79(14):5204-11.
[72] Jansen J J, Hoefsloot H C, Van der Greef J, Timmerman M E, Westerhuis J A, Smilde A K. ASCA: analysis of multivariate data obtained from an experimental design. J Chemom. 2005; 19(9):469-81.
[73] Smilde Ak., Jansen J J, Hoefsloot H C, Lamers R J, van der Greef J, Timmerman M E. ANOVA-simultaneous component analysis (ASCA): a new tool for analyzing designed metabolomics data. Bioinformatics. 2005; 21(13):3043-8.
[74] V is DJ, Westerhuis J A, Smilde A K, van der Greef J. Statistical validation of megavariate effects in ASCA. BMC Bioinformatics. 2007; 8:322.
[75] Lenz E M, Wilson I D. Analytical strategies in metabonomics. J Proteome Res. 2007; 6(2):443-58.
[76] Dettmer K, Aronov P A, Hammock B D. Mass spectrometry-based metabolomics. Mass Spectrom Rev. 2007; 26(1):51-78.
[77] Theodoridis G, Gika H G, Wilson I D. LC-MS-based methodology for global metabolite profiling in metabonomics/metabolomics. TRAC Trends Anal Chem. 2008; 27(3):251-60.
[78] Ni Y, Su M, Qiu Y, Chen M, Liu Y, Zhao A, et al. Metabolic profiling using combined GC-MS and LC-MS provides a systems understanding of aristolochic acid-induced nephrotoxicity in rat. FEBS Lett. 2007; 581(4):707-11.
[79] Qiu Y, Cai G, Su M, Chen T, Zheng X, Xu Y, et al. Serum metabolite profiling of human colorectal cancer using GC-TOFMS and UPLC-QTOFMS. J Proteome Res. 2009; 8(10):4844-50.
[80] Mihailova A, Malerod H, Wilson S R, Karaszewski B, Hauser R, Lundanes E, et al. Improving the resolution of neuropeptides in rat brain with on-line HILIC-RP compared to on-line SCX-RP. J Sep Sci. 2008; 31(3):459-67.
[81] van den Berg R A, Hoefsloot H C, Westerhuis J A, Smilde A K, van der Werf M J. Centering, scaling, and transformations: improving the biological information content of metabolomics data. BMC Genomics. 2006; 7:142.
[82] Smit S, van Breemen M J, Hoefsloot H C, Smilde A K, Aerts J M, de Koster C G. Assessing the statistical validity of proteomics based biomarkers. Anal Chim Acta. 2007; 592(2):210-7.
[83] Breitling R, Armengaud P, Amtmann A, Herzyk P. Rank products: a simple, yet powerful, new method to detect differentially regulated genes in replicated microarray experiments. FEBS Lett. 2004; 573(1-3):83-92.
[84] Chan E C, Koh P K, Mal M, Cheah P Y, Eu K W, Backshall A, et al. Metabolic profiling of human colorectal cancer using high-resolution magic angle spinning nuclear magnetic resonance (HR-MAS NMR) spectroscopy and gas chromatography mass spectrometry (GC/MS). J Proteome Res. 2009; 8(1):352-61.
[85] Wishart D S, Tzur D, Knox C, Eisner R, Guo A C, Young N, et al. HMDB: the Human
Metabolome Database. Nucleic Acids Res. 2007; 35(Database issue):D521-6.
[86] Smith C A, O'Maille G, Want E J, Qin C, Trauger S A, Brandon T R, et al. METLIN: a metabolite mass spectral database. Ther Drug Monit. 2005; 27(6):747-51.
[87] Tohge T, Fernie A R. Web-based resources for mass-spectrometry-based metabolomics: a user's guide. Pthytochemistry. 2009; 70(4):450-6.
[88] Blaylock, R. L. New Developments in Phytoprevention and Treatment of Cancer. The Journal of the American Nutraceutical Association 2, 19-29 (1999).
[89] Hollander, J. M. & Mechanick, J. I. Complementary and alternative medicine and the management of the metabolic syndrome. J. Am. Diet. Assoc. 108, 495-509 (2008).
[90] Chan, K. Progress in traditional Chinese medicine. Trends Pharmacol Sci 16, 182-187 (1995).
[91] Plumb, G W. et al. Metabolism of chlorogenic acid by human plasma, liver, intestine and gut microflora. Journal of the Science of Food and Agriculture 79, 390-392 (1999).
[92] Wang, Y. et al. A metabonomic strategy for the detection of the metabolic effects of chamomile (Matricaria recutita L.) ingestion. J Agric Food Chem. 53, 191-196 (2005).
[93] Wu, S. C. et al. Antimutagenic and antimicrobial activities of pu-erh tea. LWT-Food Sci. Technol. 40, 506-512 (2007).
[94] Wang, B. S., Yu, H. M., Chang, L. W., Yen, W. J. & Duh, P. D. Protective effects of pu-erh tea on LDL oxidation and nitric oxide generation in macrophage cells. LWT-Food Sci. Technol. 41, 1122-1132 (2008).
[95] Ni, Y. et al. Metabolic profiling reveals disorder of amino acid metabolism in four brain regions from a rat model of chronic unpredictable mild stress. Febs Letters 582, 2627-2636 (2008).
[96] Chen, X. Q., Ye, Y., Cheng, H., Yin, J. F. & Sun, C. Comparative analysis of theanine, caffeine and polyphenolic constituents in green tea, black tea and puer tea. Food Res. Devel., 141-144 (2007).
[97] Lan, K. & Jia, W. An integrated metabolomic and pharmacokinetics strategy for multi-component drugs evaluation. Curr Drug Metabol 11, 105-114 (2010).
[98] Zhang, W. D. et al. Determination of free and glucuronidated kaempferol in rat plasma by LC-MS/MS: Application to pharmacokinetic study. Journal of Chromatography B-Analytical Technologies in the Biomedical and Life Sciences 878, 2137-2140 (2010).
[99] Ma, Y. M. & Sun, R. Y. 2nd Peak of Plasma Diazepam Concentration and Enterogastric Circulation. Acta Pharmacologica Sinica 14, 218-221 (1993).
[100] Xing, J., Chen, X. Y. & Zhong, D. F. Absorption and enterohepatic circulation of baicalin in rats. Life Sciences 78, 140-146 (2005).
[101] Jansson, J. et al. Metabolomics Reveals Metabolic Biomarkers of Crohn's Disease. Plos One 4 (2009).
[102] Lin, J. K. & Lin-Shiau, S. Y. Mechanisms of hypolipidemic and anti-obesity effects of tea and tea polyphenols. Molecular Nutrition & Food Research 50, 211-217 (2006).
[103] Wu, W. & Wu, W. A study on the dose-effect relationship of the reducing blood lipid effect of polysaccharide of puer tea. Tea Fujian 2, 42-43 (2006).
[104] Chosa, H., Toda, M., Okubo, S., Hara, Y. & Shimamura, T. Antimicrobial and microbicidal activities of tea and catechins against Mycoplasma. Kansenshogaku zasshi. 66, 606-611 (1992).
[105] Horiuchi, Y., Toda, M., Okubo, S., Hara, Y. & Shimamura, T. Protective activity of tea and catechins against Bordetella pertussis. Jpn. J. Infect. Dis. 66, 599-605 (1992).
[106] McCord, T. J. et al. Synthesis and Microbiological Activities of Some Monohalogenated Analogs of Tyrosine. Journal of Medicinal Chemistry 18, 26-29 (1975).
[107] Graefe, E. U. & Veit, M. Urinary metabolites of flavonoids and hydroxycinnamic acids in humans after application of a crude extract from Equisetum arvense. Phytomedicine 6, 239-246 (1999).
[108] Hou, Y. et al. Pu-erh tea aqueous extracts lower atherosclerotic risk factors in a rat hyperlipidemia model. Experimental Gerontology 44, 434-439 (2009).
[109] Carrillo, J. A. et al. Evaluation of caffeine as an in vivo probe for CYP1A2 using measurements in plasma, saliva, and urine. Therapeutic Drug Monitoring 22, 409-417 (2000).
[110] Clifford, M. N., Copeland, E. L., Bloxsidge, J. P. & Mitchell, L. A. Hippuric acid as a major excretion product associated with black tea consumption. Xenobiotica 30, 317-326 (2000).
[111] Scheline, R. R. Metabolism of oxygen heterocyclic compounds. (CRC Press, Inc, Boca Raton. Fla.; 1999).
[112] Balentine, D. A., Wiseman, S. A. & Bouwens, L. C. M. The chemistry of tea flavonoids. Critical Reviews in Food Science and Nutrition 37, 693-704 (1997).
[113] Das, N. P. Studies on Flavonoid Metabolism—Absorption and Metabolism of (+)-Catechin in Man. Biochemical Pharmacology 20, 3435-& (1971).
[114] Jonsson, P. et al. A strategy for identifying differences in large series of metabolomic samples analyzed by GC/MS. Anal Chem 76, 1738-1745 (2004).
[115] Jonsson, P. et al. High-throughput data analysis for detecting and identifying differences between samples in GC/MS-based metabolomic analyses. Anal Chem 77, 5635-5642 (2005). [106] Chinese Society of Japan, Pu Tea Standards, available at http://www.china-tea.org/Html/200511915489-1.html.

1. A method of identifying biochemical changes in a subject in response to administration of a multi-component therapeutic and one or more active ingredients in the multi-component therapeutic comprising:
(a) determining a component profile for the multi-component therapeutic,
(b) determining a pre-administration metabolome in a subject sample before administration of the multi-component therapeutic;
(c) determining a post-administration metabolome in a subject sample after administration of the multi-component therapeutic;
(d) comparing the component profile for the multi-component therapeutic to the subject's post-administration metabolome, wherein shared components are absorbed components from the multi-component therapeutic by the subject;
(e) comparing the subject's pre-administration metabolome to the subject's post-administration metabolome, wherein shared components are altered endogenous components that are differentially expressed by administration of the multi-component therapeutic;
wherein components in the subject's post-administration metabolome that are not absorbed components or altered endogenous components are metabolized and/or biotransformed components; and
wherein the absorbed components, metabolized and/or biotransformed components and the altered endogenous components are used to characterize the biochemical changes in the subject in response to active ingredients in the multi-component therapeutic

2. The method of claim 1, wherein the altered endogenous components and the metabolized and/or biotransformed components comprise biochemical changes in the subject in response to administration of the multi-component therapeutic, and the absorbed components comprise components in the multi-component therapeutic that are involved in the biochemical changes in the subject in response to administration of the multi-component therapeutic.

3-5. (canceled)

6. The method of claim 1, wherein the sample from the subject comprises a biofluid or a tissue.

7. The method of claim 6, wherein the biofluid is serum, plasma, urine, saliva.

8. The method of claim 1, wherein the multi-component therapeutic component profile and the subject's pre-administration and post-administration metabolomes determined using chromatographic and spectrometric analytical techniques.

9. The method of claim 8, wherein the chromatographic and spectrometric analytical techniques comprise gas chromatography and/or liquid chromatography coupled with mass spectrometry (MS) and/or nuclear magnetic resonance (NMR).

10. The method of claim 1, wherein comparison of the multi-component therapeutic component profile and the subject's post-administration metabolome and comparison of the subject's pre-administration and post-administration metabolomes comprises multivariate and/or univariate statistical analysis.

11. The method of claim 10, wherein the univariate statistical analysis comprises Student's T-test univariate statistical analysis.

12. The method of claim 9, wherein the shared components are identified using join properties.

13. The method of claim 11, wherein the join properties comprise one or more of retention time, accurate compound mass, fragmentation pattern and chemical shift.

14. The method of claim 10, wherein the multivariate statistical analysis comprises Pearson product-moment correlation coefficient analysis, wherein pair-wise metabolite vectors are compared at one or more time points before and/or after administration of the multi-component therapeutic to identify linear correlations between the absorbed components, the altered endogenous metabolites and the metabolized and/or biotransformed components.

15. The method of claim 14, wherein the pair-wise metabolite vectors comprise one or more of an absorbed component vs. an altered endogenous metabolite, and a metabolized and/or biotransformed component vs. an altered endogenous component.

16. The method of claim 15, wherein metabolite vectors are also derived using the mean value of a metabolite at more than one time point before and/or after administration of the multi-component therapeutic.

17. The method of claim 1, wherein the multi-component therapeutic is administered to the subject over time and/or at varying dosages to identify time-dependent and/or dosage-dependent biochemical changes in the subject's post-administration metabolome in response to administration of the multi-component therapeutic.

18. The method of claim 14, wherein the linear correlations identified between the altered endogenous metabolites and the metabolized and/or biotransformed components are used to conduct pharmacodynamic and/or toxicology studies to characterize the biochemical changes in the subject in response to administration of the multi-component therapeutic.

19. The method of claim 18, wherein the pharmacodynamic and/or toxicology studies can be used to assess efficacy of a treatment with the multi-component therapeutic, to predict probable side effects that may be associated with treatment with the multi-component therapeutic, and/or to determine optimal dosages and treatment schedules for treatment with the multi-component therapeutic for diseases involving the altered endogenous metabolites.

20. The method of claim 14, wherein the linear correlations identified between the absorbed components, the altered endogenous metabolites and the metabolized and/or biotransformed components are used to conduct pharmacokinetic studies to characterize the biochemical changes in the subject in response to the one or more active ingredients in the multi-component therapeutic.

21. The method of claim 20, wherein the pharmacokinetic studies can be used to assess efficacy of a treatment with the multi-component therapeutic, to predict probable side effects that may be associated with treatment with the multi-component therapeutic, and/or to determine optimal dosages and treatment schedules for treatment with the multi-component therapeutic for diseases involving the altered endogenous metabolites.

22. The method of claim 1, wherein the absorbed components, the altered endogenous metabolites and the metabolized and/or biotransformed components comprise one or more compounds selected from the compounds listed in Tables 1-5.

23. A system to identifying biochemical changes in a subject in response to administration of a multi-component therapeutic and one or more active ingredients in the multi-component therapeutic comprising:
(a) a part for determining a component profile for the multi-component therapeutic, a pre-administration metabolome in a subject sample before administration of the multi-component therapeutic, and a post-administration metabolome in a subject sample after administration of the multi-component therapeutic;
(b) a part for comparing the component profile for the multi-component therapeutic, the pre-administration metabolome in a subject sample before administration of the multi-component therapeutic, and the post-administration metabolome in a subject sample after administration of the multi-component therapeutic; wherein comparison of results in identification of absorbed components, the altered endogenous metabolites and the metabolized and/or biotransformed components; and
(c) a part for analyzing correlations between the absorbed components, the altered endogenous metabolites and the metabolized and/or biotransformed components,
wherein correlations between the absorbed components, the metabolized and/or biotransformed components and the altered endogenous components are used to characterize the biochemical changes in the subject in response to active ingredients in the multi-component therapeutic

24-44. (canceled)
